(19) United States
(12) Patent Application Publication
(10) Pub. No.: US 2012/0075682 A1
(43) Pub. Date: Mar. 29, 2012

(54) Spacetime energy resonator: a transistor of complex dirac polarized vacuum topology

(76) Inventor: Richard Louis Amoroso, Oakland, CA (US)

(21) Appl. No.: 12/928,592

(22) Filed: Dec. 15, 2010

Related U.S. Application Data
(60) Provisional application No. 61/284,384, filed on Dec. 17, 2009.
(60) Provisional application No. 61/284,896, filed on Dec. 28, 2009.
(60) Provisional application No. 61/336,522, filed on Jan. 22, 2010.

(51) Int. Cl. G03H 5/00; B82Y 10/00

(52) U.S. Cl. 359/1; 977/933

(57) ABSTRACT

Method and apparatus is described for a general purpose transistor of the higher dimensional (HD) spacetime backcloth consistent with symmetry parameters of a new cosmological paradigm with a unique M-Theoretic background making correspondence to a complex scale-invariant covariant Dirac polarized aether where energy pathways follow spacetime geodesics; and switching is achieved by manipulating resonant modes of a Calabi-Yau mirror symmetry hierarchy inherent in continuous-state brane topology of the structural-phenomenology of least cosmological units tiling the raster of spacetime as it emerges from the infinite potential of the unified field.

### CLAIM OF PRIORITY

This application claims benefit, under 35 U.S.C. §119 (e), of U.S. Provisional Patent Application No. 61/284,384 filed 17 Dec. 2009 titled: Laser Oscillated Vacuum Energy Resonator: A Transistor of the Complex Dirac Polarized Spacetime Vacuum; U.S. Provisional Patent Application No. 61/284,896 filed 22 Dec. 2009 titled: Coherent Control of Biological Systems by Programmable Cellular Automata Vacuum Energy Resonance; U.S. Provisional Patent Application No. 61/336,522 filed 22 Jan. 2010 titled: Cerebroscopic Systems: Device and Method for Transducing Qualia.

### STATEMENT OF GOVERNMENT RIGHTS

Not Applicable

### BACKGROUND OF THE INVENTION

The present invention in basic form relates to systems and methods for manipulating or programming the topology and fields of higher dimensional (HD) spacetime through a complex coherently controlled resonance hierarchy surmounting the quantum uncertainty principle, leading to spacetime engineering and several new classes of technology.

A salient embodiment is Quantum Computing (QC) which has until now remained elusive beyond a few qubits. We believe bulk universal quantum computing (UQC) cannot be achieved within the framework of the current Copenhagen interpretation of quantum theory because of the theories imposed limitation of the uncertainty principle by empirical definition.

The remaining problem thwarting UQC is decoherence with the environment. Currently a dozen or more avenues of quantum computing research exist. Considered most promising is quantum dot arrays cooled to near absolute zero by room-sized cryogenic refrigeration systems to slow atomic motion in the hopes of maintaining sufficient time for operations before decoherence occurs.

Our method is superior in that it is tabletop in size, operates at room temperature in any scalable quantum system and readily overcomes the uncertainty principle by utilizing parameters inherent in the energy dependent higher dimensional Calabi-Yau mirror symmetry spacetime metric of a new cosmology. This is performed by application of a coherently controlled multilevel RF pulsed incursive oscillator resonance hierarchy.

### BRIEF SUMMARY OF THE INVENTION

In this context the current invention is based on a new holographic multiverse cosmological paradigm utilizing operationally completed forms of quantum and gravitational theory making correspondence to the unified field of infinite potentia as it arises from a unique HD string theoretic vacuum. See Amoroso, 2009, 2010.

Feynman recommended use of a synchronization backbone for implementing UQC. This has been abandoned as intractable by the physics community; a conundrum that arises from limitations imposed by the standard models of Quantum Theory (QT) and Cosmology. Feynman's model makes UQC simple to implement if used with extensions of QT and cosmology utilizing an HD conformal scale-invariant Dirac polarized vacuum cast in a continuous-state M-Theoretic Calabi-Yau 3-fold mirror symmetry spacetime background.

The elegance of Feynman's synchronization backbone is revealed by the continuous-state spin-exchange dimensional reduction compactification process inherent in the topology of the spacetime dynamics of the cosmological paradigm itself. Past attempts to utilize Feynman's suggestion relied in trying to create a synchronization backbone in bilocal quantum systems. This remained intractable because for all practical purposes the quantum system was still caught in the regime described by the Copenhagen interpretation of quantum theory. But by utilizing the new cosmology where the synchronization backbone is an inherent property of the cosmology itself, it is like getting the important half of the QC for free.

Requisite additional degrees of freedom are introduced by defining a relativistic basis for the qubit (r-qubit) and utilizing an anticipatory oscillator to manipulate the inherent parameters in the new cosmological paradigm (cosmology itself is a hierarchical form of complex self-organized system) The causal structure of these conditions reveal an inherent new “action principle” driving self-organization and providing a simple basis for ontologically (energyless topological switching) surmounting the phenomenology (energy exchange) of the quantum uncertainty principle, ΔxΔρₓ≧┐/2 or ΔEΔtₓ≧┐/2 which has been the remaining hurdle blocking bulk UQC by producing decoherence during both initialization and measurement. A protocol for causal violation (absolute surmounting) of the quantum Uncertainty Principle with probability, p≡1 is utilized as a form of spacetime engineering creating a new kind of so-called spacetime transistor.

### Pertinent Definitions

By “Calabi-Yau” as used herein is meant, the extra dimensions (XD) of spacetime in M-Theory may take the form of a dual 3-torus or 6D Calabi-Yau complex manifold, which leads to the idea of mirror symmetry.

By “Mirror symmetry” as used herein is meant, a relation existing between two Calabi-Yau manifolds, where a string theory compactified on these two manifolds leads to identical effective field theories by holomorphic isometries.

By “Least cosmological unit” as used herein is meant, the structural-phenomenology tiling the backcloth of 12D superspace; in contrast to crystallographic unit cells where the smallest representative of crystal structure in crystal space is comprised as an indefinitely extended lattice of periodically repeating cells.

By “Cellular automata” as used herein is meant, a discrete regular array of identical finite states whose next state is determined solely by their current state and the state of their neighbors.

By “Coherent control” as used herein is meant, a quantum mechanical method for controlling dynamical processes with light or modulated RF pulses employing constructive or destructive quantum interference.

By “Dirac polarized vacuum” as used herein is meant, the covariant polarized sea of infinite positive and negative energy states filling all space in relativistic quantum field theory (RQFT), the top of which is comprised of the stochastic foam of the vacuum zero point field.

By “Conformal” as used herein is meant, a mapping of a surface or region or object upon another domain so that all properties remain unchanged.

By “Scale-invariant” as used herein is meant, features or laws of a quantum system that do not change if length or energy scales are changed.

By “Relativistic qubit (r-qubit)” as used herein is meant, in contrast to the usual qubit corresponding to 3D rotations of the Riemann sphere of the Copenhagen interpretation of quantum theory; the r-qubit utilizes an additional 4D parameter of RQFT more suitable for surmounting uncertainty.

By “Probability or P≡1ⁿ as used herein is meant, in contrast to the quantum uncertainty principle where only one quantum state may be measured; all states may be measured simultaneously.

By “Sagnac effect” as used herein is meant, an interference phenomenon of counter propagating ring lasers where rotation produces a beat frequency that is the difference between the two frequencies and linearly proportional to the angular velocity of the ring lasers with respect to inertial space. The Sagnac effect is thought to violate special relativity in the small scale.

By “Interaction free measurement” (IFM) as used herein—quantum mechanical measurement detecting the position or state of an object without an interaction occurring between it and the measuring device.

By “Ising model” as used herein is meant, a lattice of spacetime spinor variables where each spinor independently takes on either the value zero or infinity with respect to hyperspherical rotation of the Riemann sphere in the continuous-state topology of multiverse cosmology. Only pairs of nearest-neighbor Calabi-Yau mirror symmetric spins can undergo phase transitions. Relates to the Witten vertex and cosmological least-unit.

By “Witten vertex” as used herein is meant, a fundamental invertible string vertex mapping one differentiable manifold to another; such that when the continuous-state dimensional reduction spin-exchange compactification process reaches zero Ising model properties of the Riemann manifold rotate to infinity.

By “Geodesic” as used herein is meant, the shortest path between two points on a curved or plane surface in a Riemann metric; if referring to a light ray the geodesic has the property that the infinitesimal interval between any two neighboring points on the curve equals zero. Objects that move freely follow geodesics in the curved spacetime of general relativity.

By “Transistor of the vacuum” as used herein is meant, in contrast to a semiconductor device for amplification, switching, voltage stabilization, or signal modulation; spacetime geodesics are used instead of wires or axes and spacetime least-unit QED cavities are used instead of selective properties of semiconductors.

By “Brane dynamics” as used herein is meant, the properties of points, curves, surfaces, or higher-dimensional (HD) manifolds in M-Theory. Since string theory has 9D, a brane can have from 0D to 9D with our perceived reality an HD cross section or 3-brane.

By “Holographic multiverse” as used herein is meant, a cosmological paradigm with room for an infinite number of nested Hubble spheres each with their own fine-tuned laws of physics embedded in an M-Theoretic multidimensional holographic backcloth.

By “Decoherence” as used herein is meant, mechanism by which quantum systems interact with environments exhibiting probabilistic behavior typically changing a system from quantum to classical.

By “Entanglement” as used herein is meant, property of quantum system containing two or more distinct objects, where information describing the objects is inextricably linked such that performing a measurement on one immediately alters properties of the other, even when separated by arbitrarily large distances.

By “Spacetime exciplex” as used herein is meant, in contrast to the usual stoichiometric chemistry nomenclature as a form of excimer (short for excited dimer) complex formed by the interaction of an excited species with a ground state counterpart of a different structure; instead describes excited, resonant, coupled modes of two mirror symmetric Calabi-Yau topological boundary conditions dissociating back into the constituent spacetime automata rather than reversion to the vacuum (quantum) ground state or are boosted to the next spin-spin coupling resonant mode in the hierarchy by the action.

By “Noetic Effect” as used herein is meant, the various resultant effects of the force of coherence of the unified noetic field as its flux enters a spacetime ‘cellular automata’ domain and the mind and body of complex self-organized living-systems.

By “Eternity” as used herein is meant, causally free of 4D Euclidean-Minkowski spacetime, with 12D the minimum number of dimensions to define eternity; metaphorically the ‘mirror image of a mirror image’.

By “Psychosphere” as used herein is meant, following the definition that the spirit and the body is the soul, the Psychosphere is the total boundary conditions of life and consciousness relative to the limits of individuality; representing a complex geometric topology which at the semi-classical limit entails a temporal domain in Minkowski space that couples to quantum processes in the brain and body; and through the mediation of the Noetic Field (noeon) includes a timeless HD domain of individual eternal elemental intelligence.

By “Dualism or Cartesian Dualism” as used herein is meant, that there is more to mind than brain alone. The two elements Descartes proposed res extensa-body stuff and the additional interacting mental component res cogitans-mind stuff, are here considered physically real as opposed to ineffable, nonphysical, immaterial or nonexistent as in the current forms of cognitive mind-brain identity theories.

By “Noetic Field Theory (NFT)” as used herein is meant, a comprehensive theory of awareness based on dualist-interactionist action principles inherent the 12D cosmology of a Holographic Anthropic Multiverse.

By “Noeon” as used herein is meant, in NFT the exchange unit of the unified field, spirit or élan vital.

By “Prion” as used herein is meant, infectious protein responsible for ‘mad cow’ and other degenerative encephalopathies.

By “Biological Mechanism” as used herein is meant, the laws of chemistry and physics are sufficient to describe all life; no additional life-principle is required.

By “Hysteresis loop” as used herein is meant, lag occurring in spacetime dynamics between application and removal of a force and its effect. An oscillating force creates harmonic hysteresis loops where the hysteroid is the closed space encompassing the hysteresis. Without hysteresis force would map a line. Spacetime hysteresis is important to NFT in several ways—The lag between time and eternity in the creation of spacetime, The volume of the hysteroid is the quantity of the noetic field injected into each spacetime point as élan vital.

### BRIEF DESCRIPTION OF THE DRAWINGS

Drawings for disclosure of Method and Apparatus for spacetime engineering herein are more saliently confined to UQC since other embodiments in the claims are operationally similar since all claims are variants of vacuum programming by the method herein. Furthermore since bulk UQC may be manifest in virtually any scalable quantum system we confine our description in the specifications and drawings primarily to apparatus related to the preferred Xanthine embodiment of FIGS. 7 & 8. Since the art is radically new we feel that even those skilled in related art may need to invest additional study to achieve the usual average state of familiarity.

FIG. 1. Design element Sagnac effect RF pulsed resonance hierarchy applied to the quantum conditions for resonant coupling to the HD Cavity-Exciplex trap of the Interferometer to constructively-destructively coherently control the topology of the 12D spacetime manifold to manipulate the unitary field. Cumulative effects are made by coupling constructive spacetime interference nodes of the cyclotron resonance hierarchy.

FIG. 2. More sophisticated embodiment utilizing micromagnetics of de Broglie matter-waves for more direct manipulation of spacetime by bypassing one or more tiers in the resonant hierarchy of FIG. 1.

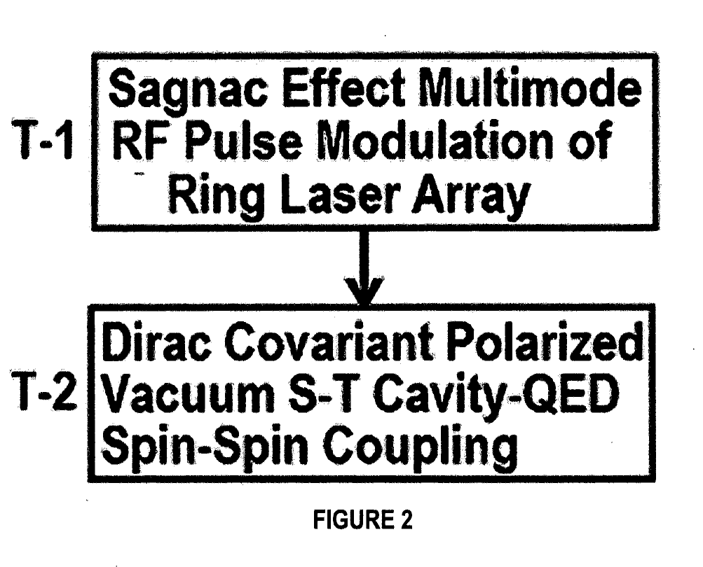

FIG. 3. The geometry of 3D Euclidean space unfolds into a 2D plane showing its components. This metaphor aids visualization of how a 4D hypercube (tesseract) unfolds into 8 component 3D cubes.

FIG. 4. A 5D hypercube unfolded to 8 cubes forming the 3D cross would be 4D tesseracts etc. The translucent central cube, represents observed reality, E₃ or a quantum state. This central cube is surrounded by six adjacent cubes. The 8th cube, the satellite, is placed arbitrarily on any adjacent cube. Key is that the central translucent cube (lower right) represents a ‘particle in a box’ quantum state that through conformal scale-invariance remains a physically real replica of the E₃ quantum state. When the metaphor is carried to 12D it becomes like the ‘mirror image of a mirror image’ in the sense that it is causally free of the E₃ quantum state and thereby open to ontological (energyless) information transfer in violation of Copenhagen uncertainty.

FIG. 5. Close-packed least-units tiling the covariant Dirac backcloth. X, y, z represent fundamental brane boundaries of a continuous-state virtual Euclidean point called the Witten vertex as in M-Theory able to undergo Ising model rotation spin-flips similar to the 0 to ∞ hyperspherical rotations of a complex Riemann sphere. A is string or brane boundary, B represents field lines, and C rotational extension of charge.

FIG. 6. Two oppositely charged vacuum subelements, D & E rotating at v≅c around a central point as a dipole (+e) EM ‘bump’ and (−e) G ‘hole’ on top of the topological surface of the polarized Dirac vacuum.

FIG. 7. Generalized structural representation of Class II mesoionic xanthine acyclonucleosides. n=1, 2; R═H, CH₃, CH₃CH₂, C₆H₅; R′=H, CH₃.

FIG. 8. Resonance stabilization in Class II Mesoionic Xanthines, our chosen test UQC embodiment

FIG. 9. Orienting the Noetic Field equation with Hysteresis loop for the Lagrange operator at the plane of equilibrium. F Domain wall, G Least-unit, H Arrow of time, J Euclidean point, K Brane.

FIG. 10. Double-cusp catastrophe (DCC) showing cusps at each end of the plane of equilibrium. The DCC occurs in ≧9 D and is the catastrophe form most compatible with HAM symmetry. The plane of equilibrium is a topological manifold tiled of least units. The equilibrium manifold is a programmable cellular automata. A are spacetime geodesics.

FIG. 11. Sagnac effect resonance hierarchy from electron resonance to spacetime resonance.

FIG. 12. General control equations for each level of the multi-tiered Sagnac effect resonance hierarchy.

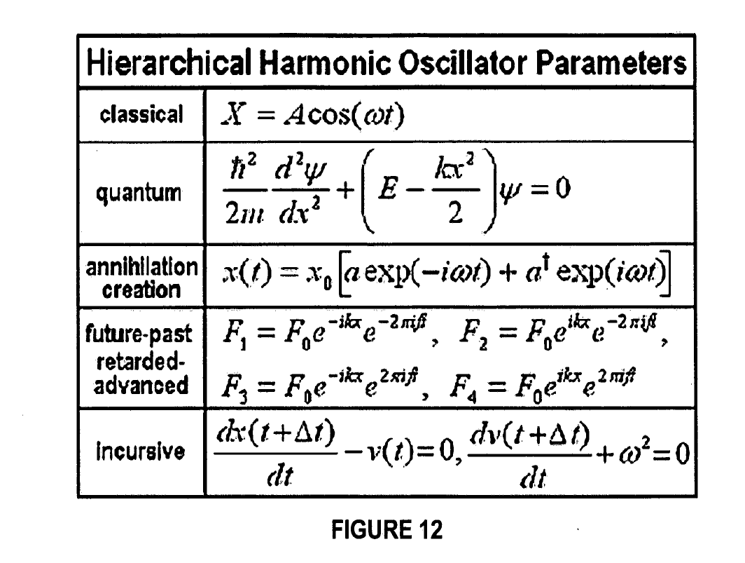

FIG. 13. Conformal scale-invariance mirror symmetry hierarchy of a local quantum state to HD; where L is a quantum state, M is Minkowski space, N conformal mirrored states, P Resonance nodes.

FIG. 14. Planes or cyclical HD topological surfaces of equal phase, φ along an arbitrary axis, z for the control plane wave propagation vector, k; Q is cyclical planes of equilibrium.

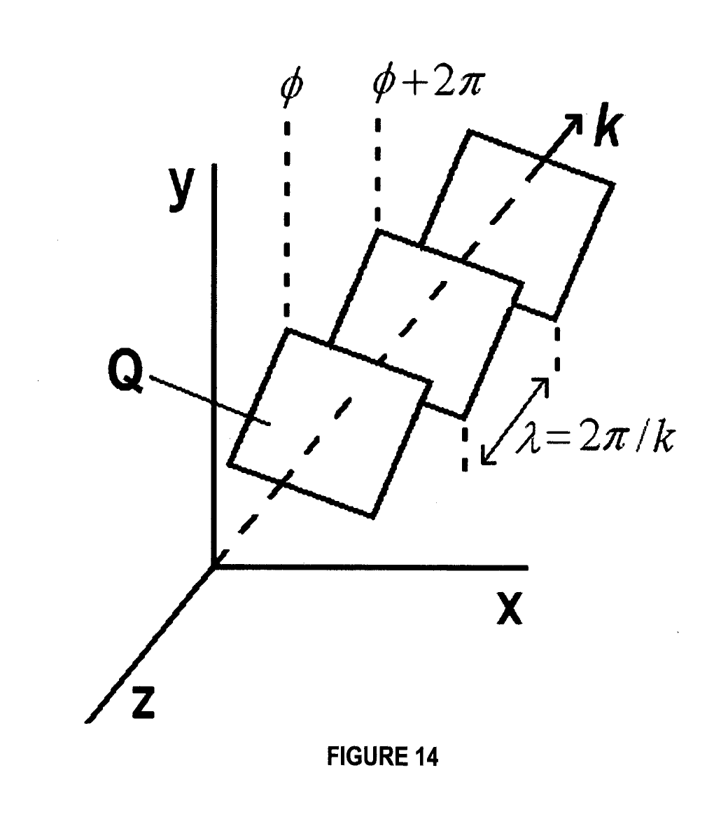

FIG. 15. Spacetime exciplex as the major switching mechanism for coherent control, able to accommodate any cellular automata geometry and any transform by topological switching resonance modes; E is energy, G ground state, z,x complex excited states.

FIG. 16. Mechanistic flow chart for prion protein conformation from normal to pathogenic; X is the X-factor, F_{(N)} the Noetic Force.

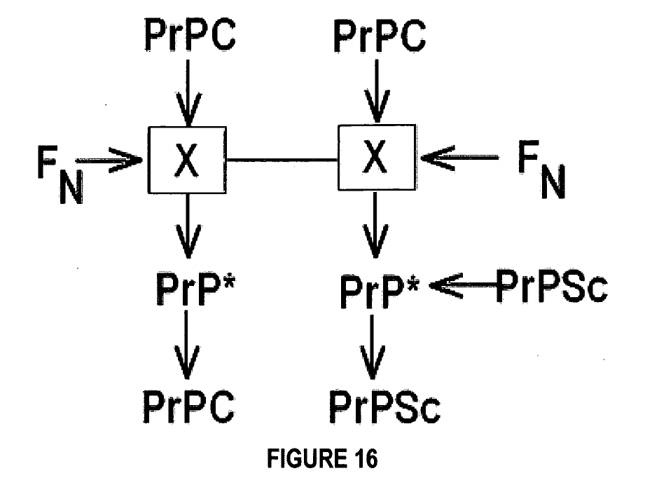

FIG. 17. Programming prion conformation with an array of Hadamard quantum gates, H.

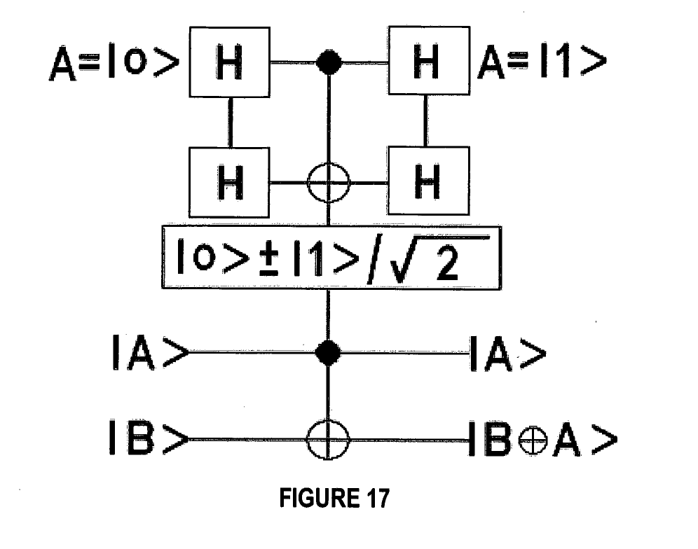

### DETAILED DESCRIPTION OF THE INVENTION

### Basics of Quantum Computing

Whereas a classical Turing machine using a register of binary bits, 1 or 0 can only be in one state at a time; a quantum computer (QC) with a sequence on n qubits can be in a superposition of all the 2″ qubit states simultaneously. The simplest implementation would be a system of particles with two spin states.

It is easy to see the enormous power of quantum computing. A 1,000 qubit quantum register is described by 2¹⁰⁰⁰ complex numbers which is many orders of magnitude more atoms than inside the Hubble radius. The main engineering problems for building a bulk quantum computer is decoherence during initialization and data readout, and quantum gates that operate faster than the decoherence time of the system which is often between nanoseconds and seconds. The ontological approach developed makes decoherence on readout irrelevant because the methodology bypasses the quantum uncertainty principle.

Eventually almost any quantum system could be used for various forms of bulk quantum computing. Some of the candidates currently being considered are: solid state and molecular solution nuclear magnetic resonance, superconducting, trapped ion, quantum dot, topological quasi-particle, optical lattice, cavity-QED, quantum optics, quantum spin, Bose-Einstein condensate, Adiabatic, transistor based, molecular magnets, quantum Hall effect, Fullerene electron spin resonance, and diamond spin.

### Overview of New Fundamental Parameters

The basis of our approach for the ontological realization of bulk or Universal Quantum Computing (UQC) is introduced conceptually utilizing an axiomatic approach to facilitate delineating the philosophy for the formalism. The theoretical model requires a new cosmology based on an extension of Quantum Theory (QT) or vice versa depending on whether one's view is top-down or bottom-up. Both the new cosmology and extension of QT are anticipatory because they take the form of complex self-organized hierarchical systems. The extended QT is derived from a combined relativistic extension of Cramer's Transactional Interpretation, based on the Wheeler-Feynman Absorber Theory of Radiation, and an HD extension of the de Broglie, Bohm, Vigier Causal Interpretation of QT where m_{γ}≠0.

The cosmology is that of a 12D Holographic Anthropic Multiverse (HAM) making correspondence to the F-Theory iteration of String Theory. Why does UQC require an anticipatory approach cast in new QT and HAM cosmology? Salient reasons discussed are: 1. Causal conditions, 2. New Symmetry relations, 3. Utilization of Feynman's suggestion, and 4. Coherent control methods of operation. Interestingly the self-organized parameters of the cosmology entail an inherent synchronization backbone, amounting to getting half the UQC for free!

### Causal Separation of Phenomenology from Ontology

Because of the recent jump from Newtonian Mechanics to Quantum Mechanics most physicists believe we live in a quantum universe. The logical progression of this line of reasoning would suggest we live in a Unitary Universe once a unified field is empirically delineated. This is an erroneous conclusion.

A better assumption based on anticipatory properties inherent in 12D HAM cosmology suggests that the universe is a continuous-state interplay of all three modes. We only observe the Euclidean component of this world view, we assume reality is a complex virtual standing wave with the present a continuously created subspace of HD future-past parameters.

Our task is to demonstrate an ontological methodology for surmounting the inherent uncertainty conditions of Copenhagen regime phenomenology with a new set of transformations that utilize an “energyless topological switching” to exchange information.

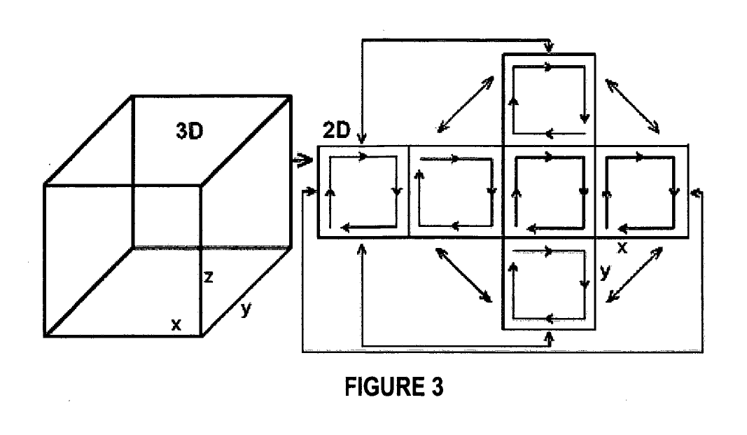

Reality as locally observed, (FIG. 3) is 3D Euclidean, E₃ or 4D Minkowskian, \hat{M}₄ depending on whether time is introduced in the Newtonian or Einstein sense. In FIG. 3 the 3D cube is shown unfolded into a cross in the 2D plane with arbitrary loss of the z direction.

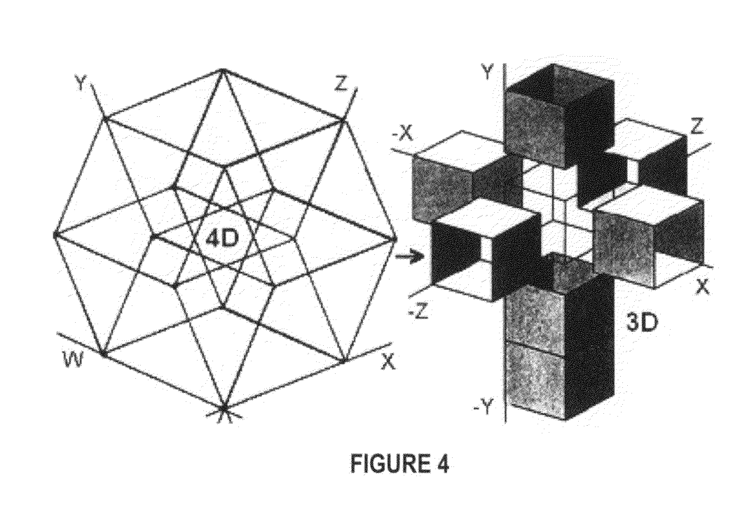

FIG. 4 shows a 4D tesseract that includes the 4th dimension designated as w. In a manner analogous to FIG. 3 the 4D tesseract is unfolded into a 3D cross as shown in FIG. 4. Loss of the w direction makes it easier for the human mind to visualize a hypercube.

For simplicity we use the 3(4)D cross to illustrate how ‘12’ is the minimum number of dimensions required to describe eternity (defined as causal separation from E₃) and conceptually reveal how to overcome the limitations of the quantum principle inherent in Copenhagen uncertainty; i.e. since the phenomenology of Copenhagen action produces uncertainty by definition—choose instead an ontological process that does not discretize the z field commutator as in Eq. (2).

To further illustrate FIG. 3, assume the translucent central cube (FIG. 3) represents local E₃ reality as a subspace surrounded by six adjacent HD cubes that are components of the 4D tesseract in FIG. 4. The 8th cube, the satellite, is arbitrarily attached to the y direction adjacent cube. Let the central cube hold a standard quantum state. A primary assumption of continuous-state noetic cosmology is that all eight 4D cubes (4096 in 12D) contain the information of the central cube's state by superposition (an inherent property of the conformal invariance of HD Relativistic Quantum Field Theory (RQFT)). This is a fundamental symmetry condition of the Superspace of HAM cosmology. The satellite cube is periodically causally free of the E₃/M₄ central cube because of the relativistic transformation.

This continuous-state topological transformation of the standing-wave modes is the inherent synchronization backbone in the backcloth of spacetime itself; as if half of the QC is obtained for free. In this context QC operations are ontological (if putatively performed in a specific manner described by the new noetic transform) without phenomenological collapse of the wave function with respect to quantum information contained in the central E₃ cube. This metaphor performed rigorously in a 12D context is able to surmount the uncertainty relation!

### Angular Momentum and Pauli-Dirac Spin Matrices

The Schrödinger equation is invariant under Galilean but not the Lorentz transformation and therefore incompatible with the principle of relativity and all phenomena relating to the interaction of light and matter leading to the concept of 2nd quantization.

Our 12D extension of QT goes beyond the usual Klein-Gordon and Dirac models of RQFT. This is an issue of the observers cosmology with an inherent complementarity between 1st and 2nd quantization much like wave-particle duality. This is a continuous-state property readily described by methods similar to that attributed to Dirac spherical rotation of the electron.

Separation of the Schrödinger equation into spherical coordinates reveals the Hamiltonian

$$H = \frac{1}{2 m} ( {p}_{r}^{2} + \frac{{L}^{2}}{{r}^{2}} ) + V ( r ) , \qquad ( 1 )$$

where pᵣ is the radial momentum (m\dot{r}) and L the angular momentum vector. As well known, the three components of angular momentum, derived from each other by cyclic permutation, are L_{z}=xp_{y}−ypₓ, Lₓ=yp_{z}−zp_{y}, L_{y}=zpₓ−xp_{z}, L=r×p where the total angular momentum L²=Lₓ²+L_{y}²+L_{z}² has commutation rules L×L=iL .

SO(3) rotation generators l₁, l₂ and l₃ satisfy l₁l₂−l₂l₁=l₃, l₂l₃−l₃l₂=l₁, l₃l₁−l₁l₃=l₂ are related quantum mechanically to angular momentum components L₁, L₂, L₃ with Lₓ=il₁, L_{y}=il₂, L_{z}=il₃ about Cartesian axes giving the usual commutation rules LₓL_{y}−L_{y}Lₓ=iL_{z}, L_{y}L_{z}−L_{z}L_{y}=iLₓ, L_{z}Lₓ−LₓL_{z}=iL_{y}.

Angular momentum refers to intrinsic spin about a massive particles center of mass and its magnetic moment by SO(3) Lie algebra which is non-Abelian so the elements do not all commute. The Pauli matrices satisfy these commutation rules when acting on two component spinor wave functions {ψ₀(x),ψ₁(x)}≡Ψ_{A}; but by the uncertainty relation, ΔxΔρ=h only one set of these operators may commute at a time.

Non-relativistic Fermi spin ½ particles with spin angular momentum operator S=½σ can be expressed as the three anticommuting Pauli 2×2 spin matrices Eq. (2) satisfying σₓσ_{y}=−σ_{y}σₓ=iσ_{z} as derived empirically from the Stern-Gerlach experiments.

$${L}_{x} = \frac{ℏ}{2} {σ}_{x} = [ \begin{matrix}0 & 1 \\ 1 & 0\end{matrix} ] , \\ {L}_{y} = \frac{ℏ}{2} {σ}_{y} = [ \begin{matrix}0 & - i \\ i & 0\end{matrix} ] , \\ {L}_{z} = \frac{ℏ}{2} {σ}_{z} = [ \begin{matrix}1 & 0 \\ 0 & - 1\end{matrix} ] . \qquad ( 2 )$$

Here we demonstrate a complex HD geometric-micromagnetic method where all commutator relations can periodically simultaneously commute like the Casimir-like ‘total spin’ operator, J²=Lₓ²+L_{y}²+L_{z}² commutes with all three components of L in 3D. This is possible in HD because E³ in HAM cosmology has the same properties as the Dirac spherical rotation of the electron.

The topology of these boundary conditions is described by HD expansion of the noetic field equation, Fₙ=E/R; F_{N} is the cyclic noetic force, E the continuous-state Lagrangian and R the complex coherence length.

Relativistic spin ½ particles are described by Dirac's formalism for the wave equation which has been expressed by several notations Eψ+c(α·p)ψ+mc² βψ=0; or

$$i ℏ \frac{\partial ψ}{\partial t} - i ℏ c α \cdot grad ψ + m {c}^{2} βψ = 0$$

which when expressed by Dirac's σ matrices can be expanded into the following 4×4 matrices:

$$β = [ \begin{matrix}1 & 0 & 0 & 0 \\ 0 & 1 & 0 & 0 \\ 0 & 0 & - 1 & 0 \\ 0 & 0 & 0 & - 1\end{matrix} ] \\ {α}_{x} = [ \begin{matrix}0 & {σ}_{x} \\ {σ}_{x} & 0\end{matrix} ] = [ \begin{matrix}0 & 0 & 0 & 1 \\ 0 & 0 & 1 & 0 \\ 0 & 1 & 0 & 0 \\ 1 & 0 & 0 & 0\end{matrix} ] \\ {α}_{y} = [ \begin{matrix}0 & 0 & 0 & - i \\ 0 & 0 & i & 0 \\ 0 & - i & 0 & 0 \\ i & 0 & 0 & 0\end{matrix} ] \\ {α}_{z} = [ \begin{matrix}0 & 0 & 1 & 0 \\ 0 & 0 & 0 & - 1 \\ 1 & 0 & 0 & 0 \\ 0 & - 1 & 0 & 0\end{matrix} ] \qquad ( 3 )$$

which are Hermitian and readily seen to contain the 2×2 Pauli matrices, Eq. (2) as in the center of matrix αₓ.

An interesting point developed below is that in cases where m=0 (or for high E where any massive particle behaves like m=0) only three anticommuting matrices instead of four are required. This means the Pauli matrices will suffice and the spinor needs only 2 components which relates to the Wehl or chiral representation.

In another popular notation the Dirac equation is represented as

$$E = {mc}^{2} + \frac{{ke}^{2}}{r} = φ c + {imc}^{2} = \vec{φ} c + {imc}^{2} \\ where E -> - \frac{ℏ}{i} \frac{\partial }{\partial t} ; \vec{φ} -> \frac{ℏ}{i} \vec{∇} \qquad ( 4 )$$

with general solution

$$\frac{ℏ c}{i} ( {γ}_{1} \frac{\partial }{\partial x} + {γ}_{2} \frac{\partial }{\partial y} + {γ}_{3} \frac{\partial }{\partial z} + {γ}_{0} \frac{\partial }{\partial ict} ) ψ - m {c}^{2} ψ = 0$$

which is easily shorthanded to

$$( {γ}^{μ} {\partial }_{μ} + i \frac{m {c}^{2}}{tc} ) .$$

There are two non-relativistic limits; the first (E+mc²+ke²/r)²=(φc)²+(mc²), is the well-known Klein-Gordon equation, and the second,

$$\begin{matrix}E + m {c}^{2} + {ke}^{2} / r = \sqrt{{( φ c )}^{2} + {( m {c}^{2} )}^{2}} \\ ≅ m {c}^{2} [ 1 + \frac{1}{2} {( \frac{φ c}{m {c}^{2}} )}^{2} + … ] \\ ≅ m {c}^{2} + \frac{{φ}^{2}}{2 m} + …\end{matrix}$$

thus becoming

$$E = \frac{{φ}^{2}}{2 m} - \frac{{ke}^{2}}{r} ,$$

the Schrödinger equation.

In this notation the matrices in Eq. (3) αₓ, α_{y}, α_{z}, β_{ict} correspond to γ₁, γ₂, γ₃, γ₀, respectively and ψ to the matrix

$$ψ = ( \begin{matrix}{ψ}_{e ↑} \\ {ψ}_{e ↓} \\ {ψ}_{φ ↑} \\ {ψ}_{φ ↓}\end{matrix} ) .$$

### Noumenal Reality Versus Phenomenology of Quantum Theory

Feynman has shown that reality can be considered incompatible with QT. If we let A, B, C represent the three observables a, b, c, their values P(a,b), P(b,c), P(c,a), their transition probabilities a→b, b→c, c→a and φ(a, b), φ(b, c), φ(c, a) the corresponding quantum mechanical amplitudes; the transition probabilities P(x,y) (x,y=a, b, c) are measurable empirically by the classical rules of probability leading to

P(a,c)=Σ_{b}P(a,b)·P(b,c) (5)

with the summation taken over all values of observable B.

Measuring P(x,y) in a case where the relative frequency of x is an ensemble prepared so that y is realized with certainty, the identity equation (6) can be shown to be wrong because the difference (called the interference term) between the right and left sides of (6) is found to be some orders of magnitude larger than the experimental error. If one calculates the interference terms according to the rules of QT from the empirically correct formula

φ(a,c)=Σ_{b}φ(a,b)φ(b,c) (6)

utilizing connections between probability and amplitude

|φ(x,y)|²=P(x,y); x,y=a,b,c. (7)

This contradiction between the classical probability identity (5) and the results of the Copenhagen interpretation (6) have been elucidated by Feynman:

. . . Looking at probabilities from a frequency point of view (5) simply results from the statement that in each experiment giving a and c, B had some value. The only way (6) could be wrong is the statement, “B had some value”, must sometimes be meaningless. Noting that (7) replaces (6) only under the circumstance that we make no attempt to measure B, we are led to say that the statement, “B has some value”, may be meaningless whenever we make no attempt to measure B″.

Feynman's statement delineates Schrödinger's cat paradox. He states regarding the interference term that if we say “B had some value” when we make no attempt to measure it is true we have a contradiction with experiment because there is a contradiction between objective reality and the validity of QT in the orthodox Copenhagen interpretation.

For our purposes here we resolve this paradox by abandoning the notion of a local absolute objective reality by stating that the observer's 3(4)D reality is virtual and that the 11(12)D HAM anticipatory reality is physically more complete. This is a key foundational element of our UQC model because we postulate firstly that the very existence of the observer discretizes reality and secondly that the application of the arbitrary z-field discretizes L such that it does not universally commute.

This is of course experimentally demonstrated as the standard interpretation of QT and is the basis for its formalism. This scenario avoided in the 12D anticipatory model of UQC is not possible by “law” if Copenhagen is applied. We demonstrate a model with zero commutator for all values of L where state evolution can be manipulated ontologically (from a position of causal separation) rather than the standard phenomenology of wave function collapse producing the uncertainty relation, δxδρₓ≧½.

### Justification for the Incursive Noetic Model

If M-theory/F-Theory subsumes the standard model of particle physics and cosmology, strings will represent the primary physical element; and h will no longer be considered a fundamental constant. First let's consider the continuous-state compactification of noetic superspace.

The 12^{th} D (hyperplane) is an absolute space signifying the geometric limit of our reality from which a 9 to 11D manifold drops out (site of unitary field) as the 1St continuous-state compactification of the harmonic superspace delineated as

x_{N}=x_{N}+2πR_{N} (8)

where N→ from 1 to 8D and R the periodic radius of space N goes from to ∞.

This condition exists because unit strings are not related to =1, but to string tension, denoted simplistically Tₛ=1/π. Fields on this periodic space therefore satisfy

φ(x)=φ(x+2πr) (9)

which means the field φ can be power expanded periodically with eigenfunctions

$$φ ( x ) = {\sum }_{k} {φ}_{k} {e}^{i px} \qquad ( 10 )$$

where p=k/R and k is an arbitrary integer so that the momentum conjugate x is quantized in integers, a feature of all compactifications. Note for our purposes that compactification of a dimension quantizes the momentum corresponding to the compactified coordinate.

This has immediate repercussions for the anticipatory UQC model. For Copenhagen, only the z component of the angular momentum vector of a particle on a Riemann sphere is considered well defined. The Dirac equation, usually formulated in 4D, must be recast in the 12D superspace to include additional causal action in the symmetry of advanced-retarded potentials and heterotic splitting of the 8D resonant tower, where the wave function and all off-diagonal elements are physically real and therefore accessible as in Cramer's transactional interpretation.

A Cramer transaction is represented as a form of standing wave both of which support the energy dependent nature of the periodic 12D continuous-state superspace. The separation of these parameters in terms of de Broglie's fusion model is used for ontological manipulation of the harmonic tier.

It is suggested that continuous compactification of noetic superspace in this framework produces a singularity (a cyclic wave-particle) which is the observed E₃ reality itself; and the 8-form factorizes into two 4-forms N₈→X₄ [symbol] X₄, i.e. the advanced—retarded components of an HD extension of a Cramer transaction.

Because M₄ is Einstein's energy-dependent spacetime metric, \hat{M}₄ where strings are susceptible to EM charges, (p, q); the tension of these heterotic strings becomes

T_{p,q}=pe^{-φ}+qe^{φ} (11)

which can be used to demonstrate that string tension, T vanishes at the singularity E₃.

### Essential Properties of Complex Noetic 12 Space

The UQC model relies on a new 12D Absolute Space (AS) (ultimate arena of reality) from which properties of a Wheeler geon or ‘ocean of light’ (the unitary noetic field) emerge. The noetic AS is an atemporal, highly ordered and symmetric harmonic superspace from which all other space relative to an Earth observer is a composite subspace. The geon domain (9D to 11D) is the first compactification regime; and because of coherence of the unitary field, railroad tracks would not recede but remain parallel.

A set of null lines (complex arrow of time), a loci of eternal points, remains hidden from local observed reality as an eternal present. This is part of the complex, ±C₄ Wheeler-Feynman-Cramer duality of the future-past standing-wave comprising the continuous state present: “a relativistic spin-exchange dimensional reduction compactification process” which represents a new set of transformations beyond Galilean and Lorentz/Poincaré to describe the inherent dynamics of this unitary domain and create the arrow of time. This condition results in our E³−M⁴ domain being a subspace of eternity; and the essential process for producing the ‘synchronization backbone’ inherent in the backcloth of HAM cosmology.

As in special relativity where c remains constant and independent of the velocity of the source; the 12D AS remains static and absolute whether matter is stationary or in relativistic motion. In this context there is a duality in terms of conservation laws, annihilation/creation, advanced/retarded potentials or between space and energy including an asymmetry between the future-past. The new set of transformations makes correspondence with M-Theory and is conceptually considered a higher dimensional extension of Dirac Spherical Rotation.

Thus issues of the historical controversy between relational and AS are pushed to the new 12D domain. Within the Classical limit the former 3D Euclidean AS remains relative to the eternal present of the subjective observer. Einstein demonstrated that the application of special relativity to a (4D Minkowski/Riemann manifold makes space relational. The new relational space extends Einstein's view from four to eleven dimensions.

In the 12D noetic superspace, S_{N} the 110 unitary noetic field (and the local 4D B⁽³⁾ component of the EM field) translates longitudinally, but the space (as in water waves) remains fixed because the wave bumps against the close-packed spheres or least units (like the water molecules) allowing only transverse displacement while the wave is locally present. This wave cyclically undergoes m_{γ}=0 and m_{γ}≠0 plus B⁽³⁾ for certain polarizations.

Current thinking on the topology of space takes three general forms: 1) The most commonly accepted 4D Minkowski/Riemann spacetime manifold; and two putative HD superspace additions, 2) Calabi-Yau space preferred by M-Theory and 3) Dodecahedral space. Nature of the true vacuum remains an open question.

The 3D absolute space of Newton became the 3(4)D relational spacetime of Einstein. The 12th D of Noetic cosmology represents a new form of absolute space, a periodic superspace where the eternal twelfth dimension has a Wheeler Geon or ocean of ‘light’ (the unified field) as its 9⇄11 D subspace.

The relational 4D Minkowski/Riemann spacetime manifold is a continuous state standing wave subspace of the 12D noetic superspace; it acts as a topological cover of an eternal present which is not observed and continuously decays into spacetime.

“Space quantization” or the quantization of orientation of atomic systems observed empirically primarily by Stern-Gerlach and secondarily in other phenomena like the Zeeman Effect in an inhomogeneous magnetic field led to the basis for representing spin ½ fermions as a uniform Dirac spherical rotation through a 720° cycle and the commutation relation for angular momentum in quantum theory. We explore extending these properties to 12D, 12D as required for UQC ontological operation.

If the noetic space water wave conception is correct, the continuous-state compactification process contains a tower of spin state Lie groups from spin 0 to spin 4. Spin 4 represents the unified field and makes cyclic correspondence with spin 0 where spacetime (sing lattice Riemann sphere spin flips create dimensional jumps through the helicoids topology.

Spin 0, ½, 1, & 2 remain in standard form. Spin three is suggested to relate to the orthogonal properties of atomic energy levels and space quantization. Therefore the spin tower hierarchy precesses through 0, 720°, 360°, 180°, 90° & 0 (∞) as powers of I.

An instant t, for a position r≡(x, y, z) or for the light cone r=xdt, defines a point or event d=\sqrt{x²+y²+z²} in ordinary spacetime coordinates, a pseudo-Euclidean metric tensor representing the sixteen points of a 4-sphere.

$${G}_{μ v} = ( \begin{matrix}1 & 0 & 0 & 0 \\ 0 & - 1 & 0 & 0 \\ 0 & 0 & - 1 & 0 \\ 0 & 0 & 0 & - 1\end{matrix} ) . \qquad ( 12 )$$

In summarizing the observers relationship to the Cosmological Principle (that the universe is homogeneous and isotropic on average in the large-scale) events are idealized instants in spacetime defined by arbitrary time and position coordinates t, x, y, z, written collectively as e where μ runs from 0 to 3.

The standard line element is

$$d {s}^{2} = {\sum }_{μ v} {G}_{μ v} d {x}^{μ} d {x}^{v} = {G}_{μ v} d {x}^{μ} d {x}^{v} , \qquad ( 13 )$$

where the metric tensor

G_{μν}(x)=G_{μν}(x) (14)

is symmetric. In local Minkowski form all the first derivatives of gᵢⱼ vanish at the event and Eq. (13) takes the form

ds²cdt²−dx²−dy²−d_{z}². (15)

The Cosmological Principle generally suggests that the clocks of all observers are synchronized throughout all space because of the inherent homogeneity and isotropy. Because of this synchronization of clocks for the same world time t, for co-moving observers the line element in Eq. (15) becomes

ds²=dt²G_{αβ}dx^{α}dx^{β}=dt²−dl², (16)

where dl² represents special separation of events at the same world time t.

This spatial component of the event dl² can be represented as an Einstein three-sphere

dl²=dx²dy²dz²+dw² (17)

which is represented by the set of points (x, y, z, w) at a fixed distance R from the origin:

R²=x²+y²+z²+w² (18)

where

w²=R²−r² and r²=x²+y²+z² (19)

so finally we may write the line element of the Einstein three-sphere from equation (17) as

$$d {l}^{2} = d {x}^{2} + d {y}^{2} + d {z}^{2} + \frac{{r}^{2} d {r}^{2}}{{R}^{2} - {r}^{2}} . \qquad ( 20 )$$

By imbedding Einstein's model of the 3-sphere in a flat HD space, specifically as a subspace of a new complex 12D superspace, new theoretical interpretations of standard cosmological principles are feasible.

Although the Newton and Coulomb potentials have similar forms the two theories have developed separately. For our purposes, following the Sakharov-Puthoff conjecture, that gravity is a product of fluctuation of the zero point field; we unify them with the Amoroso-Vigier methods where both fields are represented by 4-vector field densities A_{μ}.

Both phenomena are considered different types of motion within the same real physical field in flat spacetime as two different vacuum types of collective perturbations carried by a single vacuum field (unified).

Maxwell's equations traditionally describe only transverse elements that ‘cut-off’ at the vacuum. Here for HAM cosmology extended electromagnetic theory is utilized where the Einstein-de Broglie relation, E=v=mc² allows additional degrees of freedom such as longitudinal components B⁽³⁾ and polarized vacuum conditions where m_{γ}≠0 suggests that the photon is piloted. These conditions suggest the need for both the standard EM field and extended μνfield coordinates; an understanding of which will be seen to be required for the ontological UQC operations.

In our original integration of G and EM we chose to fix the μνfield coordinates. Here we go a step further. Dirac himself suggested by the rule of coordinate law that the pilot wave and the photon decouples. The two sets of coordinates EM or μνwould normally be considered independent of each other.

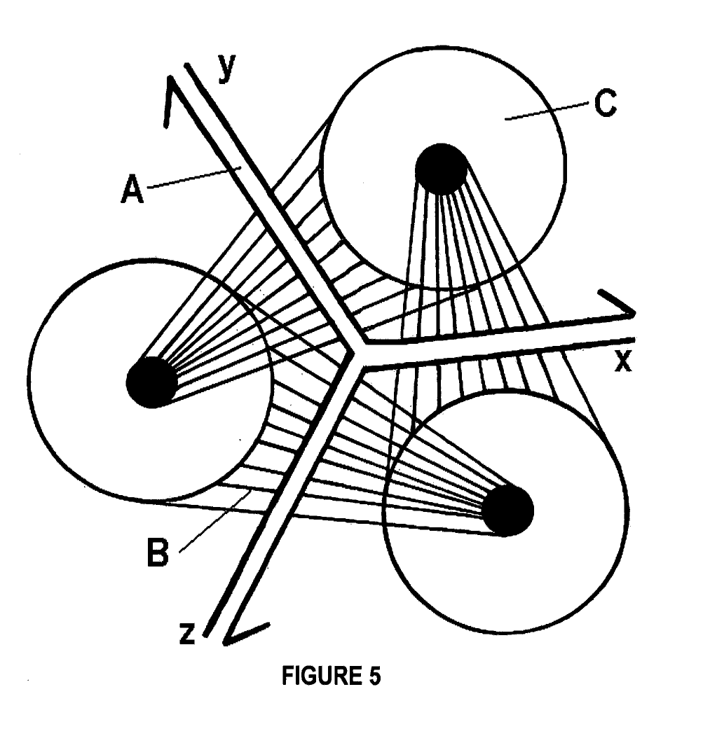

We integrate them in the topology of the Dirac polarized sea and alternate the fixing and decoupling of μν and EM coordinates as an inherent ‘leapfrogging’ of the nonlocal-supralocal continuous-state standing-wave present. Like wave-particle duality of matter, HAM cosmology EM−q_{μν} duality extends to spacetime itself in that the unified field harmonically discretizes into spatial boundary conditions of an (sing model Euclidean point (FIG. 5).

Each L-R cycle can be considered as one discrete spacetime least-unit quantum to the external observer. However as well known, our so-called quantum is actually comprised of a number of discrete frames that appear continuous to the external observer because of the refresh rate. This could be considered as the properties of quantum phase space and that material Fermi surfaces appear smooth because of the relativistic velocity of the surface electrons.

Two types of computer animation in terms of ‘figure’ and ‘ground’ illustrate this. First, the animated figure crosses (arrow of time) the stationary background from left to right, disappears off the screen and reappears cyclically with an inherent frame rate.

In the second case, the animated figure remains permanently fixed in the center of the screen and the background moves continuously from left to right (Arrow of time again) across the screen. For the sake of the metaphor one can say that this latter case is introspective relative to the observer and the first case is objective (quantum) or external to an observer.

Neither of these two views offer a complete description of reality; as noted above, a third case of simultaneity is required. The apparent separateness of the two views; i.e. ‘we live in a quantum universe’ is the root of the problem because as proposed here we live in a continuous-state universe that is classical, quantum and unitary depending on perspective. The challenge here is to show that by adopting this view a model of Universal Quantum Computing with an inherent spacetime synchronization backbone can be delineated.

Noetic Space “leapfrogs” from holographic unitarity to discretized reality. This simplifies the boundary conditions and variables needed for UQC operations. The 12D Multiverse surface is considered a new form of Absolute Space (AS) and our observed Euclidean E₃ is a pseudo-AS or subspace of this regime.

Because leapfrogging which is a fancy form of Witten's Ising flip of the covariant string vertex (FIG. 5). The E₃ pseudo-AS is a periodic discretization or ‘frozen moment’ of one 4D set of the 12D parameters (when time is included). This gives the least unit of the superspace the geometry of a torus; or in our Wheeler-Feynman future-past model considered as two 4D advanced-retarded Calabi-Yau 3-tori. This suggests the boundary conditions A:B; A′:B′ are HD boundary conditions of a harmonic oscillator allowing coherent control of the UQC to be operated with 4D parameters.

As well known the usual form of Maxwell's equations in vacuum with m_{γ}0 and B⁽³⁾=0 has infinite families of boundary free exact solutions with the Lorentz gauge vector potential A_{μ}=0; but in the noetic case with m_{γ}≠0 where Maxwell's equations do not cut off at the vacuum, there is only one family and one set of boundary conditions, a model justified empirically by the existence of the Casimir and Zeeman effects. EM theory implies the effects of the EM vector 4-potential A_{μ} on the phases, S of quantum mechanical waves

$$Δ S = \frac{q}{h} \int φ d t - \frac{q}{hc} \int \vec{A} \cdot d \vec{S} . \qquad ( 21 )$$

For the continuous-state integration the mass term, m_{γ} is introduced into Maxwell's equations. One may also describe gravity with a four-vector density A_{μ}^{g} so that the Newton and Coulomb potentials take the same form but with different coupling constants suggesting both are different aspects of the same fundamental (unified) field with A_{μ}A_{μ}→0 where A_{μ} denotes the total four-potential in a covariant polarized Dirac vacuum.

From the EM vector potential A^{μ}(x) where F_{νμ}=A_{ν,μ}−A_{μ,ν}* the components of E and B form second rank dual antisymmetric spacetime field strength tensors F^{μν}(Adv), *F^{μν}(Ret) defined as F^{μν}=∂^{μ}A^{ν}−∂^{ν}A^{μ} and *F^{μν}=½εexp μνρσ F_{ρσ} respectively as matrices

$$\begin{matrix}{F}^{μ v} ≡ ( \begin{matrix}0 & - {E}^{x} & - {E}^{y} & - {E}^{z} \\ {E}^{x} & 0 & - {B}^{z} & {B}^{y} \\ {E}^{y} & {B}^{z} & 0 & - {B}^{x} \\ {E}^{z} & - {B}^{y} & {B}^{x} & 0\end{matrix} ) , & ( 22 a ) \\ {}_{}^{*}{F}{}_{}^{μ v} ≡ ( \begin{matrix}0 & - {B}^{x} & - {B}^{y} & - {B}^{z} \\ {B}^{x} & 0 & {E}^{z} & - {E}^{y} \\ {B}^{y} & - {E}^{z} & 0 & {E}^{x} \\ {B}^{z} & {E}^{y} & - {E}^{x} & 0\end{matrix} ) & ( 22 b )\end{matrix}$$

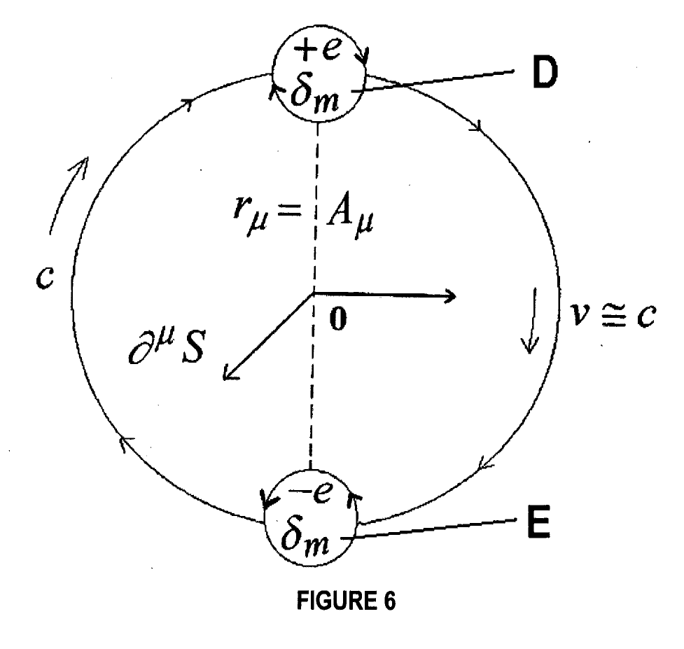

If properties of the Dirac vacuum are expanded to conform with noetic cosmology, FIG. 6 graphically represents the integration of Eqs. (12) and (13) on the top of the Dirac sea where the central point is a space-like radial 4-vector A_{μ}=r_{μ} exp(iS/) with frequency ν=m_{γ}c²/. The oppositely rotating dipoles ±e correspond to gravity and EM with each individual sub-element 4-momenta ∂_{μ}S. FIG. 5 represents one close-packed noetic hypersphere least-unit just below this regime which is the vertex at 0 where further unification to the unitary field occurs.

This is only a superficial account of the highly essential relevance of the complementarity of the G_{μν}−F_{μν} coordinate systems. To simplistically summarize the dynamics of the continuous-state SUSY symmetry breaking are key to the ontological properties of this putative model of bulk UQC.

The G-EM coordinates couple and uncouple fixing one and then the other in a dual seesaw-leapfrogging effect which is like a form of topological wave-particle duality. It is the utilization of this structural-phenomenology as a covariant resonant hierarchy that allows the ontological violation of the Copenhagen regime uncertainty principle.

The triune geometry of FIG. 5 represents the point 0 in FIG. 6 known as an (sing lattice array. This is similar to the vertex in string theory able to topologically undergo spin flips of the Riemann sphere from zero to infinity.

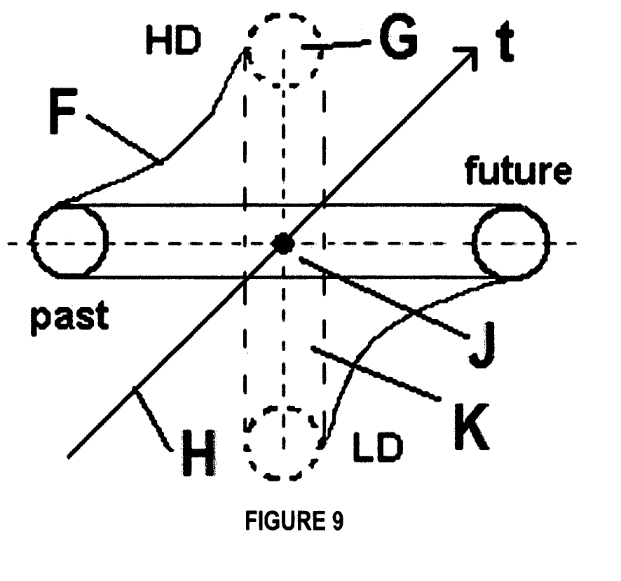

In these continuous-state points the Ising vertices as governed by the super quantum potential (unified field) as described by the noetic field equation, FIG. 9. There is a foreground and background duality where the EM and G metric alternate fixing and continuously “leapfrog” in the spacetime backcloth.

These factors are imposed on spacetime geometry by the symmetry conditions of noetic cosmology. Traditionally parallel transport of a vector or spinor around a closed path P, Q, R (2-sphere) or P, Q, R, S (3-sphere) generally results in a deficit angle, a mass deficit that signifies the amount of curvature at that vertex when the Riemann tensor is ≠0.

Tiny loops approximated by a parallelogram of two tangent vectors \vec{μ} and \vec{ν} close (no deficit) if [\vec{μ}, \vec{ν}]=0; then the curvature operator is the commutator of covariant derivatives along \vec{μ} and \vec{ν}, R(\vec{μ}, \vec{ν})=[∇_{\vec{μ}, ∇}_{\vec{ν}}]. If [\vec{μ}, \vec{ν}]≠0, ∇_{\vec{μ}, ∇}_{\vec{ν}] is subtracted from the commutator, the parallelogram doesn't close and the Riemann tensor is ≠}0.

This is aided by the gravitational curvature of spacetime; if the sum of the three internal angles of a triangle minus π is the Gaussian curvature integral (α₁+α₂+α₃)−π∫KdA with K the Gaussian curvature. Or on a sphere of radius r with α₁=α₂=α₃=π/2 the area of the triangle is (4πr²)/8 and the Gaussian curvature would be K=1/r² which is positive.

The dominant view among cosmologists regarding XD is that if they exist they must be microscopic because they are not observed in the same manner that the 10⁻³³ cm Planck scale is not observed. Even though M-Theory is cast in HD, perhaps a majority of physicists are still opposed to dimensionality >4D because as yet there is no empirical evidence. In noetic cosmology the XD are macroscopic and take part in the creation and recreation of spacetime, the arrow of time and observed macroscopic reality.

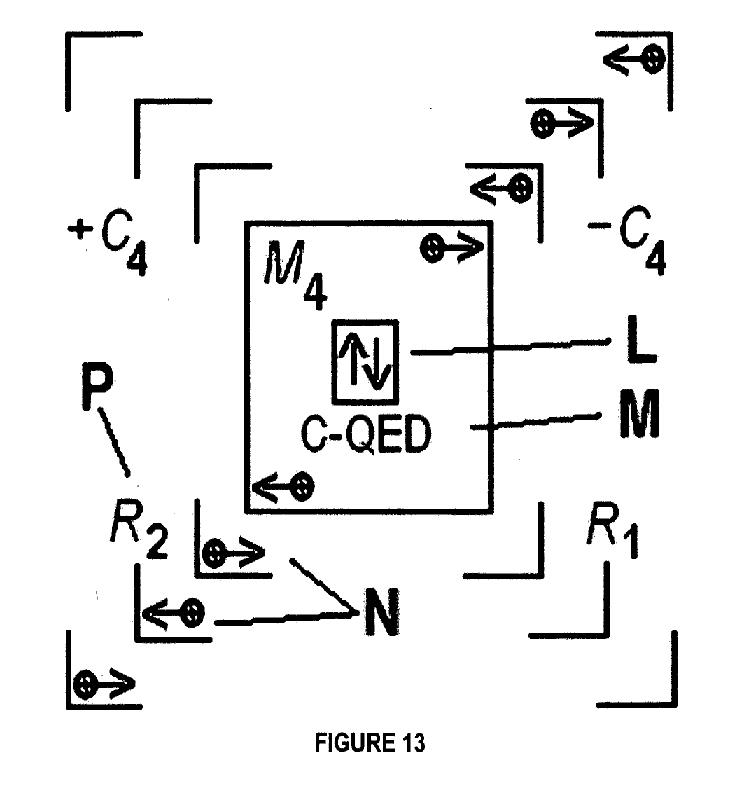

This scenario arises during the inherent ‘continuous-state spin-exchange dimensional reduction compactification process’ by parallel transport within the additional context of a dual Dirac spherical rotation of the least-unit topology (FIG. 5) of subspace elements producing deficit angles during decoupling-coupling allowing relativistic subtraction of supralocal-nonlocal domain components (FIGS. 5 & 6) producing the arrow of time/reality. The scaling process begins in the microscopic backcloth without a physical arrow of time and ramps up the helicoid hierarchy (FIG. 13) to the virtual standing-wave macroscopic present.

Because of its relativistic nature the ‘leapfrog’ passing (coupling-decoupling) between domains appears smooth to the Euclidean observer. FIGS. 13 & 14 are meant to be synonymous with the lightcone leapfrogging domain frequency modes to provide the context for assigning coupling parameters required for utilizing the synchronization backbone for the Bulk UQC.

### Geometric Introduction to the Noetic UQC Ontology

What are the topological conditions required to achieve a commutative ontology for UQC? Newton's 2^{nd} Law of motion says position and velocity completely determine an observable's ‘state’, (p, q) at an instant in time. Quantum mechanically an observable has a probabilistic distribution of values (P, Q), with quantization making correspondence between the two; conditions that delineate the uncertainty principle and provide no framework for a pragmatic absolute ontology. In HAM cosmology neither spacetime nor stochasticity is considered fundamental.

This is not a different basis than the concept of Heisenberg's potential; so what is required is a new process. Spacetime is a continuous harmonic state comprised of the Amoroso-Vigier dual EMS⇄μνmetric comprised of conventional transverse ‘EM’ elements described by Maxwell's traditional equations plus longitudinal μν elements with additional degrees of freedom derived from the Einstein-de Broglie relation E=hv=mc² (with m=m₀(1−ν²/c²)^{-1/2}) such that Maxwell's equations do not ‘cut off’ at the vacuum.

Evidence for such a metric is implied by the Casimir, Zeeman & Aharonov-Bohm effects. These two sets of coordinates EM+μν would generally be exclusive and independent. The aim here is to reveal a framework for their ‘continuous-state’ integration, not in 4D as previously done but in 12D where integration is completed to unitarity.

The close-packed least unit hypersphere tiling of this noetic superspace is a complex self-organized scale invariant anticipatory system. Operational interplay of the parameters of the fundamental least unit is discretized macroscopically into perceived Euclidean reality. Normally local application of an observational RF pulse in the arbitrary z direction discretizes the uncertainty relations of microscopic quantum states for particles. This is called space quantization.

To avoid product-ion of these uncertainties inherent in the quantum principle (by definition), a new set of Noetic transformations beyond the Galilean-Lorentz-Poincaré must be implemented by a cumulative interaction methodology to allow a ‘coherent control’ transformation of the phenomenology of discretization into an ontological superposition of the information.

To illustrate mechanically, we apply general principles for ‘pure rolling contact’ to the transmission of angular momentum translating through the topology of this HD spin tower, the relative motion of consecutive elements propagate successively in proper order with the elements of parallel axes in the corresponding topological surface. These motions may be ±coupled combinations relative to the center of mass and components of angular momentum that are singular (degenerate), linear, circular, cylindrical, spherical and hyperspherical as in branes.

This reveals the richness of the cosmological least unit as it undergoes continuous-state spin-exchange (rolling contact) compactification (past orientation) and Ising dimensional flip (future orientation) in quantifiable stages of dimensional jumps from 12D to 0D by superluminal Lorentz boosts in cyclic progression S→t→E and C→Q→U (space to time to energy; classical to quantum to unitary, zero to infinity).

Twelve dimensions is the minimum to describe eternity or escape from the temporal bounds of uncertainty, a result of the dimensional tower (FIGS. 13 & 14) where time and E₃/M₄ is a standing wave subspace of eternity. This structure whether Calabi-Yau, dodecahedral, or some M-Theory, F-Theory combination entails a reciprocal spiral topology.

In this context we utilize logarithmic, helicoid or cyclotron resonance spirals to illustrate new angular momentum commutators. The future-past asymmetry has a Doppler relationship (relative only to the perception of the 4D observer). E & E′, therefore represent equal Wheeler-Feynman future/past symmetries.

The Doppler effect arises because of inherent E-E′ boosts and compactifications. In this picture the Wheeler-Feynman-Cramer elements may be understood conceptually by pairs of logarithmic spirals of equal obliquity rolling on a common tangent, ed where each coupled point signifies a present spacetime moment; the locus of which (ed) is the arrow of time.

A radiant of spiral, r is

r=ae^{bθ} (23)

with a the value of r if θ=0, e base of the Naperian logarithms and b=1/tan φ, with φ the constant angle between the tangent to the curve and radiant to the point of tangency. If the value of θ takes uniform increase (quantized values) the radiants, r will be ct=0, 1, 2, 3 . . . , n in geometric progression relative to the hierarchal topology of the space.

These log curves are not closed; to adapt to continuous motion, pairs must be utilized. Joining corresponding sections of the spiral form symmetrical unilobed wheels. While sectors needn't be equal or symmetrical, the ‘wheels’ must be paired with sectors of equal obliquity in contact for pure rolling motion to occur. Wheels may also be bilobed or trilobed etc. up to ND to illustrate the Superspace. A tier of three symmetrical wheels.

The mechanical concept of rolling contact is used to geometrically illustrate the ontological framework for the new noetic commutation rules of angular momentum. A logarithmic spiral coupled to another of the same obliquity undergoes perfect rolling motion (no slippage and constant touching) as long as arcs of the same obliquity coincide. This system of spirals reaches a limit that could be said to be points of Ising flip; but the rotation is not continuous.

Making the rolling continuous requires 2 sections of the logarithmic spiral joined into a spheroid. Then continuous motion may occur. This single lobed gear may be made bilobed or trilobed, again for continuous or perfect rolling motion proper obliquity must be maintained.

Here as in the sensory apparatus of the ear the points of contact correspond to frequencies. If the point of contact corresponds to the z axis we have moments of commutation of angular momentum. Leaving one gear set (the spin tower of frequencies) we have a system of close packed spheres of least cosmological units undergoing the noetic mantra (spin-exchange, dimensional reduction, compactification) which means that there are HD moments of commutation in the 12D structure.

Since angular momentum is the resultant of the atomic magnetic moment and (center of mass) harmonic frequencies (as in the cyclotron frequencies of synchrotron radiation) should make these other (x and y) components of angular momentum accessible, In any given discretized (composite) E₃ frame only the z axis will commute as per standard quantum theory; but in the complex HD space the E₃ non-commutative parameters commute periodically on rotation through mirror tangent nodes of proper obliquity in the continuous state topology; i.e. in considering all HD hyperplanes, there are periodic simultaneous moments where nodes of commutation may be accessible by synchronizing RF pulses of the proper harmonic cyclotron frequency.

Bessel functions could be used to manipulate the complex cavity resonance modes. For example in a generalized Cramer event cavity (between future-past topological boundaries) the magnitude of a uniform applied electric field with E₀ constant can be taken as E=E₀e^{iωt}.

If the frequency increases the electric field flux through any loop Γ₁ produces an oscillating magnetic field B=iωr/2c²·E₀e^{iωt} proportional to r, the radius of the cavity. This varying magnetic field, proportional to the rate of change of E and thus ω, effects the electric field so it can no longer be uniform by Faraday's Law and also changes with r.

This requires corrections to our original uniform field E₁ such that the corrected field must now be E=E₁+E₂+E₃ . . . Eₙ which is best described by the Bessel function J₀ with

$${J}_{0} ( x ) = 1 - \frac{1}{{( 1 ! )}^{2}} {( \frac{x}{2} )}^{2} + \frac{1}{{( 2 ! )}^{2}} {( \frac{x}{2} )}^{4} + \frac{1}{{( 3 ! )}^{2}} {( \frac{x}{2} )}^{6} + … \qquad ( 24 )$$

such that E is now

$$E = {E}_{0} {e}^{i ω t} {J}_{0} ( \frac{ω r}{c} ) . \qquad ( 25 )$$

### Microphysical Computation Limits: Case of Relativistic Qubits

In the conventional consideration of quantum computing a quantum bit or qubit is any 2-state quantum system defined as a superposition of two logical states of a usual bit with complex coefficients that can be mapped to the Riemann sphere by stereographic projection.

Formally a qubit is represented as: Ψ=ξ|0>+η|1> with each ray ξ, ηεC in complex Hilbert space and ∥Ψ∥²=ξ ξ̅+η η̅=1, where |0> corresponds to the south or 0 pole of the Riemann sphere and |1> corresponds to the opposite or north or ∞ pole of the Riemann complex sphere.

The conventional qubit maps to the complex plane of the Riemann sphere as:

ξ η̅+η ξ̅Δ→X,ξ η̅−η ξ̅→iY,ξ ξ̅−η η̅→Z (26)

Unitary transformations of a qubit correspond to 3D rotations of the Riemann sphere. Following Vlasov for relativistic consideration of a qubit (r-qubit) an additional 4D parameter is added to equation (24):

ξ η̅+η ξ̅→X, ξ η̅−η ξ̅→iY,

ξ ξ̅−η η̅→Z, ξ ξ̅→Z, ξ ξ̅+η η̅→T (27)

In cartography and geometry, stereographic projection is a mapping projecting each point on a sphere onto a tangent plane along a straight line from the antipode of the point of tangency (with one exception: the center of projection, antipodal to the point of tangency, is not projected to any point in the Euclidean plane; it is thought of as corresponding to a “point at infinity”). One approaches that point at infinity by continuing in any direction at all; in that respect this situation is unlike the real projective plane, which has many points at infinity.

### Essential Parameters of the Incursive Oscillator

The evolution of physical theory from Classical to Quantum changed the fundamental understanding of a point or point particle from continuous—represented in 3D Euclidean space, to discrete fuzzy units with wave-particle duality—represented in 3(4)D Minkowski/Riemann spacetime. As physical cosmology has evolved towards M-Theory it is now realized that neither of these contexts is sufficient or complete.

In Multiverse cosmology the nature of a vertex or point changes into a continuous-state 12D superspace. This means there are three regimes existing simultaneously/individually: Classical, Quantum and Unity depending on mode of observation.

Motion of a one-dimensional classical harmonic oscillator is given by q=A sin(ωt+φ) and p=mωA cos(ωt+φ) where A is the amplitude and φ is the phase constant for fixed energy E=mω² A²/2.

For state |n [symbol] , with n=0, 1, 2, . . . , ∞ and with the Hamiltonian Eₙ=(n+½)ω the quantum harmonic oscillator becomes [symbol] n|q²|n [symbol] =/2mω [symbol] n|(a†a+aa†)|n [symbol] =Eₙ/mω² and [symbol] n|p²|n [symbol] =½(mω) [symbol] n|a†a+aa†=mEₙ where the terms a and a† are the annihilation and creation operators, q=\sqrt{/2mω}(a†+a) and p=i\sqrt{mω/2}(a†a).

For the 3D harmonic oscillator each equation is the same with energies Eₓ=(nₓ+½)ωₓ, E_{y}=(n_{y}+½)ω_{y} and E_{z}=(n_{z}+½)ω_{z}.

In Dubois' notation the classical 1D harmonic oscillator for Newton's second law in coordinates t and x(t) for a mass m in a potential U(x)=½(kx²) takes the differential form

$$\frac{{d}^{2} x}{d {t}^{2}} + {ω}^{2} x = 0$$

where

ω=\sqrt{k/m} (28)

which can be separated into the coupled Eqs. (29)

$$\frac{d x ( t )}{d t} - v ( t ) = 0 and \frac{d v ( t )}{d t} + {ω}^{2} x = 0. \qquad ( 29 )$$

From incursive discretization, Dubois creates two solutions x(t+Δt) v(t+Δt) providing a structural bifurcation of the system which together produce Hyperincursion. The effect of increasing the time interval discretizes the trajectory. This represents a background independent discretization of spacetime, a key element in overcoming the usual space quantization.

Each mode of a quantum harmonic oscillator is associated with cavity-QED dynamics, hexagon lattices of spacetime topology undergoing continuous transitions. E is the state of energy for n photons. For n=0 the oscillator is in the ground state, but a finite energy ½ω of the ground state, called the zero-point energy, is still present in the region of the cavity.

According to Eq. (30), the quantum harmonic oscillator field energy of the photons undergo periodic annihilation and recreation in the periodic spacetime.

$${E}_{n} = ( n + \frac{1}{2} ) ℏω . \qquad ( 30 )$$

### Ontological I/O by Superseding Quantum Uncertainty

The critical problem in applying conventional QT to the bulk implementation of QC lies in the accompanying theory of measurement; variables observed change destructively in any interaction between particle and observing apparatus. This phenomenological force of interaction is mediated by particle exchange which modifies the Schrödinger equation. In conventional terms ‘physical reality is irreducibly quantum’ and a qubit resides at a Euclidean, E³ or Minkowski, M⁴ vertex.

All attempts for bulk QC have failed in the Copenhagen regime because measurement destroys the quantum system being measured. To overcome this problem the Dirac equation is hyperdimensionalized (complexified) utilizing an extension of Cramer's Transactional Model of QT where all off diagonal elements are physically real and conformally invariant.

Bulk implementation of UQC requires a new superspace N¹² without a real vertex where not only the arbitrary z-axis of angular momentum accessible; but the x and y components are also real and accessible by a new anticipatory transformation law for ontological evolution utilizing topological switching. This is elucidated by unfolding a hypercube (FIG. 4). Relative to the subspace E₃ the extra square called a satellite is causally free of E₃ when carried to 12D unitarity.

During the HD continuous-state topological transformation of the cosmological form of Dirac spherical rotation, a pinch or twist occurs in the middle of the transform followed by an (sing flip of the close-packed complex Riemann spheres which can be driven by the micromagnetic spintronics of fractional and integer quantum Hall effects because of the highly symmetric topological parameters of driven Micromagnetics.

This UQC can be implemented in any sufficient multi-state quantum system, whether solid, liquid, bubble, crystal, dot, network, trap, well, vacuum backcloth, comprised of atoms, molecules, ions, photons, spins, NMR, threads, lines, block walls, domain walls, lattices or arrays or topological boundary conditions able to utilize coherent control of the synchronization backbone promoted by Feynman.

In order to avoid the Copenhagen limitations of collapse and dissipation UQC requires utilization of the hierarchical and recursive properties of complex self-organization inherent in the whole universe, not just a portion of its observed parameters. The critical condition is the introduction of a model for evolution of the wave function making correspondence to a new non-collapse (ontological or energyless) version of RQFT.

By a coherent control of Ising spin flips of the noetic spacetime least-units (an ontological topological switching of metrics) domains of discretization (ΔxΔρ≅) may be avoided by utilizing periodic nodes in the resonant hierarchy that are commutative because the Riemann curvature tensor equals zero. E₃ is a discretization, a composite of future-past potentials.

In HD where the parameters are separated one can manipulate commutative and noncommutative regimes. Another way to illustrate the intended use of coordinated RF sine wave π−pulses with the geometry of spatial rotations of a pair of common dice to show that some rotations commute, a [symbol] b=b [symbol] a and others are noncommutative a [symbol] b≠b [symbol] a.

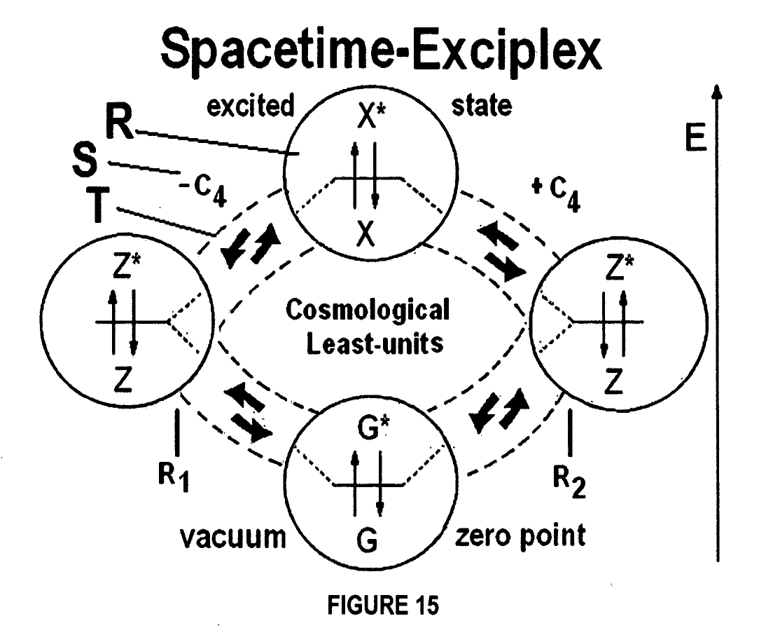

The general equations for a putative spacetime exciplex (FIG. 15) are:

$${G}^{*} + {G}^{*} {Z}^{*} ; {Z}^{*} + {m}_{γ} {X}^{*} \\ {X}^{*} - {m}_{γ} {\to }^{emission} {Z}^{*} {orG}^{*} \\ {X}^{*} + {m}_{γ} -> {Z}^{*} or {G}^{*} \qquad ( 31 )$$

where G is the ZPF ground, Z black body cavity excited states and X the spacetime C-QED exciplex coupling. The numerous configurations plus the large variety of photon frequencies absorbed allow for a full black body absorption-emission equilibrium spectrum.

The spacetime exciplex model also has sufficient parameters to allow for the spontaneous emission of protons by a process similar to the photoelectric effect but from spacetime C-QED spallation rather than from metallic surfaces.

A torus is generated by rotating a circle about an extended line in its plane where the circles become a continuous ring. According to the equation for a torus, [(\sqrt{x²}+y²)−R]²+z²=r², where r is the radius of the rotating circle and R is the distance between the center of the circle and the axis of rotation.

The volume of the torus is 2π²Rr² and the surface area is 4π² Rr, in the above Cartesian formula the z axis is the axis of rotation. Electron charged particle spherical domains fill the toroidal volume of the atomic orbit by their wave motion. If a photon of specific quanta is emitted while an electron is resident in an upper more excited Bohr orbit, the radius of the orbit drops back to the next lower energy level decreasing the volume of the torus in the emission process.

We suggest that these toroidal orbital domains have properties similar to QED cavities and apply this structure to topological switching during dimensional reduction in the continuous state multiverse (HAM) model.

### A Twistor Approach to the UQC I/O Ontology

Because of the essential requirement of utilizing an HD form of Dirac spherical rotation to access the inherent synchronization backbone in HAM cosmology; it is suggested that a Penrose twistor approach provides the most efficient methodology for coupling to the resonant hierarchy. We illustrate this only briefly here and leave it to a future paper or other QC researchers to develop more fully.

Given the worldline, y^{a}(s) and then following Bailey and Penrose, from the fundamental twistor relation, Z^{α}=(ω^{A},π_{A′}) the function ξ^{A}(s)=ω^{A}−iy^{AA′}(s)π_{A′} is then defined. Then for the scalar field contours we define a twistor function ƒ(Z^{α}) by

$$f ( {Z}^{α} ) = ∮ \frac{d s α \cdot β}{( α \cdot ξ ) ( β \cdot ξ )} \qquad ( 32 )$$

where α_{A} and β_{A} are fixed spinors and α·β=α_{A}β^{A}.

In this regime the field produced by the unit charge has poles corresponding to advanced and retarded points on the worldline. Taking an EM field potential ΦAA′(x) with left and right handed components given by φA′B′=∇_{A′φB′A}^{A} and φAB=∇_{AφBA′}^{A′} respectively.

Twistor functions describe relative cohomology classes in [symbol] regions; but the same twistor functions may also be examined geometrically in M⁴. The contour in Eq. (32) is a small loop around the α·ξ=0 and β·ξ=0 poles. There are two of these, one for advanced and one for retarded solutions.

When a singularity is reached (Dirac pinch) one switches from ƒ(α) to β(β). In a small neighborhood U of L, U_{α},U_{β} keeps away from the branching singularity of ƒ(α), ƒ(β). The process of doing contour integrals gives a well-defined field; choice of contour gives any linear combination of Adv. and Ret. solutions. The α and β spinors represent opposite directions in E³ but not in the same regions. The contours move continuously from Ret to Adv.

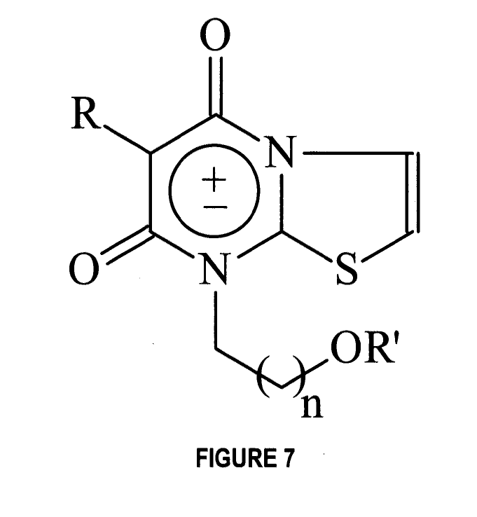

Taking the spin structure hierarchy of 1-4 benzosemiquinone or class II mesoionic xanthines (FIG. 7) for example and aligning it with the inherent synchronization-backbone of noetic cosmology using the Dirac spherical rotation contour integrals as defined by the Penrose twistor functions as an intermediary we are able to achieve the rolling motion contacts suggested metaphorically. but in the Dirac spherical rotation manner.

Why? This is to achieve ontological topological switching with the satellite regime of FIG. 4. Noetic theory postulated that this path is only open periodically (like a holophote) in the continuous-state leapfrogging of the Vigier-Amoroso coordinates. These coordinates fix and unfix; this elevates to a cosmological principle utility of the Dirac rotation first discovered for the electron.

This complexity arises because the Dirac pinch is a fundamental process of reality (not just electron spin) since the eternal origin of the unitary field is causally separated from E³. To comprehend one must contemplate the interplay of the three regimes (classical, quantum, unitary) and the domain where Dirac pinch occurs.

In order for the I/O pulses to achieve coupling to the proper leapfrogging contours, the resonance modes of the RF pulses must align precisely with the inherent beat frequency of the spacetime backcloth.

Without this coherent control the inherent synchronization backbone provides no cumulative interaction occurs with the Dirac spherical rotation hierarchy and no ontological initialization or processing of the QC registers. The QC remains stuck with the uncertainty principle at the low qubit limit achieved in the Copenhagen regime. Added benefits of the incursive oscillator instead of the continuous z field is key.

### Class II Mesoionic Xanthines as Potential 10-Qubit Quantum Computer Substrate Registers

A better embodiment than the 1-4 benzosemiquinone, molecule are Class II mesoionic xanthines such as anhydro-(8-hydroxyalkyl-5-hydroxy-7-oxothia-zolo[3,2-a]pyrimidinium hydroxides) are unique, small atomic weight, stable crystalline organic compounds that can be represented as a combination of ten different resonance structures for each simple xanthine molecule.

Each resonance structure contributes a certain percentage to the total resonance of the molecule. This unique resonance represents ten different quantum states of the entire molecule and can thus be exploited as a potential substrate for a ten-qubit register.

The number of possible superposition states for such a register in a single molecule is potentially as high as 2ⁿ states or (in this case where n=10) 1,024 complex numbers. In solution the least-unit of this mesoionic crystalline structure is scalable suggesting putative utility for bulk NMR quantum computing.

These 10-qubit registers are amenable to standard Deutsch-Jozsa, Shor and Grover algorithms. We formalize I/O techniques for Class II mesoionic xanthines based on a coherent control RF process of cumulative resonant interaction utilizing additional degrees of freedom pertinent to a relativistic basis for the qubit (r-qubit) new HD commutation rules allow decoherence to be ontologically overcome.

Mesoionic purinone analogs, a large and relatively new class of bicyclic heteroaromatic compounds, whose ring systems possess π-electron systems that are isoelectronic with those of the various known purinones, have been synthesized and characterized recently.

Class-I mesoionic analogs have been classified and defined as being those that are derived from known five-membered mesoionic ring systems. Class II mesoionic analogs are those that are derived from known six-membered mesoionic ring systems.

In 1996, Giandinoto, et al. had synthesized and characterized a number of novel Class II mesoionic xanthine acyclonucleosides as potential anti-neoplastic and antiviral agents. Class-I and Class-II mesoioic purinones have been formulated and examined from a quantum chemical standpoint. The generalized structural representation of mesoionic xanthine acyclonucleosides is shown in FIGS. 7 & 8.

In particular, the mesoionic xanthine acyclonucleosides where R′=H are especially useful since this moiety is ideal in giving the molecule a handle for attaching it to metallic, organic, polymeric or semiconductor surfaces/substrates such as GaAs, GaN, CdSe/ZnS. The definition of a mesoionic compound is a compound that cannot be adequately represented by any single covalent or single dipolar resonance structure.

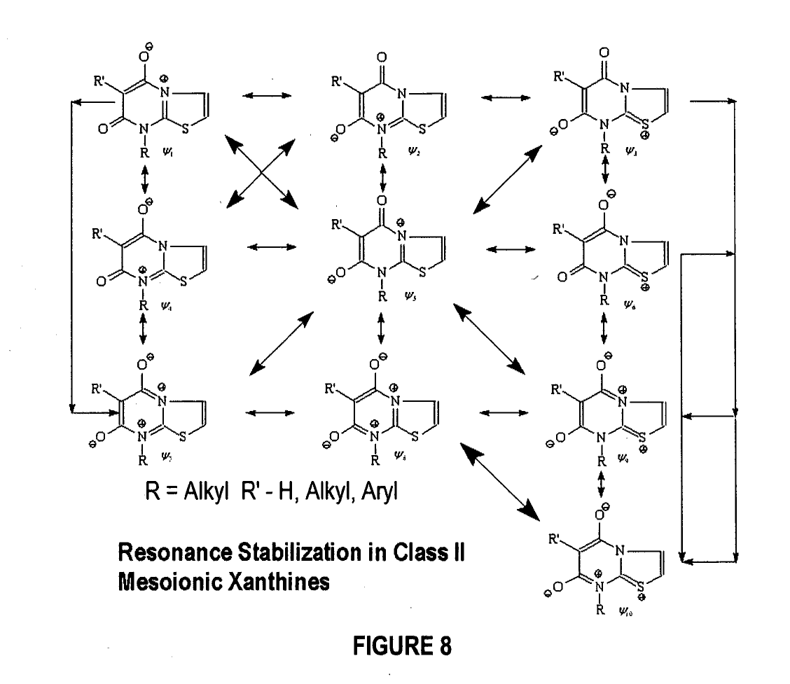

These Class II mesoionic xanthines, such as anhydro-(8-hydroxyalkyl-5-hydroxy-7 oxothiazolo[3,2a]pyrimid-inium hydroxides) cannot be adequately represented by fewer than ten different resonance contributors. FIG. 8 illustrates these ten resonance forms and all of their possible quantum inter-conversion states.

Each resonance structure shown in FIG. 8 corresponds to an individual quantum state of the total molecule and all ten are required to adequately represent the molecule in its totality of superposed quantum states. In quantum computing, there may be multiple quantum states in superposition. In this particular case where there are ten qubits, the quantum state of superposition would be the following orthonormal basis set |ψ [symbol] =αᵢ|x₁x₂x₃ . . . xₙ [symbol] for all i=1-1,024 and for all n=1-10 where xₙ is either 0 or 1.

More succinctly the above may be written:

$$: \vert ψ 〉 = {\sum }_{i = 1}^{N} {α}_{i} \vert i 〉$$

where |i [symbol] is a shorthand notation for an orthonormal basis set of indices {i₁, i₂, i₃ . . . iⱼ . . . iₙ} where N=2ⁿ.

The Greek letters αᵢ are referred to as the amplitudes of the register and are complex numbers. In a 10-qubit register, there are therefore 2¹⁰ or 1,024 complex numbers for the total register. Since the probability (|Ψ|²) of a quantum state or set of quantum superposition entangled states must always be equal to one, the following relationship for the coefficients of the quantum registers must also be true.

$${\sum }_{i = 1}^{1 , 024} {α}_{i}^{2} ≡ {\vert Ψ \vert}^{2} = 1. \qquad ( 33 )$$

For a X3-qubit register, there exists an 8D complex vector. For a 10-qubit register there exists a 1,024-dimensional complex vector. In order to initialize this vector space (register) for a quantum computer, an algorithm is necessary. In each step of the algorithm, the vector space is modified by multiplying it with a unitary matrix, which, by definition is a complex matrix.

### Initialization of Mesoionic Xanthine Registers

The mesoionic xanthine molecule, as depicted in FIG. 8, represents a molecule that is in a quantum superposition of at least ten distinct and unique quantum states. An efficient scheme for initializing quantum registers with an arbitrary superposed state, without the introduction of additional qubits has been developed by Long & Sun.

This scheme begins with the state |0 . . . 0 [symbol] and is then transformed to a general superposed state of the following form:

$$\vert ψ 〉 = {\sum }_{i = 0}^{N - 1} {a}_{i} \vert i 〉 .$$

In this particular case, N=1,024 and |i [symbol] is the shorthand notation for the basis set {i₁, i₂, i₃ . . . iⱼ . . . iₙ} where n=log₂ N and where iⱼ denotes the two possible states (0 or 1) of the j^{th}-qubit. |ψ> is a general quantum superposition of N basis states. Each basis state is a product state of n qubits.

The initialization scheme involves only two types of unitary transformations or gate operations. The first gate operation is a single bit rotation

$${U}_{θ} , {U}_{θ} [ \begin{matrix}0 \\ 1\end{matrix} ] = [ \begin{matrix}cos θ & sin θ \\ sin θ & - cos θ\end{matrix} ] [ \begin{matrix}0 \\ 1\end{matrix} ] .$$

This rotation differs from the ordinary because it is an ordinary rotation only for the |0 [symbol] bit, but interjects a minus sign for the |1 [symbol] bit.

The operation thus converts a qubit in the state |0 [symbol] to a superposition of the two-state (cos θ, sin θ) and a qubit in the |1 [symbol] state to the superposition of the 2-state (sin θ, −cos θ).

When θ=0, the state |0 [symbol] remains unchanged but converts the sign of state |1 [symbol] (i.e., Pauli-Z gate). When

$$θ = \frac{π}{4} ,$$

U_{θ} is simply reduced to the Hadamard-Walsh transformation. When,

$$θ = \frac{π}{2} ( 90 ° rotation ) ,$$

it acts as the NOT operation (Pauli-X, σₓ) by changing |0 [symbol] to |1 [symbol] and |1 [symbol] to |0 [symbol] ,

$$i = \{ \begin{matrix}0 -> \{ 000 … 000 \} \\ 1 -> \{ 000 … 001 \} \\ 2 -> \{ 000 … 010 \} \\ 3 -> \{ 000 … 100 \} \\ ⋮ \\ N - 1 -> \{ 111 , … 111 \}\end{matrix} \qquad ( 34 )$$

The second type of gate operation is known as the controlled k-operation. This operation is constructed from a string of k controlling qubits. The squares represent the controlling qubits {i₁, i₂, . . . iₖ} and the circle is a unitary operation on the target qubit representing an angle of rotation. The uniqueness and power of this operation is that it is a conditional one that is activated only when the controlling qubits hold the respective values indicated in the squares. Figure not shown.

Controlled k-operations may be constructed using O(k²) standard 1- and 2-bit gate operations. In order to more easily see how these operations are performed we may take a look at the simple example of a two-qubit system

$$\vert 00 〉 -> \sqrt{{\vert {a}_{00} \vert}^{2} + {\vert {a}_{01} \vert}^{2}} \vert 00 〉 + \sqrt{{\vert {a}_{10} \vert}^{2} + {\vert {a}_{11} \vert}^{2}} \vert 10 〉 .$$

Operation 1) Single bit rotation α₁, →|0 [symbol] [a₀₀|0 [symbol] +a₀₁|1 [symbol] ]+|1 [symbol] [a₁₀|0 [symbol] +a₁₁|1 [symbol] ] Operation 2) Two controlled-operations U_{α2,i} (i=0, 1)=a₀₀|00 [symbol] +a₀₁|01 [symbol] +a₁₀|10 [symbol] +a₁₁ [symbol] ).

The single bit rotation

$${α}_{1} is equal to {tan}^{- 1} \sqrt{\frac{{\vert {a}_{10} \vert}^{2} + {\vert {a}_{11} \vert}^{2}}{{\vert {a}_{00} \vert}^{2 } + {\vert {a}_{01} \vert}^{2}}} .$$

We may now represent the operations in matrix form as well:

$${U}_{α2 , 0} = [ \begin{matrix}\frac{{a}_{00}}{\sqrt{{\vert {a}_{00} \vert}^{2} + {\vert {a}_{01} \vert}^{2}}} & \frac{{a}_{01}}{\sqrt{{\vert {a}_{00} \vert}^{2} + {\vert {a}_{01} \vert}^{2}}} \\ \frac{{a}_{01}^{*}}{\sqrt{{\vert {a}_{00} \vert}^{2} + {\vert {a}_{01} \vert}^{2}}} & \frac{{a}_{00}^{*}}{\sqrt{{\vert {a}_{00} \vert}^{2} + {\vert {a}_{01} \vert}^{2}}}\end{matrix} ] , \\ {U}_{α2 , 1} = [ \begin{matrix}\frac{{a}_{10}}{\sqrt{{\vert {a}_{10} \vert}^{2} + {\vert {a}_{11} \vert}^{2}}} & \frac{{a}_{11}}{\sqrt{{\vert {a}_{10} \vert}^{2} + {\vert {a}_{11} \vert}^{2}}} \\ \frac{{a}_{11}^{*}}{\sqrt{{\vert {a}_{10} \vert}^{2} + {\vert {a}_{11} \vert}^{2}}} & \frac{{a}_{10}^{*}}{\sqrt{{\vert {a}_{10} \vert}^{2} + {\vert {a}_{11} \vert}^{2}}}\end{matrix} ] \qquad ( 35 )$$

The situation becomes even more interesting when using a larger register such as a 3-qubit register having 8 basis states:
Starting from the state |000 [symbol] , a single bit rotation is operated on the
1^{st}-qubit with the angle

$${α}_{1} = {tan}^{- 1} \sqrt{\frac{{\vert {a}_{100} \vert}^{2} + {\vert {a}_{101} \vert}^{2} + {\vert {a}_{110} \vert}^{2} + {\vert {a}_{111} \vert}^{2}}{{\vert {a}_{000} \vert}^{2} + {\vert {a}_{001} \vert}^{2} + {\vert {a}_{010} \vert}^{2} + {\vert {a}_{011} \vert}^{2}}}$$

transforming the initialized state |000 [symbol] to the state

$$\sqrt{{\vert {a}_{000} \vert}^{2} + {\vert {a}_{001} \vert}^{2} + {\vert {a}_{010} \vert}^{2} + {\vert {a}_{011} \vert}^{2}} \vert 000 〉 + \sqrt{{\vert {a}_{100} \vert}^{2} + {\vert {a}_{101} \vert}^{2} + {\vert {a}_{110} \vert}^{2} + {\vert {a}_{111} \vert}^{2}} \vert 100 〉 .$$

Then, two controlled-rotations with angles

$${tan}^{- 1} \sqrt{\frac{{\vert {a}_{010} \vert}^{2} + {\vert {a}_{011} \vert}^{2}}{{\vert {a}_{000} \vert}^{2} + {\vert {a}_{001} \vert}^{2}}} and {tan}^{- 1} \sqrt{\frac{{\vert {a}_{110} \vert}^{2} + {\vert {a}_{111} \vert}^{2}}{{\vert {a}_{100} \vert}^{2} + {\vert {a}_{101} \vert}^{2}}}$$

operate on the 2ⁿd qubit.

The resulting superposed state vector becomes:

$$\sqrt{{\vert {a}_{000} \vert}^{2} + {\vert {a}_{001} \vert}^{2}} \vert 000 〉 + \sqrt{{\vert {a}_{010} \vert}^{2} + {\vert {a}_{011} \vert}^{2}} \vert 010 〉 + \sqrt{{\vert {a}_{100} \vert}^{2} + {\vert {a}_{001} \vert}^{2}} \vert 100 〉 + \sqrt{{\vert {a}_{110} \vert}^{2} + {\vert {a}_{111} \vert}^{2}} \vert 110 〉 .$$

Finally, 4 controlled-unitary transformations operate on the 3^{rd}-qubit to generate the superposed state: a₀₀₀|000 [symbol] +a₀₀₁|001 [symbol] +a₀₁₀|010 [symbol] )+a₁₀₀|100 [symbol] +a₀₁₁|011 [symbol] +a₁₀₁|101 [symbol] +a₁₁₀|100 [symbol] +a₁₁₁|111 [symbol] ).

These 4 controlled-unitary transformations are:

$${U}_{α3 , 00} = [ \begin{matrix}\frac{{a}_{000}}{\sqrt{{\vert {a}_{000} \vert}^{2} + {\vert {a}_{001} \vert}^{2}}} & \frac{{a}_{001}}{\sqrt{{\vert {a}_{000} \vert}^{2} + {\vert {a}_{001} \vert}^{2}}} \\ \frac{{a}_{001}^{*}}{\sqrt{{\vert {a}_{000} \vert}^{2} + {\vert {a}_{001} \vert}^{2}}} & - \frac{{a}_{000}^{*}}{\sqrt{{\vert {a}_{000} \vert}^{2} + {\vert {a}_{001} \vert}^{2}}}\end{matrix} ] \\ {U}_{α3 , 01} = [ \begin{matrix}\frac{{a}_{010}}{\sqrt{{\vert {a}_{010} \vert}^{2} + {\vert {a}_{011} \vert}^{2}}} & \frac{{a}_{011}}{\sqrt{{\vert {a}_{010} \vert}^{2} + {\vert {a}_{011} \vert}^{2}}} \\ \frac{{a}_{011}^{*}}{\sqrt{{\vert {a}_{010} \vert}^{2} + {\vert {a}_{011} \vert}^{2}}} & - \frac{{a}_{010}^{*}}{\sqrt{{\vert {a}_{010} \vert}^{2} + {\vert {a}_{011} \vert}^{2}}}\end{matrix} ] \\ {U}_{α3 , 10} = [ \begin{matrix}\frac{{a}_{1 , 00}}{\sqrt{{\vert {a}_{100} \vert}^{2} + {\vert {a}_{101} \vert}^{2}}} & \frac{{a}_{101}}{\sqrt{{\vert {a}_{100} \vert}^{2} + {\vert {a}_{101} \vert}^{2}}} \\ \frac{{a}_{101}^{*}}{\sqrt{{\vert {a}_{100} \vert}^{2} + {\vert {a}_{101} \vert}^{2}}} & - \frac{{a}_{100}^{*}}{\sqrt{{\vert {a}_{100} \vert}^{2} + {\vert {a}_{101} \vert}^{2}}}\end{matrix} ] \\ {U}_{α3 , 11} = [ \begin{matrix}\frac{{a}_{110}}{\sqrt{{\vert {a}_{110} \vert}^{2} + {\vert {a}_{111} \vert}^{2}}} & \frac{{a}_{111}}{\sqrt{{\vert {a}_{110} \vert}^{2} + {\vert {a}_{111} \vert}^{2}}} \\ \frac{{a}_{111}^{*}}{\sqrt{{\vert {a}_{110} \vert}^{2} + {\vert {a}_{111} \vert}^{2}}} & - \frac{{a}_{110}^{*}}{\sqrt{{\vert {a}_{110} \vert}^{2}} + {\vert {a}_{111} \vert}^{2}}\end{matrix} ] \qquad ( 36 )$$

For notation purposes we use an “angle” to label a controlled k-operation. If the coefficients are all real, it reduces to an ordinary rotation angle. The notations of angles of the controlled k-rotations, the first subscript designates the target qubit order number and the subscripts following the comma designate the quantum states of the controlling qubits. For example, the 3 in a₃₁ refers to the target qubit and the subscripts (11 in α_{3,11}) refer to the controlling qubits.

In the initialization, operations for the first n−1 qubits are controlled rotations where each rotation depends only on a single real parameter. The rotation angles take on the following general expressions. In the first qubit there is a 1-qubit rotation. The rotation angle is:

$${α}_{1} = {tan}^{- 1} \sqrt{\frac{{\sum }_{{i}_{2} {i}_{3} … {i}_{n}} {\vert {a}_{1 {i}_{2} {i}_{3} … {i}_{n}} \vert}^{2}}{{\sum }_{{i}_{2} {i}_{3} … {i}_{n}} {\vert {a}_{0 {i}_{2} {i}_{3} … {i}_{n}} \vert}^{2}}} .$$

In the 2^{nd} qubit, there are two controlled-rotations:

$${α}_{2 , 0} = {tan}^{- 1} \sqrt{\frac{{\sum }_{{i}_{3} {i}_{4} … {i}_{n}} {\vert {a}_{01 {i}_{3} {i}_{4} … {i}_{n}} \vert}^{2}}{{\sum }_{{i}_{3} {i}_{4} … {i}_{n}} {\vert {a}_{00 {i}_{3} {i}_{4} … {i}_{n}} \vert}^{2}}}$$

$$and$$

$${α}_{2 , 1} = {tan}^{- 1} \sqrt{\frac{{\sum }_{{i}_{3} {i}_{4} … {i}_{n}} {\vert {a}_{11 {i}_{3} {i}_{4} … {i}_{n}} \vert}^{2}}{{\sum }_{{i}_{3} {i}_{4} … {i}_{n}} {\vert {a}_{10 {i}_{3} {i}_{4} … {i}_{n}} \vert}^{2}}} .$$

In general, in the j^{th}-qubit, there are 2⁻¹ controlled-rotations, with each of them having j−1 controlling qubits labeled as i₁ i₂ . . . iⱼ₋₁. The rotation angle in the j^{th}-qubit (j≠n) is given by:

$${α}_{j , {i}_{1} {i}_{2} … {i}_{j - 1}} = {tan}^{- 1} \sqrt{\frac{{\sum }_{{i}_{j + 1} … {i}_{n}} {\vert {a}_{{i}_{1} {i}_{2} … {i}_{j - 1} 1 {i}_{j + 1} … {i}_{n}} \vert}^{2}}{{\sum }_{{i}_{j + 1} … {i}_{n}} {\vert {a}_{{i}_{1} {i}_{2} … {i}_{j - 1} 0 {i}_{j + 1} … {i}_{n}} \vert}^{2}}} . \qquad ( 37 )$$

For the last qubit, where j=n we have 2⁻¹ controlled unitary transformations where:

$${U}_{{α}_{n ,} {i}_{1} {i}_{2} … {i}_{n - 1}} = [ \begin{matrix}\frac{{A}_{0}}{\sqrt{{\vert {A}_{0} \vert}^{2} + {\vert {A}_{1} \vert}^{2}}} & \frac{{A}_{1}}{\sqrt{{\vert {A}_{0} \vert}^{2} + {\vert {A}_{1} \vert}^{2}}} \\ \frac{{A}_{1}^{*}}{\sqrt{{\vert {A}_{0} \vert}^{2} + {\vert {A}_{1} \vert}^{2}}} & - \frac{{A}_{0}^{*}}{\sqrt{{\vert {A}_{0} \vert}^{2} + {\vert {A}_{1} \vert}^{2}}}\end{matrix} ]$$

where A₀=aᵢ_{₁}ᵢ_{₂} _{. . . i}_{ₙ₋₁}₀ and A₁=aᵢ_{₁}ᵢ_{₂} _{. . . i}_{ₙ₋₁}₁.

A₀ and A₁ are real, the operation is simply a rotation and the angle is given by:

$${α}_{n , {i}_{1} {i}_{2} … {i}_{n - 1}} = {tan}^{- 1} ( \frac{{A}_{1}}{{A}_{0}} ) . \qquad ( 38 )$$

We are now ready to initialize quantum superposition registers of three different types starting from the state |0 . . . 0 [symbol] :

1. The evenly distributed state

$$\vert ψ 〉 = {\sum }_{i} \vert i 〉$$

is the most common state in quantum computing. The Hadamard-Walsh gate operation on each qubit generates this form of superposition from the state |0 . . . 0 [symbol] . In this particular case, all of the rotation angles are π/4. In each qubit, the controlling qubits use up all possible combinations and therefore the 2^{j-1} controlled Hadamard-Wash gate operations are reduced to a single Hadamard-Walsh transformation in the p-qubit.

2. The Greenberger-Home-Zeilinger or GHZ state is the maximally entangled state with the superposition 1/\sqrt{2} (|0 . . . 0 [symbol] ±|1 . . . 1 [symbol] ). Suppose we would like to transform the state |0000 [symbol] to the state 1/\sqrt{2}(|0000 [symbol] +|1111 [symbol] ). The circuit below shows this diagrammatically:

The rotation in the 1^{st}-qubit is the Hadamard-Walsh transformation. There are two controlled operations α_{2,0}=0 in the 2^{nd}-qubit that are equal to the identity operation and so does nothing to the qubit.

However

$${α}_{2 , 1} = \frac{π}{2}$$

corresponds to the CNOT operation, so effectively, there is only one controlled-NOT gate in the 2^{nd}-qubit. There are four gate operations in the 3^{rd}-qubit.

$${α}_{3 , 11} = \frac{π}{2}$$

is the |11 [symbol] -CNOT gate and α_{3,00} is the identity operation. α_{3,01} and α_{3,10} are undetermined angles equal to 0/0.

Upon closer examination, however, these angles are equal to 0 and are therefore equal to the identity operation. Therefore, the only gate operation in the 3^{rd}-qubit is the |11 [symbol] -CNOT operation. Similarly, there is only the |111 [symbol] -CNOT operation in the 4^{th}-qubit. Should the circuit contain more than four qubits, the same analysis applies until the last qubit. For the last qubit, the rotation is either

$$\frac{π}{2} for the state \frac{1}{\sqrt{2}} ( \vert 0 … 0 〉 + \vert 1 … 1 〉 ) or - \frac{π}{2} for the state \frac{1}{\sqrt{2}} ( \vert 0 … 0 〉 - \vert 1 … 1 〉 ) .$$

3. In the Grover search algorithm, the state vector is built up in a two-dimensional space spanned by the so-called “marked” state |τ [symbol] and the “rest” state |c [symbol] =Σ_{i·r}|i [symbol] . At any step in the search, the state vector has the form |ψ [symbol] =sin θ|τ [symbol] +cos θ|c [symbol] . In order to initialize such a superposed state, we let |Σ [symbol] =|i₁i₂ . . . iₙ [symbol] be the marked state. We may now construct the state |ψ [symbol] from |0 . . . 0 [symbol] . The amplitudes aᵢ of the basis states

$$\vert ψ 〉 = {\sum }_{i = 0}^{N - 1} {a}_{i} \vert i 〉$$

are aᵣ=sin θ and aᵢ=cos θ/\sqrt{N−1} for i≠τ.

According to the following equation,

$${α}_{1} = {tan}^{- 1} \sqrt{\frac{{\sum }_{{i}_{2} {i}_{3} … {i}_{n}} {\vert {a}_{1 {i}_{2} {i}_{3} … {i}_{n}} \vert}^{2}}{{\sum }_{{i}_{2} {i}_{3} … {i}_{n}} {\vert {a}_{0 {i}_{2} {i}_{3} … {i}_{n}} \vert}^{2}}} ,$$

the rotation angle in the 1^{st}-qubit is:

$${α}_{1} = \{ \begin{matrix}{tan}^{- 1} {Ω}_{1} , & if {i}_{1} = 1 \\ {tan}^{- 1} \frac{1}{{Ω}_{1}} , & if {i}_{1} = 0\end{matrix} \\ where {Ω}_{1} = \sqrt{\frac{( N - 2 ) {cos}^{2} θ + 2 ( N - 1 ) {sin}^{2} θ}{N {cos}^{2} θ}} . \qquad ( 39 )$$

In the k^{th}-qubit, the angle for the |i₁, i₂ . . . iₖ₋₁ [symbol] -controlled rotation is therefore:

$${α}_{k , {i}_{1} , {i}_{2} … {i}_{k - 1}} = \{ \begin{matrix}{tan}^{- 1} {Ω}_{k} , & if {i}_{k} = 1 \\ {tan}^{- 1} \frac{1}{{Ω}_{k}} , & if {i}_{k} = 0\end{matrix} \\ where {Ω}_{1} = \sqrt{\frac{( N - {2}^{k} ) {cos}^{2} θ + {2}^{k} ( N - 1 ) {sin}^{2} θ}{N {cos}^{2} θ}} \qquad ( 40 )$$

A viable organic molecule, a Class II Mesoionic Xanthine, has been introduced as a potential 10-qubit register substrate for scalable quantum computing. We have shown that the ground state of this xanthine molecule exists in a superposition of ten unique wave functions. These unique wave functions can form the basis of 10-qubit registers for quantum computation.

Additionally a formalism was devised whereby these registers may be efficiently initialized, subsequently read into and transformed via standard unitary algorithms. We propose that polar solutions of the mesoionic xanthines or small crystalline quantum dots may be suitable for I/O techniques.

Furthermore, these solutions or quantum dots may be RF laser pulsed at a certain set of frequencies to produce a cumulative resonant interaction within the xanthines to exploit higher degrees of freedom resulting from new HD commutation rules. Relaxation of the numerous excited states via these HD commutation rules are putatively a vehicle to ontologically overcome the decoherence problem associated with QC applications. This ability overcomes the major obstacle for bulk quantum computing.

### Technological Conclusions

The debate over the completeness of quantum theory has raged for nearly one hundred years. There is more to do; but here we bring it to its endgame by finding a method for empirically surmounting the uncertainty principle. We have stated that bulk QC cannot be achieved within the limits of Big Bang cosmology or the bounds described by the Copenhagen regime. Here we have produced a rudimentary path for the completion of QT through an embodiment for implementing bulk QC.

We doubt one can understand the ontology without sufficiently comprehending the new cosmology and have perhaps overdone the metaphors in hoping to facilitate this. We can only guess how difficult it will be to build a prototype utilizing our methodology. One could like Edison try 10,000 filaments (multiphase concatenation of resonant hierarchy coupling modes) and expect to achieve success with sufficient effort. Although this in not supposed to be necessary if our protocol is correct.

Any style of sufficiently broad quantum system should be able to provide a vehicle for bulk implementation. DiVincenzo has suggested five requirements the physical implementation of quantum computation:
A physical system with scalable qubits
Ability to initialize the qubit states
Long decoherence times, longer than gate operation times
Universal set of quantum gates
Qubit measurement capability

We have met these requirements and await the appearance of universal bulk quantum computing. As a suggestion we have included what we believe to be a viable candidate organic molecule, that of the Class II Mesoionic Xanthine, because it has a potential scalable 10-qubit register substrate. Our general approached is based on a HD form of Dirac Spherical rotation in the context of a completed form of quantum theory able to ontologically surmount uncertainty.

A formalism could just as readily be designed around the nomenclature of the spacetime dynamics of M-Theory. Also our method could just as easily be translated into a form of Topological Quantum Field Theory (TQFT), not addressed here but which the brane-world closely resembles. This is also illustrated in the work of L. H. Kauffman, in papers such as where he also integrates TQFT with knot theory for quantum computing.

### Empirical Protocol For Surmounting Quantum Uncertainty

Interaction-Free Measurement (IFM) is a quantum mechanical procedure for detecting the state of an object without a phenomenological interaction occurring with the measuring device. A radical extension of the various experimental protocols spawned recently by the Elitzur-Vaidman IFM thought experiment is proposed to ontologically surmount (no interaction or collapse) the quantum uncertainty principle with probability≡1 through utility of additional degrees of freedom inherent in the supersymmetric regime of string/brane theory.

Just as the UV catastrophe provided a clue for the immanent transition from Classical to Quantum Mechanics, the duality in the Quantum Zeno Effect hints at another new horizon. IFM provides an intermediate indicia of this developing scenario. The quantum Zeno paradox experimentally implemented in IFM protocols hints at the duality between the regular phenomenological quantum theory and a completed unitary or ontological model beyond the formalism of the standard Copenhagen interpretation.

Utilizing extended theoretical elements associated with a new formulation for the topological transformation of a ‘cosmological least unit’, a putative empirical protocol for producing IFM with probability=1 is introduced in a manner representing a direct causal violation or absolute surmounting of the quantum Uncertainty Principle.

### Philosophy of Phenomenology Versus Ontology

In the 1970's the concept of quantum non-demolition (QND) arose as a process for performing extremely sensitive measurements without disturbing an extremely weak signal which lead to the Weber approach for gravitational interferometry. But there was a trade-off between the accuracy of a QND measurement and its inevitable back-action on the conjugate observable to that measured. Myriad terms were introduced for programs exploring manipulation of the quantum uncertainty principle for non-collapse of the wave function:

Negative Result Measurement (NRM), Quantum Non-Demolition (QND), Interaction Free Measurement (IFM), Quantum Zeno Effect (QZE), Bang-Bang Decoupling (BBD), Quantum Error Correction (QEC), Quantum Interrogation Measurement (QIM), Counter Factual Computing (CFC), Absorption-Free Measure-ment (AFM), Quantum Seeing in the Dark (QSD), Quantum Erasure Experiment (QEE), Interaction Free Imaging (IFI) and the Bomb Testing Experiment (BTE).

An interaction is any action, generally a force, mediated by an exchange particle like the photon in electromagnetic interactions. This physical concept of a fundamental interaction regards phenomenological properties of matter (Fermions) mediated by the exchange of an energy/momentum field (Bosons) as described by the Galilean, Lorentz or Poincaré groups of transformations. “There has been some controversy and misunderstanding of the IFM system concerning what is meant by ‘interaction’ in the context of ‘interaction-free’ measurements.

In particular, we stress that there must be a coupling (interaction) term in any Hamiltonian description.”. Here we wish to introduce a new ontol-ogical type of homeomorphic transformation with no exchange particle mediated by an interactionless or energyless topological switching.

It is impossible by definition to violate the uncertainty principle, ΔxΔρₓ/2 or ΔEΔtₓ≧/2 within the framework of Copenhagen phenomenology arising from operation of a ‘Heisenberg Microscope’. This is a fundamental empirical fact demonstrated by the Stern-Gerlach experiment where space quantization is produced along the z axis by continuous application of a non-uniform magnetic field to atomic spin structure, or by Young's double-slit experiment for example.

Recent work stemming from the Elitzur-Vaidman bomb-test thought experiment has begun to change this immutable law. The Elitzur-Vaidman bomb-test experiment was first demonstrated experimentally in 1994 using a Mach-Zender interferometer; and soon led to two main improved procedures:
1) Multiple recycled Measurements and
2) Multiple Interferometers.

The Mach-Zehnder interferometer works by using pairs of correlated photons produced by spontaneous parametric-down conversion from a molecular crystal such as LiIO₃. Initially in the first experiments for a 50-50 beam splitter for a one time measurement cycle the IFM probability was 25% according to the formula in Eq. (41); but for repeated measurements and/or various forms of multiple interferometers the IFM probability can be arbitrarily increased toward unity.

$$η = \frac{P ( Det 2 )}{P ( Det 2 ) + P ( Bomb )} \qquad ( 41 )$$

The probability for the IFM model was suggested to occur in powers of π/2N by P_{IFM}=[1−½(π/2N)²+ . . . ]^{2N} where N is the number of beam splitters in the Max-Zender interferometer. In his seminal paper (A thought experiment) Elitzur suggested a maximum IFM of 50%. Kwiat's team developed a method to improve the model to 80% with P_{QSD}=1−(π²/4N)+O(1/N²) where in this case N is the number of photon cycles through the apparatus. In regards to the Elitzur and Vaidmann consideration that their model could be explained by the ‘Many-Worlds’ interpretation Cramer has proposed, “they suggest that the information indicating the presence of the opaque object can be considered to come from an interaction that occurs in a separate Everett-Wheeler universe and to be transferred to our universe through the absence of interference”.

Here a protocol is delineated not for another sophisticated improvement of the varied stepwise degrees of violating the uncertainty relation by the several IFM protocols; but for completely surmounting the uncertainty relation directly, in a straight forward manner, for any and every single action with Probability, P≡1.

In an unexpected way our model has similarities to IFM/QSD but uses extended theory to fully complete the task of uncertainty violation. One could say the new noetic protocol sort of turns the IFM methodology upside down and inside out. The HD regime of the noetic protocol is like the complete “hall of mirrors” where the whole battery of interferometers and multiple cycling routine is inherent in the HD regime, such that only one ‘measurement’ is required for probability, P≡1.

The methodology of this new empirical protocol is fully ontological (rather than the usual phenomenological) and action in the new HD SUSY regime in causal violation of Copenhagen phenomenology not in an Everett ‘many-worlds’ sense but in a manner that extends to completion the de Broglie-Bohm-Vigier causal interpretation of quantum theory. The ontological basis is realized utilizing the additional degrees of freedom of a 12D F-Theory iteration of M-Theory along with the key supposition of conformal scale-invariance pertaining to the state of quantum of information.

Considerations of the vacuum are of paramount concern for string theory, but much of its essential parameters are ignored in the avid exploration of other details. The P=1 model relies heavily on the existence of a Dirac polarized vacuum. Of primary concern at this point of our development is its inclusion of extended electromagnetic theory which is a key element in manipulating the structural-phenomenology of spacetime.

An experimental design, relying on the utility of a new fundamental teleological action principle inherent in the topological geometry of a covariant polarized Dirac vacuum putatively driving the evolution of self-organization in spacetime as an autopoietic complex system, is developed to elucidate the methodology for surmounting uncertainty. The experimental apparatus, a multi-level interferometer, is designed to focus this noetic unitary field

The protocol relies on the symmetry conditions of new self-organized cosmological parameters amenable to a resonant hierarchy of coherently controlled topological interactions able to undergo what Toffoli calls ‘topological switching’ as the energyless basis for the Micromagnetics of information exchange.

Finally to complete the concatenation we utilize theoretical concepts associated with the putative covariant polarized Dirac vacuum forming a string theoretic spacetime background also making correspondence between our ontological view of quantum theory and an extension of Cramer's Transactional Interpretation.

### The Proper Cosmological Perspective is Key

When physicists embraced the 3D Newtonian world view about a hundred years ago the universe was considered to be mechanical and predictable like a clockwork. Since the advent of QT reality is believed to be quantum and statistical or uncertain. Following this line of reasoning when a Theory of Everything (TOE) is realistically discovered based on a unitary field, should some form of monism be embraced? We postulate that cosmology is not uniquely based on any of these three conditions, but a continuous-state dynamic transform-ation of the three regimes comprised of a Wheeler-Feynman-Cramer complementarity as outlined.

Physics has long resisted the role of the observer in physical theory; but in an anthropic cosmology the observer is an inherent key element or better said, the basis of observation. This conundrum of the observer can be avoided here as its effects only become critical for process needing to control a much deeper region of spacetime.

Einstein stated that ‘all of physics is based on measurements of duration and extension. Until now this has occurred within the parameters of a 4D Minkowski-Riemann spacetime metric under Gauge conditions utilizing various forms of the E₃/\hat{M}₄ Galilean-Lorentz-Poincaré transformations describing classical, quantum and relativistic conditions.

These criteria are no longer sufficient and indeed our protocol for surmounting the uncertainty principle requires description of a new cosmological regime described by a new set of 12D transformations we hope to call the Noetic Transformation because of its relevance to anthropic considerations. In this regard in spite of Bell's theorem, following Einstein's conundrum, we restate his complaint that quantum theory is incomplete and therefore wholly inadequate for some processes.

Cramer's transactional model of QT has been ignored by most physicists for a variety of reasons we will not take the time to address here. This just means that when we bandy it about here as a key foundation of HAM cosmology it is foreign and not well understood. A Cramer transaction entails Wheeler-Feynman future-past, standing-wave symmetry conditions which when extended to the HD SUSY regime readily lend themselves to extension to mirror symmetry conditions inherent in the 12D F-Theory iteration of M-Theory.

Further we suggest that the new 12D noetic transform adds additional piloting super-quantum potential parameters, suggesting two forms, levels or regimes for quantum mechanics—that of the observed 4D phenomenological interaction associated with the uncertainty principle; and the new HD ontological ‘piloting’ or anthropic guidance regime. As discussed reality itself is a Cramer future-past transaction. Because the external world we observe is a limited subspace of a larger contiguous reality some elements are removed from perception by subtractive interferometry.

In the standard Copenhagen Interpretation of QT an event emerges only as a result of measurement and objective reality is considered to be a probabilistic illusion. Cramer considers ‘all off diagonal elements of the line element physically real’ during the process of the offer-wave-confirmation-wave process preceding a transaction (event). We may call the final event a resultant of the conditions of Heisenberg Potentia. Here we still wish to consider reality illusory to the Minkowski observer.

Issues of the nature of the fundamental cosmological background continue to be debated with disparate views jockeying for philosophical supremacy; a scenario remaining tenable because experimental avenues for testing physics beyond the standard model have remained elusive. Here a putative empirical protocol is devised for manipulating the so-called covariant Dirac polarized vacuum (DPV) providing a methodology for both surmounting uncertainty and low energy protocols for testing string theory.

The DPV has a sixty year history in the physics literature which has been ignored by the main stream physics community for a number of philosophical conflicts. The problem of surmounting uncertainty is solved by the utility of additional degrees of freedom introduced by utilizing a multiverse cosmology and the associated extended theoretical elements.

### Micromagnetics of Spacetime Conformation

An extensive body of literature exists for phenomena related to the zero-point field; but relative to noetic theory this work is considered metaphorically descriptive only of the ‘fog over the ocean’ rather than the structural-phenomenology of the ocean itself. Instead the deep structure of a real covariant Dirac polarized vacuum is utilized. The Casimir, Zeeman, Aharanov-Bohm and Sagnac effects are considered evidence for a Dirac vacuum. New assumptions are made concerning the Dirac polarized vacuum relating to the topology of spacetime and the structure of matter cast in a 12D form of Relativistic Quantum Field Theory (RQFT) in the context of the new HAM cosmological paradigm.

In this anthropic cosmology the observed Euclidean-Minkowski spacetime present, E₃−\hat{M}₄ is a virtual standing wave of highly ordered symmetric Wheeler-Feynman-Cramer retarded-advanced future-past parameters respectively. An essential ingredient of HAM cosmology is that a new action principle synonymous with the unified field arises naturally and drives self-organization and evolution through all levels of scale.

An experimental design is introduced to isolate and utilize the new anthropic action to test empirically its ability to effect conformational structure of the topology of spacetime to surmount the usual phenomenologically based uncertainty in an ontological matter with probability≡1.

Noetic Theory postulates that spacetime topology is ‘continuously transformed’ by the self-organizing properties of the long-range coherence of the anthropic, élan vital or unitary noetic field. In addition to manipulating conformational change, from the experimental results we attempt to calculate the energy Hamiltonian required to manipulate the Casimir topological conformation in terms of the noetic field equation, F_{N}=E/R (unexpanded form).

This resonant coupling produced by the teleological action of the anthropic noetic field driving its hierarchical self-organization has local, nonlocal and supralocal (complex HD) parameters.

The Schrödinger equation, extended by the addition of the de Broglie-Bohm quantum potential-pilot wave mechanism has been used to describe an electron moving on a neural manifold; but this is not a sufficient extension to describe anthropic noetic aspects of the continuous-state symmetry breaking of spacetime topology which requires further extension to include action of the noetic unitary field in additional dimensions.

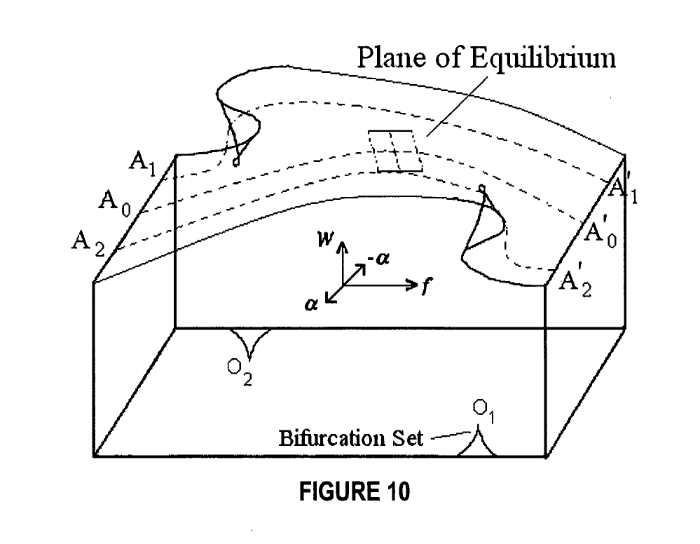

The Noetic Field produces periodic symmetry variations with long-range coherence that lead to a critical Noetic Effect of the (sing model lattice gas rotation of the Riemann sphere backcloth. This can be described by a form of double-cusp catastrophe dynamics (FIG. 10). Operationally the plane of equilibrium experiences sustained hyperincursion by the noetic field.

The coupled modes of this process rely on a special form of the harmonic oscillator called the incursive oscillator. There is a force of coherence. For example for an Earth observer's temporal perception, railroad tracks recede into a point at the horizon. For an atemporal eternal HD observer, the tracks remain parallel. This is the origin of the coherence force which forms a kind of logic gate driving equilibrium of the Casimir boundaries to parallel or degenerate modes with the possibility of effecting conformational states.

This is a boundary condition problem of the Born-von Karman type where conditions restrict the wave function to periodicity on a Bravais lattice of hexagonal symmetry, stated simply as ψ(r+Nᵢaᵢ)=ψᵣ, where i runs over the dimensions of the Bravais lattice, aᵢ are the lattice vectors and Nᵢ are integers.

In this model presence of the periodic spherical rotation effects of the cyclical coherence-decoherence modes allow the action of the noetic field. This Noetic Processing is governed by the fundamental equation of unitarity, F_{N}=E/R (FIG. 9).

Cyclotron resonance, logarithmic spiral, Kaluza-Klein hierarchy or genus-1 helicoid ‘parking garage may maintain piloting by the noetic field or induce an electromotive ‘radiation pressure’ or topological switching coherence force, the Noetic Effect (FIGS. 9 & 10), on the topology of spacetime leading to conformational change in the static-dynamic leapfrogging’ of the Casimir boundary conditions of topological brane states.

A representative embodiment is the action of a cyclotron resonance hierarchy acting on the genus-1 helicoid parking garage structure modulated by a form of Bessel function because it melds well with catastrophe theory and the future-past symmetry breaking parameters inherent in the structural-phenom-enology of continuous-state spacetime topology.

The structural-phenomenology of atoms and molecules is full of domain walls amenable to description by combinations of Gauss' and Stokes' theorems ordered in terms of Bessel Functions where boundary conditions create resonant cavities built up by alternating static and dynamic Casimir conditions.

As frequency increases central peaks occur with opposite or zero polarity at the domain edges. These properties are relevant to Ising Model spin flips of the domains of the Riemann-Block Spheres effecting homeostatic planes of equilibrium (FIG. 10). The noetic effect can maintain equilibrium or produce catastrophes causing conformational change in the Casimir structures.

### Catastrophe Theory and the Noetic Formalism

Regarding dynamical systems that generally operate in a framework of stability and equilibrium—Technically these systems have a restrictive class called gradient systems which contain singularities or points of extrema. Some causal action can institute a bifurcation of an extrema that can initiate a qualitative change in the physical state of the system.

Catastrophe theory describes the breakdown of stability of any equilibrium system causing the system to jump to another state as the control parameters change. The changes in the singularities associated with the bifurcation of extrema are called elementary catastrophes and can be described by real mathematical functions

f:R^{N}→R. (42)

The equation describing an elementary catastrophe utilizes variables representing Control and State parameters of the system and is a smooth real function of r and n where R represents the resultant singularity or catastrophe

f:R^{r}×Rⁿ→R (43)

The r variables are the control parameters of the state variables n. The function f is therefore an r-parameter family of functions of n variables. If we let

f(aᵢ, . . . aᵣ; xⱼ, . . . xₙ) (44)

be a smooth real-valued function of r+n real variables we get equation (3). The number of elementary catastrophes depends only on r and is finite for r≧5 totaling eleven (table 1) and infinite for r≧6.

This model can be utilized to call for a new field of vacuum engineering based on the structural-phenomenology of the noetic field and whether resultant action of the noetic effect is positive or negative. Spacetime exhibits complex self-organization. The noetic field is the factor driving this self-organization; therefore we postulate hyperincursion and anticipatory properties are inherent in the fundamental hierarchical basis of this self-organization which can be formally described in terms of Double-Cusp Catastrophe Theory.

FIG. 9 graphically illustrates the fundamental scale invariant noetic equation F_{(N)}=E/R of mental action. Any internal or external stress or change in E is a nonlinear dynamic process producing stability or instability in the boundary conditions of R; an instability in E→stress→displacement→catastrophe→jump . . . whereas stable flux is homeostatic. HAM cosmology also contains a form of hysteresis loop of the Hamiltonian generalized in FIG. 9 as future-past parameters of noetic spacetime. The area E represents the energy of the noetic force, F_{N•} of the unified field.

The structural-phenomenology of Double-Cusp Catastrophe (DCC) Theory in ≧9D appears homeomorphic to the Riemannian manifold of both 11D M-Theory and the topological geometry of the continuous-state spin-exchange dimensional reduction compactification process inherent in the action of the corresponding scale invariant least-unit of noetic superspace as cast in HAM cosmology.

In this general framework the double-cusp equilibrium surface is analyzed in terms of a hierarchy of Ising-like lattice gas jumps in state providing a framework for considering the noetic least-unit tiling of the Planck backcloth as a complex HD catastrophe manifold mediated by the unitary noetic field which because of the polarized properties of the Dirac vacuum lends itself to empirical mediation.

The putative significance for the application of double-cusp catastrophe theory to the noetic HAM formalism is that the structure of possible boundary conditions and the number of control points is revealed. For example, in this simplistic view, a 3D point in real spacetime might have 16 control photon-gravitons (noeons) covering it. Carrying this all the way up to the 12D holoscape of the Multiverse, the same 3D point might be controlled or guided by a total of 8,176 photons.

The number arrived at by summing the points of D4 to D12. No point in the universe is isolated; so this does not include the possible power factor by associated points in both the HD and LD HAM backcloth. Within the inherent continuous-state dimensional reduction compactification process, the LD domain (D<3) couple to orders of magnitude more photon-gravitons.

The least-unit tiling the Planck backcloth is a complex HD catastrophe manifold with Dirac spherical rotation symmetry mediated by the unitary action of the noetic field. Internal or external stress or change in energy, E is a nonlinear process producing stability or instability in the boundary conditions of R; a causal instability in E→stress→displacement→catastrophe→Ising jump . . . whereas stable flux is homeostatic.

The hysteresis loop of the noetic field (FIG. 9) is conformally scale invariant; the same processes occur in HAM cosmology and domains of living systems. The area represents the energy of the string tension, T₀ or élan vital. This energy, E_{N} is measured in Einsteins, the fundamental physical quantity defined as a ‘mole’—Avogadro's number (6.02×10²³) of bosons, defined here as noeons, the exchange unit of the unitary field.

Equation (45) describes the equilibrium surface of the DCC as modeled in (FIG. 10); where B± [symbol] is the state variable and μ_{d} and υ_{d} are the control parameters.

(B+ [symbol] )³+(B+ [symbol] )μ_{d}+υ_{d}=0 (45)

The position of the two cusps is found at μ_{d}=0 and υ_{d}=0. At any moment temporal permutations of the noetic catastrophe cycle evolve in time from future to past and higher to lower dimensions in the same manner as the spacetime present of the least-unit of HAM cosmology for the spatial domains: R¹²⊃ . . . R⁴⊃R³⊃R²⊃R¹⊃R⁰; followed by an Ising rotation where the cycle repeats.

### Protocol for Manipulating Noetic Cosmology

Extrapolating Einstein's energy dependent or deformed spacetime metric, \hat{M}₄ to a supersymmetric 12D standing-wave future-past advanced-retarded multiverse topology we have designed a spacetime resonance method for a covariant Dirac polarized vacuum which has properties like an ‘ocean of light’.

If this is true spacetime acts like a ‘surface wave’ on the upper regime of the complex self-organized Dirac Sea and is therefore amenable to descriptive methods of nonlinear dispersive wave phenomena generally of the basic form

L(μ)=εN(μ). (46)

Where L and N are Linear and Nonlinear operators respectively in the linear limit where ε=0 with elementary dispersive wave solutions μᵢ=Aᵢ cos θᵢ, θᵢ=kᵢx−ω(kᵢ)t for 1D plus time where nonlinearity creates resonant interactions between the p, solutions and the Amplitude Aᵢ depends on t, creating potentially substantial effects where initial absent modes can become cumulative interactions producing shock wave effects.

Motion of a one dimensional classical harmonic oscillator is given by q=A sin(ωt+φ) and p=mωA cos(ωtφ) where A is the amplitude and φ is the phase constant for fixed energy E=mω²A²/2. For state [symbol] , with n=0, 1, 2 . . . ∞ and

Hamiltonian Eₙ=(n+½)ω the quantum harmonic oscillator becomes

[symbol]

n|q²|n [symbol] =/2mω [symbol] n|(a^{↑}a+aa^{↑})|n [symbol] =Eₙ/mω² (47)

and

[symbol]

n|p²|n [symbol] =½(mω) [symbol] n|a^{↑}a+aa^{↑}=mEₙ (48)

where a & a^{↑} are the annihilation and creation operators,

q=\sqrt{/2mω}(a^{↑}+a) and p=i\sqrt{mω/2}(a^{↑}a).

For the 3D harmonic oscillator each equation is the same with energies

Eₓ=(nₓ+½)ωₓ,E_{y}=(n_{y}+½)ω_{y}

and E_{z}=(n_{z}+½)ω_{z}. (49)

In Dubois' notation the classical 1D harmonic oscillator for Newton's second law in coordinates t and x(t) for a mass m in a potential U(x)=½(kx²) takes the differential form

$$\frac{{d}^{2} x}{d {t}^{2}} + {ω}^{2} x = 0 where ω = \sqrt{k / m} \qquad ( 50 )$$

which can be separated into the coupled equations

$$\frac{d x ( t )}{d t} - v ( t ) = 0 and \frac{d v ( t )}{d t} + {ω}^{2} x = 0. \qquad ( 51 )$$

From incursive discretization, Dubois creates two solutions x(t+Δt) v(t+Δt) providing a structural bifurcation of the system which together produce Hyperincursion. The effect of increasing the time interval discretizes the trajectory. This represents a background independent discretization of spacetime.

### Introduction to the P≡1 Embodiment Method

In a homogeneous magnetic field, the forces exerted on opposite ends of the dipole cancel each other out and the trajectory of the particle is unaffected. if the particles are classical “spinning” particles then the distribution of their spin angular momentum vectors is taken to be truly random and each particle would be deflected up or down by a different amount producing an even distribution on the screen of a detector.

Instead, quantum mechanically, the particles passing through the device are deflected either up or down by a specific amount. this means that spin angular momentum is quantized (also called space quantization), i.e. it can only take on discrete values. there is not a continuous distribution of possible angular momenta. this is the usual fundamental basis of the standard quantum theory and where we must introduce a new experimental protocol to surmount it. This is the crux of our new methodology: If application of a homogeneous magnetic field produces quantum uncertainty upon measurement, then “do something else”.

In NMR spectroscopy often it is easier to make a first order calculation for a resonant state and then vary the frequency until resonance is achieved. Among the variety of possible approaches that might work best for a specific quantum system, if we choose NMR for the Noetic Interferometer it is relatively straight forward to determine the spin-spin resonant couplings between the modulated electrons and the nucleons; but achieving a critical resonant coupling with the wave properties of matter and the spacetime backcloth is another matter.

Firstly, for HAM cosmology is not a rigid barrier as in Standard Model Big Bang-Copenhagen cosmology; is a virtual limit of past-advanced elements of the continuous-state standing-wave present as it cyclically recedes into the past where the least unit cavities tiling the spacetime backcloth can have radii≦the Larmour radius of the hydrogen atom.

This new Planck length oscillates through a limit cycle from the Larmour radius of the hydrogen atom to standard . This is like a wave-particle duality—Larmour radius at the future-retarded moment and at the past-advanced moment. The dynamics are different for future-retarded elements which have been theorized to have the possibility of infinite radius for D>4. This scenario is a postulate of string theory. Considering the domain walls of the least-unit structure, the -Larmour regime is considered internal-nonlocal and the Larmour-infinity regime considered external-supralocal.

For simplicity we introduce our review of NMR concepts for the hydrogen atom, a single proton with magnetic moment μ, angular momentum J related by the vector μ=γJ where γ is the gyromagnetic ratio and J=I where I is the nuclear spin. The magnetic energy U=−μ·B of the nucleus in an external magnetic field in the z direction is U=−μ_{z}B₀=−γI_{z}B₀ where values of I_{z}, m_{I} are quantized according to m_{I}=I,I−1,I−2,I−3, . . . −1.

For most nuclear species the z-component of the magnetization, M grows exponentially until reaching equilibrium according to M_{z}(t)=M₀(1−e exp−t/T₁) where T₁ is the spin-lattice relaxation time. Of interest for the noetic interferometer is the fact that as p precesses cyclically from m_{I}=−½ to m_{I}=+½ the nucleons experience a torque, τ changing J by τ=dJ/dt or μ×B=dJ/dt.

Under thermal equilibrium the x-y components are zero; but M_{z} can rotate into the x-y plane creating transverse Mₓ and M_{y} components dM/dt=γM×B for the entire system by applying a rotating circularly polarized oscillating magnetic field 2B₁ cos ωtî of frequency ω in addition to the constant magnetic field B₀\hat{k}.

Now the total time dependent field decomposes into the two counterpropagating fields

B₁(cos ωtî+sin ωtĵ)+·B₁(cos ωtî−sin ωtĵ) (52)

This more complicated form for use with multiple applied fields is necessary, as described below, for use with the Sagnac Effect, quadrupole, and dipole dynamics required to operate the noetic interferometer.

Nuclear Quadrupole Resonance (NQR) is a form of NMR in which quantized energy level transitions are induced by an oscillating RF magnetic field in the electric quadrupole moment of nuclear spin systems rather than the magnetic dipole moment.

The nuclear quadrupole moment, Q is based on the nuclear charge distributions ρ(r) departure from spherical symmetry defined as the average value of ½(3z²−r²)ρ(r) over the nuclear volume. Q has the dimension of area where the nuclear angular momentum, for which m₁=I where I is the nuclear spin quantum number and m₁ is the quantum number for the z component of the spin, m₁=−1,+1, . . . , I−1,I.

Nuclei with I=0 have no magnetic moment and are therefore magnetically inert. Similarly in order for Q=0 the nucleus must be spherical with spin, I≧0. For spin I=½ nuclei have dipole moments, μ but no Q. Q is positive for prolate nuclei and negative for oblate nuclei.

For an isolated nucleus in a constant magnetic field H₀ with nuclear spin number I>0 the nucleus possesses a magnetic moment. From Quantum Theory (QT) the length of the nuclear angular momentum vector is [I(+1)]^{1/2} where measurable components are given by m with m the magnetic quantum number taking any (2I+1) value from the series, I, I−1, I−2, . . . , −(I−1),−I. For the I= 3/2 case there are four values along the direction of the applied magnetic field H₀.

Of the three types of spin-spin coupling, this experiment relies the hyperfine interaction for electron-nucleus coupling, specifically the interaction of the nuclear electric quadrupole moment induced by an applied oscillating RF electric field to act on the nuclear magnetic dipole moment μ. When the electron and nuclear spins are strongly aligned along their z-components the Hamiltonian is −m·B, and if B is in the z direction

H=−γ_{N}I·B=−γ_{N}BIₓ (53)

with m=γ_{N}I, γ_{N} the magnetogyric ratio γ_{N}=e/2mₚ and mₚ the mass of the proton.

Radio frequency excitation of the nuclear magnetic moment, μ to resonance occurs for a nucleus collectively which rotates μ to some angle with respect to the applied field B₀. This produces a torque μᵢ×B₀ causing the angular momentum, μ itself to precess around B₀ at the Larmour frequency ω_{L}=γ_{N}B₀. This coherent precessing of μ can also induce a ‘voltage’ in surrounding media, an energy component of the Hamiltonian to be utilized to create interference in the structure of spacetime.

Metaphorically this is like dropping stones in a pool of water: One stone creates concentric ripples; two stones create domains of constructive and destructive interference. Such an event is not considered possible in the standard models of particle physics, quantum theory and cosmology. However Noetic science uses extended versions of these theories wherein a new teleological action principle is utilized to develop what we call a ‘transistor of spacetime’.

Just as standard transistors and copper wires provide the basis for almost all modern electronic devices; This Laser Oscillated Vacuum Energy Resonator (LOVER) using the information content of spacetime geodesics (null lines) will become the basis of many forms of Noetic Technologies.

Simplistically in this context, utilizing an array of modulated tunable lasers, atomic electrons are RF pulsed with a resonant frequency that couples them to the magnetic moment of the nucleons such that a cumulative interaction is created to dramatically enhance the Haisch-Rueda inertial back-reaction.

The laser beams are counter-propagating producing a Sagnac effect Interferometry to maximize the violation of Special Relativity. This is the 1^{st} stage of a multi-tier experimental platform designed (according to the tenets of Noetic Field Theory) to ‘open a hole’ in the fabric of spacetime in order to isolate and utilize the force \hat{F}₀ of the Unitary Field.

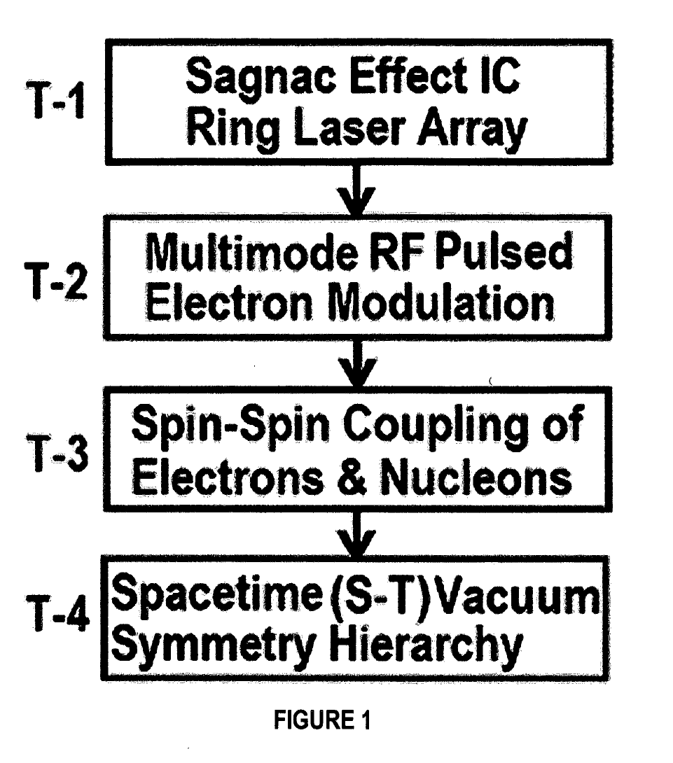

The interferometer utilized as the basis for our vacuum engineering research platform is a multi-tiered device. The top tier is comprised of counter-propagating Sagnac effect ring lasers that can be built into an IC array of 1,000+ ring lasers (FIGS. 1 & 12). If each microlaser in the array is designed to be counter-propagating, an interference phenomena called the Sagnac Effect occurs that violates special relativity in the small scale.

This array of RF modulated Sagnac-Effect ring lasers provides the top tier of the multi-tier LOVER Inside the ring of each laser is a cavity where quantum effects called Cavity Quantum Electrodynamics (C-QED) may occur. A specific molecule is placed inside each cavity, a xanthene quantum dot, or prion protein in our sample embodiments.

If the ring laser array is modulated with resonant frequency modes chosen to achieve spin-spin coupling with the molecules electrons and neutrons, by a process of Coherent Control of Cumulative Interaction an inertial back-reaction is produced whereby the electrons also resonate with the spacetime backcloth in order to ‘open an oscillating hole’ in it. This requires a form of RQFT compatible with the 12D version of M-theory called F-Theory relying on the symmetry conditions of HAM cosmology within which it is cast.

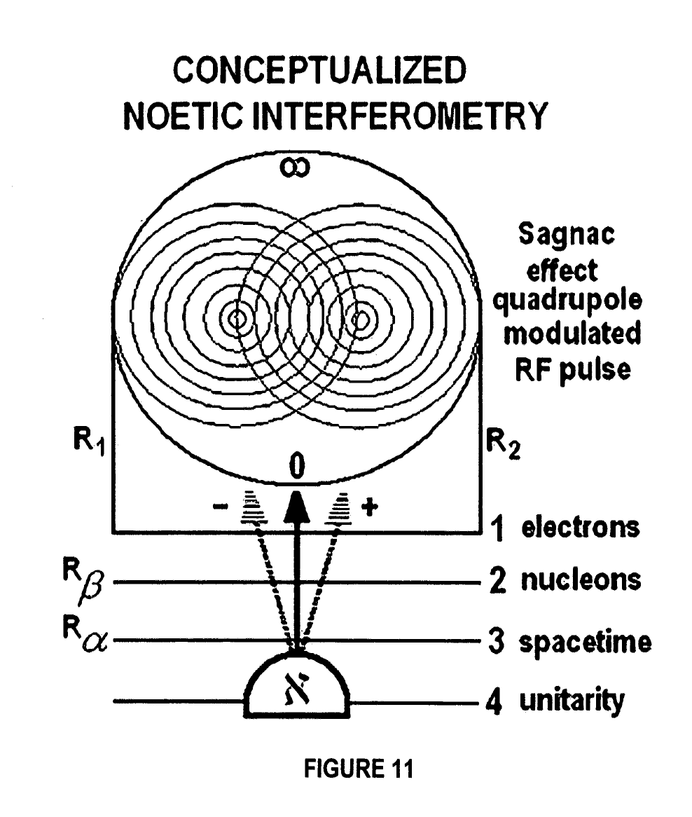

The first step in the interference hierarchy (FIG. 11) is to establish an inertial back-reaction between modulated electrons and their coupled resonance modes with nucleons. The complete nature of inertia remains a mystery. But if one follows the Sakarov and Puthoff conjecture, the force of gravity and inertia, the initial resistance to motion, are actions of the vacuum zero-point field.

Therefore the parameter m in Newton's 2nd law f=ma is a function of the zero-point field. Newton's 3^{rd} law states that ‘every force has an equal and opposite reaction’. Haisch & Rueda claim vacuum resistance arises from this reaction force, f=f. We derived an electromagnetic interpretation of gravity and electro-magnetism that suggests this inertial back-reaction is like an electromotive force of the de Broglie matter-wave field in the spin exchange annihilation creation process inherent in a hysteresis of relativistic spacetime fabric.

In fact we go further to suggest that the energy responsible for Newton's 3^{rd} law is a result of the continuous-state flux of the ubiquitous noetic field. For the LOVER we assume the Haisch-Rueda postulate is correct

$$f = \frac{d ρ}{d t} - {lim}_{Δ t -> 0} \frac{Δ p}{Δ t} ≡ \frac{d {ρ}_{*}}{d {t}_{*}} - {lim}_{Δ {t}_{*} -> 0} \frac{Δ {ρ}_{*}}{Δ {t}_{*}} = {f}_{*} \qquad ( 14 )$$

where Δp is the impulse given by the accelerating agent and thus Δρ_{*}^{zp}=−Δρ_{*}.

The cyclotron resonance hierarchy must also utilize the proper beat frequency of the continuous-state dimensional reduction spin-exchange compactification process inherent in the symmetry of noetic spacetime naturally ‘tuned’ to make the speed of light c≡c.

With this apparatus in place noetic theory suggests that destructive-constructive C-QED interference of the spacetime fabric occurs such that the noeon eternity wave, of the unitary field, U_{F} is harmonically (like a holophote) released into the cavity of the detector array. Parameters of the Dubois incursive oscillator are also required for aligning the interferometer hierarchy with the beat frequency of spacetime.

Using water wave conception for the ‘Dirac sea’, the continuous state compactification process contains a tower of spin states from spin 0 to 4. Spin 4 represents the unified field making cyclic correspondence with spin 0 where (sing lattice spin flips create dimensional jumps. Spin 0, ½, 1, & 2 remain in standard form. Spin three is suggested to relate to the orthogonal properties of atomic energy levels and space quantization. Therefore the spin tower hierarchy precesses through 0, 720°, 360°, 180°, 90° & 0 (∞) as powers of i.

Coherent control of the multi-level tier of cumulative interactions relies on full utilization of the continuous-state cycling inherent in parameters of HAM cosmology. What putatively will allow noetic interferometry to operate is the harmonic coupling to periodic modes of Dirac spherical rotation in the symmetry of the HD geometry. The universe is no more classical than quantum as currently believed; reality rather is a continuous state cycling of nodes of classical to quantum to unitary, C→ [symbol] →U.

The salient point is that cosmology, the topology of spacetime itself, has the same type of spinorial rotation and wave-particle duality Dirac postulated for the electron. Recall that the electron requires a 4D topology and 720° for one rotation instead of the usual 360° to complete a rotation in 3D.

The hierarchy of noetic cosmology is cast in 12D such that the pertinent form of relativistic quantum field theory has significantly more degrees of freedom whereby the modes of resonant coupling may act on the structural-phenomenology of Dirac ‘sea’ itself rather than just the superficial zero-point field surface approaches to vacuum engineering common until now.

The parameters of the noetic oscillator may best be implemented by RQFT using a form of de Broglie fusion. According to de Broglie a spin 1 photon can be considered a fusion of a pair of spin ½ corpuscles linked by an electrostatic force. Initially de Broglie thought this might be an electron-positron pair and later a neutrino and antineutrino:

“A more complete theory of quanta of light must introduce polarization in such a way that to each atom of light should be linked an internal state of right and left polarization represented by an axial vector with the same direction as the propagation velocity”. These prospects suggest a deeper relationship in the structure of spacetime of the Cramer type.

The epistemological implications of a 12D RQFT must be delineated. The empirical domain of the standard model relates to the 4D phenomenology of elementary particles. It is the intricate notion of what constitutes a particle that concerns us here—the objects emerging from the quantized fields defined on Minkowski spacetime. This domain for evaluating physical events is insufficient for our purposes.

The problem is not only the additional degrees of freedom and the associated extra-dimensionality, or the fact that ‘particles’ can be annihilated and created but that in HAM cosmology they are continuously annihilated and recreated within the holograph as part of the annihilation and recreation of the fabric of spacetime itself. This property is inherent in the 12D Multiverse because temporality is a subspace of eternity.

This is compatible with the concept of a particle as a quantized field. What we are suggesting parallels the wave-particle duality in the propagation of an electromagnetic wave. We postulate this as a property of all matter and spacetime albeit as continuous-state standing waves.

For a basic description, following de Broglie's fusion concept, assume two sets of coordinates x₁, y₁, z₁ and x₂, y₂, z₂ which become

$$X = \frac{{x}_{1} + {x}_{2}}{2} , \\ Y = \frac{{y}_{1} + {y}_{2}}{2} , \\ Z = \frac{{z}_{1} + {z}_{2}}{2} \qquad ( 55 )$$

Then for identical particles of mass m without distinguishing coordinates, the Schrödinger equation (for the center of mass) is

$$- i ℏ \frac{\partial ψ}{\partial t} = \frac{1}{2 M} Δ ψ , M = 2 m \qquad ( 56 )$$

Equation 56 corresponds to the present and Eq. 57a corresponds to the advanced wave and (57b) to the retarded wave.

$$- i ℏ \frac{\partial φ}{\partial t} = \frac{1}{2 M} Δ φ , \\ - i ℏ \frac{\partial ϕ}{\partial t} = \frac{1}{2 M} Δ ϕ . \qquad ( 57 )$$

Extending Rauscher's concept for a complex 8-space differential line element dS²=η_{μν}dZ^{μ}dZ*^{ν}, where the indices run 1 to 4, η_{μν} is the complex 8-space metric, Z^{μ} the complex 8-space variable and where Z^{μ}=X_{Re}^{μ}+iX_{Im}^{μ} and Z*^{ν} is the complex conjugate, to 12D continuous-state HAM spacetime; we write just the dimensions for simplicity.

x_{Re},y_{Re},z_{Re},t_{Re},±x_{Im},±y_{Im},±z_{Im},±t_{Im} (58)

where ± signifies Wheeler-Feynman/Cramer type future-past/retarded-advanced dimensions.

This dimensionality provides an elementary framework for applying the hierarchical harmonic oscillator.

### Technological Overview

If the Noetic Interferometer is able to isolate and manipulate the eternity wave, it will become a primary research platform for developing a whole new class of vacuum based technologies; whereas one could say virtually all electronic devices up to now are based on transistors and copper wires.

The LOVER could be called a transistor of spacetime, where rather than copper wires, the geodesics or null lines of spacetime are utilized to transfer information topologically with no exchange particle mediating the ‘interaction’ which perhaps should be called a correlation or entanglement in this scenario to distinguish phenomenology versus ontology.

This introduction is only an overview of the embodiment introducing the anticipated new field of [symbol] -wave (eternity-wave) spacetime engineering that will revolutionize many fields of science. Our sample embodiment is to utilize the noetic [symbol] -wave for the manipulation of prion protein conformation.

Finally we stress that spacetime energy is not ‘produced’ by the noetic interferometer. The interferometer manipulates the boundary conditions ‘insulating’ or ‘hiding’ the unitary geodesics of spacetime by constructive and destructive interference allowing the holophotic release of unitary noeons by completing a cascading water-wheel like circuit already existing behind the usual spacetime domain walls of reality. Probably LOVER vacuum energy is emitted into the LOVER as a form of superradiance of the hysteresis loop of least-unit parallel transport.

### Device and Method for Transducing the Physical Basis for Qualia

The oldest and most difficult epistemological question is considered to be the nature of consciousness or awareness. Of the myriad definitions in use, none are considered complete; and each discipline maintains its own operational model. In medicine for example it usually suffices to consider consciousness as simply the state of wakefulness. Delineating a physical basis for qualia is tantamount to solving the problem of consciousness itself.

The challenge has seemed intractable if consciousness is considered synonymous with current definitions of awareness. Compounding the problem the term consciousness, mind and awareness are often used interchangeably. For our purposes here we define:

Awareness: The continuous variety of experiential states of mind coded dynamically in terms of qualia.

Mind: The cognitive domain or active site of awareness; a subspace of the psychosphere housing the dynamics of qualia.

Consciousness: a fundamental cosmological principle inherent in an Anthropic Multiverse, acting like the concept of charge in electrodynamics.

These universal principle provides the basis for defining complex Self-Organized Living Systems (SOLS) in terms of three complementary base states in continuous dynamical interaction of which Mind and Awareness are integral elements. Note that the Anthropic Multiverse is itself considered a form of complex self-organized system.

Awareness has a component ‘feeling’ or sense of being; that ‘feel’ according to the currently dominant neural identity model is said to arise or be identical to a computational product of brain neural or quantum biochemistry. “Consciousness” is developed from a modified Cartesian interactionist perspective.

Dualism suggests that the brain plays a secondary role as a transducer or data processor; and that the fundamental basis for awareness must be explored from a cosmological perspective that includes additional teleological action components driving the self-organization (life) and mental activity of complex self-organized living systems.

The primary task for this Noetic Field Theory (NFT) is to define consciousness as a dynamic system comprised of three fundamental base states or complementary/interacting parameters.

A presently ineffable domain of elemental intelligence signifying eternal boundary conditions of an individual mind, representing one complement of the universal principle of consciousness.

A complex self-organized system (brain/body) to couple that portion of universal mind to temporal reality. This is the 2nd complement forming an entity.

A teleological action principle equated with the unitary noetic field, élan vital, chi, prana or ‘spirit of God’ which is the ‘noetic force’ giving life or driving self-organization. This action principle is the ‘substance’ of interaction and therefore also the ‘light of the mind’. Because it is physically real NFT is empirically testable and will lead to conscious technologies.

Noetic cosmology is considered a continuous-state Holographic Anthropic Multiverse (HAM). In this HAM context awareness is an evanescent property of the inherent self-organization of the cosmology (within the bounds of a cognitive domain) produced by the continuous-state dynamics of the three complementary-interacting components or base states.

This structure is meant to appear somewhat circular because the continuous-state dynamics of both HAM cosmology and consciousness operate as complex self-organized systems with scale-invariant anticipatory properties; which as generally known are hierarchical with recursive and incursive properties. The structural-phenomenology of the three components represent a difficult panoply of theological, philosophical and scientific issues that have been argued in more detail elsewhere.

The horrendous concatenation of concepts is a testament to why the nature of consciousness is called the oldest and most difficult problem. As we will define in more detail, from the triune context above, qualia are the moment to moment superradiance or evanescent character of this cosmology of consciousness or put another way qualia are moment to moment slices of the physically real structural-phenomenology of mind.

How should mental content be represented? The Psychoneural Identity hypothesis, currently the dominant view maintained by cognitive psychologists states that the mind is a product of the central nervous system, predominantly the brain.

No cosmological perspective is required to describe consciousness from the Cognitive perspective since it follows that consciousness must either emerge from the brain or take some form of mind brain identity, with awareness based on properties of some form of classical or quantum neural programming.

But this has led to the definition of consciousness as a Hard Problem ‘that is too difficult to research scientifically’. Cognitive scientists formally pose the issue of consciousness with the query: ‘What processes in the brain give rise to awareness?’ NFT considers this a category error for philosophy of mind. The question should be posed instead as: ‘What processes give rise to awareness?’.

In the complementary/dualist-interactionist model utilized by NFT the brain is the least important factor of the three basis states of consciousness:

The brain is primarily a data processing transducer of information between the mind and external world.

The material brain/body couples the SOLS and its consciousness to temporal 3D reality.

The brain also manages a spectrum of physiological processes and homeostasis.

For these three purposes (it appears there are no others) the brain, in the context of the larger triune noetic system of a cosmology of consciousness, is the central processor (relative to the temporal domain) of a special form of conscious quantum computer. The linear programming of a Turing machine is insufficient to handle the whims of intentional action.

Dualism is currently unpopular with philosophers of science, not because there is no philosophical basis for dualism, but because the basis has remained more theological and until now there has never been a well developed scientific theory amenable to scrutiny. This is considered unacceptable by definition.

Even Eccles' (the last great dualist) theory, the most highly developed interactionist model to date remained a philosophical construct because at the time he could say nothing about the nature of his Psychon. This problem is expounded by Dennett:

“This fundamentally antiscientific stance of dualism is, to my mind, its most disqualifying feature, and is the reason why in this book I adopt the apparently dogmatic rule that dualism is to be avoided at all costs. It is not that I think I can give a knock-down proof that dualism, in all its forms, is false or incoherent, but that, given the way dualism wallows in mystery, accepting dualism is giving up.”

The purpose of this work to satisfy Dennett type criticisms. But why bother? Why is a heretical context in radical opposition to current thinking required? The history of science has shown that before a new model is empirically tested indicators of its veracity are: internal logical consistency, elegance and explanatory power.

First one must realize that the Big Bang (like all current models of science) is Naturalistic or Darwinian with adherents insisting that an additional life principle is not required. However HCM Cosmology, introduces a teleological action principle allowing consciousness and qualia to be modeled in a comprehensive manner with evolution no longer considered random, but driven or guided by the additional self-organized parameters inherent in the HCM cosmology. This work presents the first comprehensive and empirically testable description for the physical basis of qualia in history!

Postulating a physical basis for Qualia suggests Qualia may also be ‘bottled’ or exist independently of private 1st person introspection (breaking the 1st person 3rd person barrier). This statement's context must be clarified. For example, by definition ‘a sound in the forest’ is not merely the physical ripple in the leaves of trees, nor an analog or digital recording of such; but the conscious apprehension (qualia) of tree ripples by some conscious entity.

This definition of sound is required because a ‘ripple’ like the information content of thought has no meaning without apprehension. What then is the “it”; what is the physical substrate or noumenon beyond this phenomenon of ‘ripple and apprehension’ that could physically exist and be recorded extra-entity? What could produce or reproduce the same Qualia later, in the same individual, or another individual and thus potentially also in a conscious computer or robotic android device? Our attempt to accomplish this task will of course be accomplished in terms of the three-fold noetic basis of consciousness.

Obviously our noetic postulates must demonstrate that subjectivity is not the sole requisite for the existence of qualia; and that current philosophical constraints about subjectivity are grossly inadequate for describing the material existence of qualia or for developing a model for dissolution of the 1st person 3rd person barrier. As the chemical elements were classified into a periodic table in past centuries; a similar tabulation is predicted for quale in ensuing decades.

We are in conflict with the current definition of qualia. To resolve the conflict qualia will has to be redefined, but first it is useful to review the current thinking about Qualia.

### Qualia: Initial Definition Drawn from Current Thinking

A basic definition given by Penrose equates qualia with subjective experience. Although incisive this definition is much too simple for our purposes. Chalmers delineates a broader working definition of qualia with descriptive phrases like “the subjective quality of experience” or “there is something it feels like to be a cognitive agent”. He initiates his definition with a well-known line from Nagel: “a being is conscious if there is something it is like to be that being”:

“A mental state is conscious if there is something it is like to be in that mental state . . . a mental state is conscious if it has a qualitative feel—an associated quality of experience. These qualitative feels are also known as phenomenal qualities, or qualia for short. The problem of explaining these phenomenal qualities is just the problem of explaining consciousness.”

“This is the really hard part of the mind-body problem. I use the term [walla] in what I think is the standard way, to refer to those properties of mental states that type those states by what it is like to have them . . . . Qualia can be properties of ‘internal’ mental states as well as of sensations. It is often convenient to speak as if qualia are properties instantiated directly by a subject, rather than a subject's mental states; this practice is harmless, and justified by the fact that qualia correspond to mental state-types in their own right.”

### General Summary of the Conventional Definition of Qualia

The what it's like character of mental states. The way it feels to have mental states like pain, seeing red, smelling a rose, etc. Qualia, plural of “quale”, is a term introduced by Lewis in 1929. A quale is an introspectible and seemingly monadic property of a sense datum. For example, qualia of a rose includes the visual sense datum of experienced redness, and qualia of an olfactory sense datum of the sweetness of the scent.

Variations of the above summary represent the limits of current thinking; while insightful only a philosophical basis for Qualia is supplied. Defining qualia is no simple task. One must first, as Chalmers predicts, complete the task of preparing a comprehensive model of consciousness, and then at the leading edge of that theory clarify a plethora of new terms and conditions before there is any hope of developing a rigorous model for understanding how Qualia are represented dynamically and apprehended by the mind ontologically. Since this task is theoretically possible under the auspices of NFT lets begin.

In terms of our noetic cosmology, an Anthropic continuous-state HCM, there exists a structural-phenomenological domain defined as the psychosphere or complete set of boundary conditions housing the life energy and mind of a living system or individual conscious entity. The cognitive domain—the active seat of qualia, of such an entity entails a complementarity of static and dynamic Casimir modes or boundary conditions described by the Noetic Field equation F_{(N)}=E/R.

Central to this domain is the temporally localized Heisenberg matrix coupled to the brain holoscape together representing the mental raster (TV screen) transducing entrained moments of conscious awareness. This raster of awareness contains standing wave modes (like the vibration of a violin string) centered on the timeless or eternal present moment; as a self-organized complex system which is in essence a microcosm of the entire scale-invariant conscious Multiverse.

These continuously evanescing mental states of information termed qualia or the physical embodiment of mental content change or evolve with changes in mentation, intention or sensory input.

There was a mantra passed around the Stanford University physics department in the mid 1970's (later determined to be insufficient) to describe the nature of matter. It went like this: ‘If one assumes that matter is a vector gluon, the leading light cone singularity is modulated by a phase of the quark gluon field’. It's an interesting ‘thing’ for a particle physicist to ponder because it suggests various aspects of both the particle and wave nature of matter.

In the framework of the noetic formalism a similar mantra for consciousness would state: If one assumes that qualia are tensor psychons; the leading lightcone singularity is modulated by a phase of the noeon psychon field. Why tease the reader with such a concatenation? For three reasons:
1. To take us away from the ‘brain only’ limitations posited by neural identity theory,
2. To stress the cosmological properties of the noumenon of awareness,
3. Point out its physical, material, wave-particle duality-like and continuous state basis.

### The Physical Basis of Subjective Experience

“What's it like to be a bat?” is the title of a well-known 1974 article by Thomas Nagel that discusses the difficulties associated with developing a scientific explanation for the nature of experience. Nagel states that current reductionist attempts fail by filtering out any basis for consciousness and thus become meaningless since they are logically compatible with its absence.

His main premise is that if one assumes that an organism has any conscious experience at all, “that there is something it is like to be that organism”. This is the subjective character of experience for any conscious entity whether it be a bat or a Martian. Every experience has a specific subjective nature, i.e. qualia.

Nagel also states that “there are facts which could not ever be represented or comprehended by human beings, simply because our structure does not permit us to operate with concepts of the requisite type”; because “to even form a conception of what it is like to be a bat one must take up the bat's point of view”. If one removed the viewpoint of the subjective observer; what would be left?

Nagel suggests that the remaining properties might be those detectable by other human beings or the physical processes themselves or states intrinsic to the experience of awareness. This changes the point of view of qualia to the form that “there is something it is like to undergo certain physical processes”. If our idea of the physical ever expands to include mental phenomena, it will have to assign them an objective character. Nagel recognizes the fact that:

“Very little work has been done on the basic question (from which mention of the brain can be entirely omitted) whether any sense can be made of experiences having an objective character at all. Does it make sense . . . to ask what my experiences are really like, as opposed to how they appear to me? . . . . This question also lies at the heart of the problem of other minds . . . If one understood how subjective experience could have an objective nature, one would understand the existence of subjects other than oneself.”

These questions we intend to answer here. Firstly this means contemporary definitions of qualia are grossly inadequate philosophical constructs. The standard definition is still somewhat suited for philosophically describing the subjective character of qualia; but since qualia are physically real in terms of NFT, additional components of the definition must be generated to describe qualia from the objective sense—i.e. to distinguish the phenomenology of qualia from the ontological noumenon or existence of the physical ‘thing in itself’ with a putative basis for breaking down the 1st person 3rd person barrier. Thus the noetic definition of qualia must be three-fold requiring the following forms:

Type I. The Subjective—The what it feels like basis of awareness. The phenomenological states of a qualia experience. (This is the current philosophical definition of qualia used by Cognitive Psychology)

Type II. The Objective—Physical basis of qualia independent of the subjective feel that could be stored or transferred to a 3rd party. The noumenal elements of qualia upon which the phenomenology is based.

Type III. The Universal—Living systems represent Qualia states of the conscious universe. SOLS provide a substrate representing a “blank slate”, a TV turned on (alive) but with no program signal (mental content). Q-III act as carrier waves from which Q-II are modulated into Q-I by superradiance of the unified noetic field. By Godel's Incompleteness Theorem the objective elements cannot stand alone and be mental but must be imbedded in the context of the greater dynamic holism of HCM Cosmology. Just as for the definition of a sound above.

For clarification it should be noted that all three forms of qualia are considered physically real by noetic theory because the noetic fields of HCM cosmology on which the model is based are all physically real. The noetic field is the unified field or life principle—the inherent cosmological ordering principle driving the self-organization of SOLS.

### What's it Like to be a Prion

We will analyze the objective character of qualia by taking a much more fundamental approach than that of confining ourselves only to mammals as Nagel did. We begin by defining the prion as the most fundamental form of living system because of its use of the noetic effect. Until now Biological Mechanism has remained the basis for living systems. NFT does not discard mechanism. The mechanical properties of SOLS make them very efficient ironically masking the need for an additional life principle.

It is generally accepted that unicellular organism are the most fundamental life form. Some debate is centered around viruses since they have no cell wall. But they commandeer their host's cellular machinery, supporting the case for them as living systems. The prion however is only a complex protein molecule making a case to classify them as living systems a tougher one to make. The tenets of NFT suggest that the prion remains as the only truly mechanical life-form.

Prion propagation only requires a conformational or ‘shape change’ of it's molecule to change its activity from the normal to infectious prion state. While a virus commandeers a cell, prions appear only to steal some of a host's élan vital to drive the purely mechanical activity of conformational change. A technical issue addressed elsewhere.

Since NFT assumes that self-awareness is not a requisite for qualia; a primitive form must be associated with the cognitive domain of even the most fundamental living systems. Very few activities are associated with the mechanical ‘life’ of a prion—no Q-I or Q-II, but it couples to the Q-III of its host allowing it's mechanical properties to operate through the noetic effect by the presence of the Noetic Field. It may be reasonable to limit prion existence to only three activities:

1 Translation, 2. Conformational change and 3. Propagation. We need not say the prion has any form of rudimentary awareness at all if we use only the objective definition of qualia. Later we discuss the relation of qualia to the noetic basis of life. Suffice it to say that at the most fundamental level, just being a living system ‘entitles’ any life form, even the most primitive such as prions and viruses, to certain fundamental action modes.

These ‘actions’ are the effects of the inherent mechanistic aspects of complex self-organization in an Anthropic conscious Multiverse. To repeat in the case of the prion protein action is purely mechanical because there is no cognitive domain and therefore no self-organization.

It is postulated that the holophote (flashing like a light house beacon) entry of the noeon (exchange particle of the unitary noetic field) from every point in the topology of spacetime into every atom or molecule, provides a coherence (which in this case acts like a Casmir force) that facilitates the conformational changes responsible for prion propagation when certain other in vivo noetic conditions are met.

If we assume that a noetic topological charge is associated with the boundary conditions of the prions physical chemistry, certain specific orientations of the molecular bonds are associated with the translations involved in conformational transitions. The infectious prion protein has a Casimir pressure stronger than the forces stabilizing normal prion protein's configuration. This is a purely mechanistic effect, but not a chemical reaction because it utilizes computational aspects of the noetic field.

### Developing a Metaphor for Delineating Qualia

A “Movie Theater” model of mind readily illustrates the triune basis of Consciousness/Qualia because its structural-phenomenology is synonymous with the three fundamental base states of consciousness in the anthropic cosmology of NFT:
1. Eternal elemental Intelligence,
2. The ubiquitous Noetic Unified Field (or spirit of God),
3. Classical/Quantum spacetime dynamics in brain and body.

Secondary metaphors of rainbow formation or stroboscopic stop action on the standing wave of a plucked stringed instrument are also pertinent metaphors. Qualia are only perceived within the recursive hierarchical processes of the complex structure of SOLS (or perhaps in the future a form of cybernetic system that extracellularly duplicates these features).

According to NFT a living system is comprised of a local spacetime connected computational biochemistry animated by a nonlocal/supralocal teleological action principle synonymous with the life-force, élan vital, chi, ki, spirit of God or unified field of physics.

SOLS also entail a Cognitive Domain a dynamic subspace within the boundaries of the entities psychosphere that is the arena where the components associated with the complex processes producing conscious awareness produce Qualia type I (Q-I) as the continuous instantaneous evanesce of apprehension.

The psychosphere could be said to be the conscious field in complementarity with the active mental site of the cognitive domain operationally like a wave-particle duality oscillating between dynamic and static modes. This is key to understanding the noetic delineation of qualia.

Can there be a living-system with a cognitive domain devoid of mental content? In this respect we might assume that coma is a deeper or more ‘empty’ state than sleep. NFT postulates that the prion is the simplest or limiting form of living system albeit one that is purely mechanistic and therefore devoid of a domain of Elemental Intelligence that is co-eternal with God or the Anthropic Multiverse.

Noetic Theory contains the concepts that can solve this dilemma. According to NFT inanimate matter like plastic or steel is one of the triune elements of consciousness—the noetic field according to Einstein's E=mc². But rock itself is not alive or conscious relative to our perspective because it is not a component of living systems. Prions and viruses do have a cognitive Domain (although commandeered) but no agency or self-awareness.

Their activity is a purely mechanistic program. Plants are living systems, i.e. material “animated” by the élan vital, but the “agency” of their cognitive domain is also mechanistic and chemotaxic.

Any living system by virtue of the life process has a Cognitive Domain which in the most primitive is little more than synonymous with its de Broglie wave (adding a higher order spiritual control element to the nature of the de Broglie matter wave—the conscious informational character of the unitary field).

True agency and in that sense rudimentary awareness seems to begin with bacteria, making them smarter than trees, since they are reported to make primitive choices (in mazes) beyond that dictated by mechanism alone; but whether self-awareness begins with mammals, dolphins or birds is an open question especially in the face of the waggle dance of bees. Logically, but somewhat arbitrarily, the assumption is made that prions and viruses are not ‘aware’ but have the mechanistic consciousness of plants—a step above rock.

Something about the boundary conditions of a cell seems required for the rudimentary intelligence assigned to bacteria to operate; perhaps this relates to the nature of the noetic field. Since a virus commandeers a cell and its machinery should this be called a form of anti-consciousness rather than the simplest form of self-intelligence; does thievery allow true cognition by use of the hosts body or cellular level of consciousness.

The current state of NFT development cannot make this delineation definitively only probably. A rigorous answer must wait for empirical testing. But in the interim logic suggests there must be some form of destructive interference between the two systems that would for example in the case of the prion give it the ‘power’ to translate.

The next challenge is what entities or “who” should have elemental intelligence co-eternal with God? In some theologies—The spirit and the body is the soul of man. If we assign intentional action to the lowly bacteria as we have done here; are they entitled to this distinction? Is the fundamental domain of Elemental Intelligence some micro boundary condition so that a human being would as it were be a “galaxy” of micro bacterial type domains of Elemental Intelligence?

At present this seems too ‘woo woo’ Sci-Fi or Eastern panpsychic-monistic to answer. But without some Cartesian style revelation from God or future empirical development utilizing putative Dirac-Noetic Interferometry or the cerebroscopic transducer as a research platform to ‘see’ the HD domain of Elemental Intelligence; we are forced to leave this as an open question at present. Fortunately this bears little effect on our seminal definitions of the physical nature of Qualia because it seems that wherever we set a demarcation on the “qualia pyramid” or hierarchy, the result is the same as far as defining Qualia is concerned.

Firstly, the initial corollary is that Qualia can only be apprehended subjectively in a complex self-organized living system, shared by synchronous entanglement breaking down the 1st person 3rd person barrier, Q-II recording induced into a “sufficiently simulated” artificial living system—an Android? (since we don't know exactly what that means at present, we will drop it from the discussion for now). By following the predictions of NFT by definition:

Postulate 1. Any entity with sufficient awareness (Coherence length or psychosphere radius of computation in the logic array of its cognitive domain) for intentional action, beginning with bacteria, have the conscious ability to apprehend Qualia Type I and utilize type II. For the lowest living systems (virus, prion) this is primarily a purely mechanistic activity.

The mechanistic effects result from the “radiation pressure” or topological coherence of the unified noeon field in the holographic backcloth of the conscious multiverse. To put it another way mechanistic systems get a bit of a free ride by being imbedded in the self-organized structure of the universal self-organization.

A single hydrogen atom has the ability to exist as an isolated entity in space from a 3D perspective, but this does not seem to be true of a Quale (singular of Qualia) because their “light” structure is confined to the hyper-holographic domain of the psychosphere comprised of an array of ‘least units’ of awareness which cannot be separated from the topological fabric of reality in the same way that an image cannot be resolved by a single photon.

But in the future, it may be possible to confine a Quale in a QED cavity or atom as was recently done for photons. It would still have to kept in an active state because a ‘stopped photon’ is annihilated. The main utility of the concept of Quale may be in defining some particular unit of awareness in stand alone form for illustrative purposes.

Is there a definitional distinction between apprehension and the “feel” of Qualia? This represents a challenge that is perhaps moot; but in order to consider infinitesimal shades of difference, for the purpose of discussion we will say that Qualia is the content of the instantaneous moment of apprehension in a stream of consciousness.

We want to make this distinction so fine that there is no distinction between apprehension and qualia. The rational for this nomenclatural abyss is that by the noetic definition Qualia has properties like that of a blind man exploring an elephant: a rope (tail), pillar (leg), hose(trunk), wall (body) fan (ear) in that Qualia can be looked at from perspectives of both apprehension (Type I) and structural phenomenology (Type II). Specifically, Qualia exist in a hyperholograpic domain that has eternal or timeless properties, spatial cavity configuration properties, noetic field informational and temporal wave-particle duality action properties etc.

Back to the “movie theater” mind metaphor. When the projector bulb is on (no film), this represents a living system with a blank slate of Type III Qualia. If the projector bulb is on but not shining on the screen, a boundary condition proximal to the screen would represent sleep and a boundary condition distal to the screen could represent coma. Some mention will have to be made at some point concerning distortion.

Filters of personality, psychosis, drugs etc. that distort apprehension, i.e. S1 “sees” lucidly and S2 is wearing “filters”. This brings up another definitional dilemma that relates to the collective unconscious. Is there some absolute Platonic form residing in a Jungian collective unconscious for each Quale that is apprehended in various degrees of impurity by each entity from within species and from bacteria upwards?

Or should we define everyone's perception as different which therefore becomes a different Qualia. We already know that individual differences cause varied reaction to the same stimulus.

Qualia I cannot be just the film in the projector. Just the film would be Q-II objects like a DVD, video tape or the vibration of the leaves of trees as the unapprehended precursor to sound. Therefore Qualia in the ‘movie theater’ metaphor entail a complex self-organized system built on the three types of qualia in the context of the triune nature of consciousness.

These factors working in concert summate into Qualia I when apprehended by a conscious living system: The film—data impinging the quantum raster from either external or internal sensory input or mentation processed in each case by the Cognitive Domain or Brain as data processor/transducer. Q-II.

The light—Noeons of the unified noetic field Q-III that act as
A) the élan vital and
B) “light of the mind”
C) Gravitation framing the heavens.

The image on the screen—Content of the mind filling the cognitive domain of the mental theater. Q-I.

The feel or apprehension of qualia entails all of the above—Type I qualia (Q-I).

Type II qualia is all the above physical parameters not apprehended as in Type I. Type II qualia may be stored extracellularly, shared by revelation, telepathy or by synchronicity breaking down the 1st person 3rd person barrier.

Type III qualia—Qualia of the Conscious Multiverse.

Postulate 2. In the above context in general: If one assumes that Qualia can be represented as a continuous array of tensor Psychons evanescing within the temporal brain holoscape of the cognitive domain of an entities psychosphere; the leading lightcone singularity is modulated by a phase of the noeon-psychon field.

This postulate first made above now begins to be more comprehensible.

### Applying the Movie Theater Metaphor of Qualia

Based on the fundamental Cartesian dualist-interactionist tenets of Noetic Field Theory (NFT) suggesting that consciousness has three base states:

1. Supralocal (co-eternal with God)—Elemental Intelligence, (Elemental Intelligence is currently ineffable other than that is some form of eternal boundary condition).

2. Action of the ubiquitous Unified Noetic Field (spirit of God, chi, ki or prana) and

3. Semi-classical (temporal) quantum Brain Dynamics or Cognitive Domain.

In total comprising the cosmology of individual entities Psychosphere (a conscious entity is a cosmology in Noetic Theory rather than just an object (brain) as in Cognitive Theory). It is possible to make a generalized table of living systems and qualia reminiscent of the periodic table of chemical elements. The chart cannot be perfected without future empirical research; but the table represents a “best guess” based on what the Noetic Theory currently suggests.

### Hierarchy of Life and Awareness (Qualia)

1. Rock Or Inanimate Matter—Pervaded by Noetic Field only, thus containing one of the three component of consciousness, but is not a living system. E=mc² (all spirit is matter). Continual transformation of matter and energy. No Qualia relative.

2. Plants, And Infectious Proteins Like The Prion And Viruses—Noetic Field. Rudimentary Cognitive Domain, but activity is purely mechanistic by flux of Qualia type II. Rudimentary levels of Q-III.

3. Bacteria Plus—Noetic Field, Qualia Type I and II, Cognitive Domain has rudimentary awareness, choice is generally a mechanistic computation, Q-III.

4. Lower Classes Of Animals—Noetic Field. Qualia Type I, II and III. Cognitive Domain/Brain has basic awareness and ability for conscious choice, some of which is genetically encoded and instinctual.

5. Mammals, Dolphins, Birds—Noetic Field. Cognitive Domain/Brain. Elemental Intelligence (Soul). Qualia Type I, II and III. Many in this class have self-awareness. Elemental Intelligence is a more theological component of consciousness; it is this parameter that allows a living system or conscious systems to exist beyond Earthly temporal existence after temporal death.

### The Limits of Quale

Does our putative extracellular or extra-sentient containment of Qualia have to be immediate to another living system? If we utilized the true definition of a sound. But that is a superficial definition like defining consciousness as wakefulness. Our intention here is to develop a definition of Qualia that is not just descriptive of its phenomenological character but descriptive of its complete structural-phenomenological noumenon which gives the character and the context of Qualia within the continuous state Multiverse (HAM).

With the proper configuration which would entail some sort of control mechanism, theoretically one could put the proper ‘configuration’ of a Qualia within a ‘rock’ but it would not be apprehended unless placed in superposition with a living-system. Since Qualia by the generally accepted definition is in essence the ‘feel of awareness’ or the what it's like to be aware, we now begin to split hairs if we are going to be able to able to define Qualia in a manner in which it can be transferred or shared and stored extracellularly.

Assume a particular conscious entity perceives a simplest form of experience, not temperature because it habituates dramatically over a short duration. All continuous experience habituates to a degree. Let's arbitrarily choose a simple visual experience because vision is the dominant sense with the largest data field.

Assume the subject is in a completely darkened room with only a pinpoint of monochromatic light emitted in millisecond pencils. If the subject is highly skilled at attention by for example with extensive training in meditation; awareness for illustrative purposes is maximized. But there will still be infinitesimal differences in the chain of Qualia from individual limitations and instantaneous variation.

Qualia generally occur in a smooth or continuous perceptual stream of discrete events—discrete frames of film in the projector appear as a smooth continuum on the screen in the same manner that tiny raindrops summate by the Huygens principle of wave train addition into a coherently perceived rainbow that might stretch from horizon to horizon. Because of quantum changes or differences from moment to moment the same Qualia varies because:
Subjective attention to nodes X₁ to X₂ to Xₙ is never perfect.
Quantum uncertainty or fuzziness exists in the oscillation of all biochemical species.
Other extra-quantum oscillations from macroscopic motions or distractions.
Loss by habituation

If we claim the infinitesimal variances are minimal and can be ignored for all practical purposes (FAPP) in the case of individual awareness, these variances could be said to be maximized in a different subject sharing the exact same state of awareness measured by some method of dissolution of the 1st person 3rd person barrier. What is the point of that spectral variance? The answer is that a particular qualia is never precisely the ideal state of a particular qualia.

Since even intra-subjectively there is some averaging over the interval of an instantaneous qualia. To clarify—when is a qualia not the Qualia? Is there a Platonic-type form for a particular qualia? Lets assume an object in some arbitrary setting. For the sake of precision we must realize that each 1,000 units of a particular qualia are all different according to the above four parameters, but FAPP with some averaging we can claim that the 1,000 vary only with infinitesimal differences such that the 1,000 are in essence the same qualia in this particular case.

It is this ‘average’ that we would like to quantify as the ‘point of white light’ (in a dark room) with ‘full’ attention and neglecting loss by habituation. So the infinitesimal averaging would be multidimensional across all properties. Even though all qualia are considered unique, we will not be concerned with the infinitesimal differences within a category for a unique qualia.

At some level an ‘impure qualia’ breaks the barrier of infinitesimal differences and does become a different qualia. By putting the infinitesimal variations aside we are ready to begin the next problem in our discussion; that of the ‘periodic table’ of conscious elements and holographic properties of the ‘collective unconscious’.

Awareness has been defined as the fundamental principle of a conscious universe. It is in the seat of this awareness that qualia is experienced. After a further note on the philosophical basis for qualia, its physical cosmology will be addressed.

### Philosophical Basis for Universal Nature of Qualia

The following remarks support the philosophical suggestion that qualia are the same for all living systems in the same way that DNA is universal to all cellular organisms. Hemoglobin and chlorophyll molecules used for energy transport in animals and plants respectively have very similar molecular structures. Likewise Noetic Theory predicts that qualia have universal structural-phenomenological forms in a conscious universe that can be categorized in a manner paralleling that of the periodic table of chemical elements. But apprehension differences would occur. So even if a Q-II is standardized, if as suggested cats are color blind, apprehension of the same Q-II would be different in each case.

It is generally believed by Jungian psychologists that archetypes of the collective unconscious (Perhaps some form of nonlocal repository bottled in the Earth's psychosphere) represent some form of physically real basis for historical human memory, a basis for personality, and act as a storehouse fostering the evolution of human consciousness.

The best circumstantial evidence for the existence of a Jungian type collective unconscious is the uncanny ability of idiot savants, who are typically handicapped, often isolated in remote areas, and with little formal education, to recite daily weather data perfectly for hundred year periods. Cats are able to watch videos of birds or fish with interest. Several commercial products are available.

Telepathic visions of shared images with animals have been reported suggesting at least some form of universal translator. These ruminations lend a degree of philosophical support to the assumption of Noetic Cosmology predicting that local, nonlocal and unitary aspects of Q-II qualia are universal for all living systems.

But one asks, if the cognitive domain of a bacterium has only a few bits relative to the yottabit (10²⁴ bit) capacity of a human brain how could a bacterium experience ‘thought’ based on the same fundamental Q-II form? Several reasons apply theoretically. A large 2×2 meter holographic film would contain the same information as a pin head size piece torn out of it, only dimmer. The intelligence of the honey bee seems far greater than the capacity of its pin point size neural ganglia, suggesting that a group mind or aspects of the collective unconscious become entangled or superposed through the spacetime manifold.

Theologically the dualist—interactionist model theorizes that the conscious life of the soul continues after Earthly death in some form of a spiritual body. This suggests that ultimately the mind is a form of optical computer with holographic optical storage. In this context the Pauli Exclusion Principle for one at a time Fermi states would not apply. The Bose or photonic state is said to have capacity for infinite superposition. Some creatures for example are color blind.

When presented with color, information loss would occur suggesting the scaling of intelligence also scales the information capacity. One immediately sees that a lot of research will be required to definitively explore these possibilities. We remind the reader NFT is empirically testable and apparatus has been designed to falsify it. When the research begins a new ‘transistor of the vacuum’ will allow empirical study of qualia.

### Microscopic Cognitive Domain—Base of Qualia Pyramid

Barbara Shipman discovered a mathematical relationship between the topology of the quarkonium manifold and the waggle dance of honey bees. By mapping a six-dimensional quantum geometrical figure onto two-dimensions she recognized the pattern as that of the honeybee's ritual dance. To her, this implied that the bees mind is coupled to the quantum world, since it is in the quantum realm that the six-dimensional geometry of phase space has real meaning.

This might also imply a theoretical reason why bees seem to have a lot more intelligence relative to a neural ganglia (insect brain) the size of a pin point. This could support a model indicating action by quantum superposition of a Jungian type collective unconscious. This is the type of concept that could be empirically tested when the Dirac-Noetic interferometer (DNI) is developed.

The bees use the waggle dance to communicate to other bees in the hive the location and distance of a food source. The form of the dance changes according to the location of the flowers constituting the source. The surprising thing is that there may be a deep mathematical explanation for how the dance changes form. Shipman's reasoning related the geometry of the bee's waggle dance to a space in symplectic geometry known as a “flag manifold.”

Shipman believes it is possible that the instincts which control bee behavior are wired in such a way that the quantum principles related to this kind of geometry apply. It could also suggest an advanced form of an EPR-like resonant condition that correlates conscious information across the cognitive domain of the bee's individual and collective unconscious.

[Shipman saysit is not the standard Copenhagen Interpretation (CI) of quantum theory that explains the waggling dance but the ontological non-collapse versions of de Broglie, Bohm and Vigier (DBV). The Bohm & Hiley model suggests a ‘quantum force’ directs an electrons motion by a field that it is always in contact with.

A higher dimensional super-quantum potential version of Bohm's quantum potential is compatible with the ‘energy covering’ (unified field) of the least unit of awareness described by noetic cosmology. While an extension of CI the DBV interpretation is not a sufficient extension to describe living systems because they still don't describe consciousness. Instead of a statistical evaluation of the action of a particle on a manifold, they suggest how a potential may guide the action. This provides a context for intentional action but does not describe intentionality itself. For this we need more physics and eight more dimensions.

Wheeler and Feynman developed what is called the absorber model of radiation suggesting that propagation is mediated by future-past conditions supplied by an absorber and emitter with advanced and retarded potentials. Some thirty years later Cramer extended their model to the CI model of quantum theory providing an avenue for correspondence with required new cosmology so that these two arenas may be sufficiently extended to describe mind.

Korall and his collaborators have found that bursts of 250 Hz magnetic fields applied to dancing bees cause a misdirection of up to 10 degrees in the honeybee's flight direction. Their analysis of the data suggests that this action is the result of a quantum mechanical nuclear spin resonance. This work on the language of bees seems to give evidence of the involvement of a nonlocal collective unconscious that can enable a superposition of states among the cognitive domains of individual bees.

Shipman concludes that the geometry of the collective activity relates to vacuum topology in the same manner as elementary quarks and anti quarks confined to the spacetime manifold correspond to the vertices of a hexagon. The resonant motion of the quark manifold can be shown to include a ‘holophote’ (like the oscillating beacon of a lighthouse) entry of the noetic field of consciousness into all living systems.

Additional theoretical evidence that mental activity is associated with the noetic field is suggested by a behavior observed in some birds called the vestibular-ocular response. A bird's body oscillates stochastically in the wind while perched on a tree branch; but the bird's head remains fixed perfectly still. This process is considered non-computable and as such beyond the capabilities of a bird brain to process.

Indeed it is believed a super computer could not compute it. The more sophisticated the super computer only the better the approximation. If this is true it suggests sophisticated non-computable information exchange occurs in the ‘collective unconscious’ of vacuum topology. This also suggests that the mind-body interface is a naturally occurring form of conscious quantum computer.

### Foundations of Qualia in Physical Cosmology

Even the simplest living systems given intentionality are comprised of hundreds of billions of atoms. Each atom is known to have an associated de Broglie wave suggesting that a rich nonlocal structural-phenomenological cavity-QED computational informa-ional array configures qualia. Therefore explaining qualia should entail a discussion of the HD topological properties of the polarized Dirac vacuum in association with the cosmology of the Noetic least unit.

The Noetic Model of mind is a structural-phenomenological microcosm with boundary conditions defined as the limits of the entities psychosphere. The domain of this multi-level complex system operates under a complementarity of classical, quantum and unitary mechanics. Following this Noetic definition, a living-system is a triune system; which signifies the brain as a classical/semi-classical I/O array and the mind as a unitary coherent system with the long range correspondence between the two mediated by the Noetic Field.

Hawking has discussed a quantum wave function of the entire universe where the ground state corresponds to de Sitter space in the classical limit. Noetic Cosmology includes everything within the bounds of the 4D Hubble sphere H_{R}. Every lesser system within H_{R} would be a component of the H_{R} wave function having it's own component wave function of the total universe.

$${Ψ}_{{U}_{{H}_{R}}} = {\sum }_{i}^{∞} \vert {ψ}_{i} 〉 \\ {Ψ}_{{U}_{{H}_{R}}} = {ψψ}^{*} \qquad ( 59 )$$

According to the de Broglie/Bohm model of quantum theory all matter has an associated pilot wave guiding its evolution of state. This quantum potential as it is also called engulfs all ‘particles’ including living systems. In the noetic cosmology developed here this is synonymous with the HD energy covering of each least unit, which has also been described as a Wheeler Geon or ‘ball’ of light with sufficient self-energy to cohere. This energy is what noetic cosmology considers to be contained in the psychosphere or ‘soul’ that can exist eternally independent of temporal 3(4)D Euclidean/Minkowski reality.

Like the wave function of all matter for the entire universe in Hawking's Big Bang quantum cosmology; ‘consciousness’ holds a similar status in Noetic Cosmology. As stated above, a living-systems is defined as a Qualia of the conscious universe (Q-III). In terms of the ‘least unit’ of noetic cosmology and the associated triune nature forming the basis of living-systems, this consciousness provides:
The unitary field filling all space, governing all matter
The élan vital or life principle
Light of the Mind—Qualia I, II & Ill

Qualia are a high level component of conscious life with more complexity than described by the usual type I definition as the ‘what it feels like’ aspect of awareness centered on the eternal ‘now’ of a living system. Any ‘thought’ occurs in a web of multiple states: mood, health, energy, degree of wakefulness, biases toward object of apprehension. Can Noetic Theory definitively categorize these aspects of Qualia?

Some aspects of qualia description could be considered extraneous under certain specific conditions, for example, orientation could be discounted when contemplating a sphere. Probably the distance factor would cancel in apprehending a pencil of light in a dark chamber. The point of this discussion is that within certain limits there is a particular fundamental ‘form’ that manifests any particular qualia. Meaning that there exists a universal fundamental periodic array of conscious elements utilized by all conscious systems—high level language like German or Greek are different but the language of Qualia (like DNA) is the same for all conscious systems. This principle of course is required for dissolution of the 1st person 3rd person barrier.

The best current theory for a preliminary description of the interrelationship between the two domains is that of Cavity Quantum Electrodynamics (CQED). QED couples the mental Psychon to the brain Dendron on the classical side and QED long range coherence couples the Psychon to it's qualia on the mind side. We use the work of Preparata as the model of QED for the discussion here.

General principles of CQED laser physics stated by Anderson's dictum that the production of coherent modes requires two special conditions:
An external power source called the “pump” and
Finely tuned Q-III ‘Casimirrors’ or the hyper-boundary conditions of the “cavity”.
   Without these conditions, there is no lasing.

The continuous state CQED of the Noetic Least Unit satisfies these conditions. The Action or “pump” is inherent to the dynamics of the continuous dimensional-reduction-spin exchange-compactification process of the of the 12D topology creating and recreating the standing-wave present. The same hyperstructures of the least unit provide the QED cavity. The present acts as the neutral ground state and the energy mode covering at the ‘top’ of the cycle is the excited state. The wave train of qualia is the evanescent ‘lasing’ action.

Classical information undergoes a type of “superradiant phase transition” during the continuous noetic transformation, a form of ‘quasi-particle’ transition through the intervening “Fermi-measurement” barrier of quantum chaos. In the noetic cosmology the unitary domain is ‘always’ coherent. Planck scale chaos is the temporal barrier between the 4D Minkowski subspace and the HD eternal realm. Our perception of Euclidean reality is also a form of coherence, although a more limited form; this is why it appears smooth.

Chaos is required for the barrier so that the higher and lower domains can both interface and be isolated (a form of complementarity) with enough degrees of freedom for the complexities of matter, living-systems, and intelligent intentionality.

The process is described by Gauss' Theorem for the flux of a vector field C through the surface of a cube:

∫_{S}C·nda=∫_{V}∇·CdV, (60)

where S is any closed surface, V is the volume inside it, and n is the outward unit vector normal to the of the surface area element da; and by Stokes' Theorem for the circulation C around a square:

[symbol]

C·ds=∫_{S}(∇×C)ₙda, (61)

where S is any surface bounded by Γ. ∇ is the vector operator

$$∇ = ( \frac{\partial }{{\partial }_{X}} , \frac{\partial }{{\partial }_{Y}} , \frac{\partial }{{\partial }_{Z}} ) \qquad ( 62 )$$

### The Physical Basis of Qualia

To provide a complete context for qualia a psychosphere is defined. This psychosphere is the complete domain (brain plus cosmology) comprising activity of an individual entities conscious mind. The cosmology of this domain provides an additional set of self-organized boundary conditions with both temporal and eternal parameters encompassing all three types of qualia. The hyperholographic-like topology is a structural-phenomenological cosmological process comprised of dynamic and static Casimir modes.

These counter propagating future-past Casimir boundary conditions simplistically can be said to be governed by Gauss and Strokes theorem and generate an evanescent wave of Q-I awareness (on the Q-III carrier base) that is focused physically on the ‘leading light-cone singularity of a Minkowski space standing wave domain of each present instant. This tier of the complex system operates by absolute parallelism and deficit angle hysteresis of the continuous state noetic transformation of the dynamic/static Casimir boundary conditions of Q-II elements where Q-I appear as a superradiant effect.

This domain could be said to couple to the dendritic microprocess of Pribram's holoscape or dendron by way of the Eccles psychon. The experimental design for empirically testing this noetic model is based on a new class of interferometer called the Dirac-Noetic Interferometer (DNI) that utilizes spin states of Dirac spherical rotation in contrast with the symmetry conditions of the continuous state transformation of the least unit of noetic superspace to manipulate superradiant effects of the new noetic action principle to be applied in initial experimentation to the cognitive domain of the prion defined by noetic theory as the simplest mode of a complex living system.

Our earlier definition of a living system as a complex hierarchical structural-phenomenology can now be seen to coincide with the model of qualia we have developed in this discourse. The following postulate, which will probably be found challenging for most cognitive psychologists to accept, is made directly by noetic theory as a result of noetic theory being a form of Cartesian dualism where mind is able to exist independent of the temporal reality.

Postulate 3: The Type II Qualia for a Pencil of Light, is the Pencil of Light.

The contrast between qualia and quale of the light pencil relates to the nature of light waves and quanta, which at present is still not completely understood. The photon concept is still incomplete. In addition to the current understanding of the photon as a wave-particle duality; there is also a duality between time and eternity or the unified field. As stated the Planck barrier exists only for fermions. So the ‘hidden’ unitary aspects of the photon (in this case our light pencil) allow it to be shuttled into the timeless domain of the mind through quasiparticle transitions.

Once postulate 3 is made however noetic theory does clearly predict that Qualia Type I occurs when the Qualia Type II energizes the appropriate cavity of the cognitive domain of the psychosphere with Q-III as a carrier. The delineation above leads to one more complexity in our definition of Qualia. Noetic Theory by definition claims that the noumenon of Q-I phenomena is it's unapprehended Q-II form which is a structural-phenomenology in its own right physically and therefore has its own noumenal elements.

We avoid discussion here of the noumenon of Q-III as a path not relevant to human awareness. In this sense though the noumenon of Q-III is the whole cosmology of the HCM. Returning to the additional complexity of defining Q-II as a photonic pencil. The light pencil is a dynamic element. Perhaps static elements should be included. Possible digital or analog forms of storage that could be fed into the holographic matrix of a cerebroscopic transducer.

A standard image requires a screen or other reflective surface to be resolved; but if the foci of two parabolic mirrors (Casimir plates in our model) are made to coincide the two images superpose into a real 3D holographic image that does not need a screen. There is a science toy called the ‘magic mirage’ that is used to demonstrate this effect of parabolic mirrors. Objects placed in the bottom appear like solid objects at the top of the device.

The holophote action of élan vital energetics arises from the harmonic oscillation (static-dynamic) of least unit boundary conditions tiling the spacetime backcloth. The beat frequency of this continuous action is the carrier wave of Q-III that modulates cognitive data of Q-II into Q-I awareness states which is a superposition of the two (Q-III and Q-II). This modulation of qualia occurs in the HD QED cavities of the cognitive domain.

The QED cavities are a close-packed tiling of least unit hyperspheres; the Casimir surfaces of which are able to reflect quaneme elements. While the best reflectors of EM waves are polished metal mirrors, charged boundary conditions also reflect EM waves in the same way radio signals bounce off the ionized gases of the Kennelly-Heaviside layers if the ionosphere. This reflective “sheath” enclosing the cognitive domain is charged by the Noeon radiation of the élan vital, the phases of which are “regulated” in the complex HD space of the least unit cosmology.

How does noetic theory arrive at describing other more complex qualia from the simple light pencil? Light quanta are microscopic in contrast to the macroscopic sphere of awareness. It would thus seem reasonable to assume that scale invariant properties of the HCM least unit of awareness would apply. Like phonemes as the fundamental sound elements for language there are qualia-nemes or quanemes for awareness all based on modulated Q-II states of the geometric structural-phenomenology of Q-III.

Propagation and reflection of the quanemes of Type-II qualia is the key to the simplicity of the physical basis of qualia as described in noetic cosmology because according to postulate 3 although these Type-II quanemes are noumenal sub-elements of qualia they represent more usual physical aspects of CQED interactions. At the level of quanemes the contemporary physics that might best apply to their description is that of the several forms of superstring theory.

Strings are considered the fundamental objects of nature in this model. Recent arguments concerning the small scale topology of space challenge the customary assumption that the dimensionality of space must be an integer. This recent conjecture of non-integer dimensionalities seems to be compatible with the continuous dimensional reduction compactification process as it would occur at the level of quaneme modulation in the noetic theory of qualia.

The beauty of non-integer spacetime dimension is that it provides a way to eliminate the troubling divergencies plaguing quantum electrodynamics. Another boon of this idea for the noetic cosmology is that the Hausdorff classical measure-theoretical definition of dimension can be used to define non-integer dimensionalities in a way that implies a limiting process that entails a convergence of real numbers toward zero.

Which is the situation in noetic cosmologies continuous dimensional reduction process from 12D to 0D; and although physicists consider this model incompatible with quantum theory because of its precision, it is compatible with the extension of quantum theory in noetic cosmology which does allow such precision in some circumstances! The next step is construction of the Dirac-Noetic Interferometer to test these hypotheses.

### Applications Resulting from the Physical Understanding of Qualia

Understanding the physical basis of qualia can be utilized to make psychology a hard science and develop a fundamental basis for creating a ‘Moral Psychology’. Simply utilizing dissonant or harmonious resonance with a quale's physical field is not sufficient. If this was the essential requirement a ‘real’ moral psychology would not be possible because commensurate states of harmony could be generated for both ‘evil’ systems and ‘good’ systems. (Setting aside for now any definition of evil and good) Opposite systems would be dissonant and similar systems resonant with each other; revealing nothing about their absolute moral nature. All that could said is that they are structurally different producing constructive or destructive interference by phase alignment.

The inherent teleology of the HAM can be used to overcome this limitation. The origin of this approach is initially theological. But since noetic action is physical, scientific methods may be employed leaving theological roots dormant. The noetic principle shows that life is a higher order coherent system produced by the hierarchical functioning of the noetic field acting in conjunction with eternal elemental intelligence and the temporal structural phenomenology of the cosmology of the fundamental ‘least unit’. Theological implications suggest that the noetic field acts as an élan vital emanating from the Throne of God to fill all space.

This is the basis for developing a moral psychology. By Coders incompleteness theorem, a system can not be fully known solely in terms of itself, i.e. resonance modes for constructive interference must arise from resonant coupling to a higher order regime beyond the systems limits. Of course this premise is only valid if the noetic unitary field of HAM cosmology tantamount to the spirit of God therefore entailing “perfect” knowledge relative to the lower order regime.

The implications for medicine and psychology are enormous both in terms of diagnosis, treatment and elevating norms. A new class of diseases of consciousness will be defined for etiologies like ulcerative colitis, Alzheimer's disease, or fiber myalgia for example for which fundamental cause and cure are currently unknown. Also the eventual practical development of Conscious technologies like telepathic machines, intelligent androids and the possibility of locating criminals by clairvoyance enhancing technologies like those portrayed in the 2002 Hollywood film—The Minority Report will be feasible.

Since the noetic model of mind entails a temporal/eternal complementarity-duality; injecting timeless phase elements (eternity wave) would allow practical development of a Star Trek Medical Tricorder for instant healing of wounds normally taking several months.

### Summary

Application of the quantum hypothesis to blackbody radiation, Planck (1900) and the photoelectric effect, Einstein (1905) was met with disbelief by most and scorn by some. In a letter to a friend Einstein wrote: ‘I have just published a fundamental paper about light, but I am sure that nobody will understand it.’ Einstein was correct! Scientists were so sure that energy followed a continuous spectrum that it took about fifteen years before his theory was experimentally verified.

Today most scientists believe strongly in biological mechanism and vigorously deny a need for teleology principles or any type of life force beyond random evolutionary tenets of Darwinian Naturalism. A Nobel Prize was given in 2006 for ‘proof of the Big Bang’; this is troubling because Hubble discovered cosmological redshift, not a Doppler expansion of the universe, a mistake in interpretation of astrophysical data.

One of these Nobelists has often proclaimed that ‘it is impossible that the Big Bang is wrong’. Scientific progress is typically a locus of tiny steps. When major paradigm shifts periodically occur like those inaugurated by Copernicus and Galileo, the resistance can be great.

An extreme case of this resistance occurred with the great Greek mathematician Hipparchus—He calculated heliocentric orbits of the planets, but because they were not perfect spheres (believed at the time to be the only way God would create them) he abandoned his work. Hipparchus' influence was so strong that it was 2,000 years before Copernicus bravely presented his version of heliocentricity, but only on his deathbed for fear of the trouble it would cause and Galileo was nearly executed for professing similar ideas.

Cartesian dualism is presently considered so archaic (and wrong!) that scientists openly mock colleagues adhering to it. Some scientists and philosophers are currently trying to ‘prove’ God doesn't exist or is an irrelevant concept to be absorbed into other nomenclature. Christopher Columbus did not sail off the edge of a flat Earth or get swallowed up by a plethora of phantasmagoric sea monsters on his way to a new world. This fog of myopic “see” monsters shall not block the horizon to wonders of mind and the higher dimensional structure of reality keeping it secret much longer . . . .

### BEST MODES OF THE INVENTION COMMERCIAL APPLICATIONS

As an exemplary mode of the invention as it pertains to bulk Universal Quantum Computing (UQC) we have chosen quantum dot ultraviolet RF pulsed modulated ring laser arrays of class II mesoionic xanthene molecules because they are simple and inexpensive to manufacture, the crystals are stable at room temperature for hundreds of years and since each molecule has ten quantum states are easy to scale.

For coherently controlled manipulation of molecular species of complex self-organized autopoietic living systems we chose the protinaceous compound called the prion that is responsible for neurogenereative encephalopathies. A prion sample is placed in the Sagnac effect ring laser C-QED cavity and coherently controlled manipulation of conformational change in the prion molecule are achieved by setting up spacetime cellular automata in the form of an array of Hadamard quantum logic gates.

The manipulation of the physical aspects of qualia requires a special class of “Conscious Quantum Computer”, the QC is conscious but it is modeled after the HD complex mind-body interactions of governing the evolution of thought. This special class of QC is used in conjunction with cellular automatic spacetime logic arrays able to coherently control the unified field.

Although exemplary embodiments of the present invention are described in detail and reference made to the foregoing drawings for descriptive and illustrative purposes, are not to be considered limited thereby as a variety of other embodiments or additional advantages and modifications of the foregoing art may readily occur to those skilled the art without departing from the scope of the invention defined by the claims appended and by equivalents of the claims included therein, in general the following claims of the specific embodiments disclosed in the specifications should not be construed so as to limit the claims to the specific embodiments disclosed in the specifications and disclosures, but should be construed to include all possible embodiments within the complete scope of the equivalents to which such claims are entitled.

What is claimed is:

1. Apparatus and methods for manipulating spacetime (spacetime as defined by a unique new Holographic Anthropic Multiverse (HAM) cosmological paradigm. In the current vernacular this spacetime is comprised of the scale-invariant continuous-state topology of hierarchic 3-forms totaling 9 spatial and 3 temporal dimensions of Calabi-Yau mirror symmetry parameters or the continuous-state spin exchange compactification dynamics of brane domain wall boundary conditions) consisting of
A universal control system with four associated general methods for manipulating or programming spacetime information listed in descending depth of controlled spacetime embedding (immersion) or utilization;
For controlling:
(A) Any scalable quantum states for bulk universal quantum computing
(B) Conformational states of molecular species of complex self-organized autopoietic living systems.
(C) Exchange quanta of the unified field (noeons)
(D) The infinite potentia of absolute space as the scale-invariant continuous-state topological
conditions of spacetime emerge from it with observed Euclidean space, E₃ as a standing-wave virtual Subspace.

2. Apparatus of claim 1 comprising a ‘transistor of spacetime’.

3. System of claim 2 whereby HD spacetime geodesics act as wires or information pathways.

4. System of claim 2 whereby switching is achieved by manipulating scale-invariant hierarchical resonant modes of Calabi-Yau topological mirror symmetric boundary conditions.

5. Apparatus of claim 2 whereby the “body” of the spacetime transistor is comprised of C-QED topological boundary conditions embedded in the HD raster of the continuous-state spacetime backcloth.

6. Apparatus of claim 5 whereby the raster of spacetime is like a programmable cellular automata array comprised of continuous-state ‘cosmological least-units’ unique to the new HAM cosmological paradigm.

7. Apparatus of claim 6 whereby a cosmological least-unit is the fundamental cyclical asymptotic singularity of spacetime undergoing a continuous-state spin-exchange dimensional reduction compactification process in manner metaphorically consistent with an losing model 0⇄∞ lattice-gas rotations of the complex Riemann sphere defined as a dual mirror symmetric Calabi-Yau 3-form in current M-Theoretic models.

8. Method of claim 7 whereby cyclic modes of the coherently controlled resonant hierarchy couple to symmetry conditions unique to HAM cosmology allowing utility of an inherent synchronization backbone as a key property facilitating control or manipulation of HD parameters of the spacetime transistor formats.

9. Method of claim 8 whereby the coherent control hierarchy is governed by a new set of HD noetic spacetime transformations (beyond the usual Lorentz-Poincaré group of transformations) able to describe and mediate HD symmetry parameters.

10. Method of claim 9 whereby topological switching is mediated by the noetic field equation, F_{(N)}=E/R; where E is a hysteresis loop of noeon energy measured in Einsteins or moles of noeons and R is the complex rotational radius.

11. The noetic transform of claim 9 wherein the Einstein units Lagrangian operates as a spacetime exciplex least-unit continuous-state cavity array to facilitate spacetime modulation.

12. Method of claim 11 whereby surmounting the phenomenology (energy exchange mediation) of the quantum uncertainty principle, ΔxΔρₓ≧/2 or ΔEΔtₓ≧/2 is achieved by cyclically manipulating periodic modes of a coherently controlled resonant hierarchy of Calabi-Yau scale-invariant boundary conditions to exchange quantum state parameters ontologically (energyless) by topological switching with probability, p≡1.

13. Apparatus of claim 9 consisting of Sagnac effect interferometry tuned to a hierarchy of HD conformal scale-invariant de Broglie matter wave causally-free mirror symmetric “copies” of the quantum state associated with the usual 3D Euclidean regime quantum state.

14. Method of claim 13 wherein the Sagnac effect hierarchy couples electrons to nucleons to de Broglie matter-waves to spacetime resonance or alternatively without quantum species present directly to the spacetime least-unit cellular automata array.

15. Method of claim 9 whereby where utility of the Dubois incursive oscillator as key component of the coherent control method for creating access to the scale invariant Calabi-Yau continuous-state spacetime hierarchy.

16. Method of claim 9 whereby extracting quantum state information is achieved by topological switching.

17. A relativistic qubit (r-qubit) with interacting quantum fields wherein the utility of RQFT and de Broglie matter-waves introduce additional HD degrees of freedom for resonant coupling to periodic HD spacetime modes beyond the conventional Copenhagen interpretation of a Block sphere 3D qubit.

18. Method of claim 1B wherein cosmological least unit spacetime cellular automata are configured as Hadamard or other quantum gates to manipulate conformational changes in biological molecular species such as the prion responsible for neurodegenerative encephalopathies.

19. Method and apparatus of claim 1C whereby the noeon, the exchange quanta of the unified field, is manipulated by coherently controlled cycles of constructive interference for holophote noeon superadiance within an array of spacetime transistors.

20. Method and apparatus for utility of the full 12D regime of spacetime for manipulating qualia whereby developing a new class of noeon mediated medical technologies for ameliorating autoimmune aetiologies and implementing various forms of sensory by-pass prosthesis.
